(19) United States
(12) Patent Application Publication
(10) Pub. No.: US 2007/0250462 A1
(43) Pub. Date: Oct. 25, 2007

(54) Computerized systems and methods for assessment of genetic test results

(76) Inventors: Jean Amos Wilson, Huntington Beach, CA (US); Jim Williamson, Long Beach, CA (US); Mary Kay Mosch, Sparks, MD (US); Laurence McCarthy, Great Falls, VA (US); Rick Lustig, Mission Viejo, CA (US)

Correspondence Address: BOZICEVIC, FIELD & FRANCIS LLP, 1900 UNIVERSITY AVENUE, SUITE 200, EAST PALO ALTO, CA, 94303, US

(21) Appl. No.: 11/590,669

(22) Filed: Oct. 30, 2006

Related U.S. Application Data
(60) Provisional application No. 60/732,728, filed on Nov. 1, 2005.

(51) Int. Cl. G06N 3/12

(52) U.S. Cl. 706/13

(57) ABSTRACT

Computer-based methods and systems for facilitating assessment of results of genetic screening tests are provided. The methods and systems can be implemented to, for example, facilitate a risk assessment revision for a subject who may be a carrier of a genetic disease or facilitate a diagnosis of a genetic disease.

### CROSS-REFERENCE TO RELATED APPLICATION

This application claims the benefit of U.S. Provisional Application No. 60/732,728, filed Nov. 1, 2005, which application is incorporated herein by reference in its entirety.

### BACKGROUND

Genetic diagnosis and counseling has been greatly advanced in the past several years by the development of more elegant and efficient screening methods. For example, application of nucleic acid-based testing technologies such as PCR-based amplification and microarray-based analysis as made generating results of a genetic test more affordable and much less complex than in prior years. There are many commercially available genetic tests which allow one to screen for the presence or absence of many mutations (e.g., 20-40 mutations), and require non-invasive biological samples as starting material (e.g., a buccal swab). Because the tests are simple, and the results generated easily, clinics and hospitals are beginning to move these testing activities “in-house”.

Interpretation of the results of such genetic tests can be complex, particularly in the context of evaluating the risk that a carrier subject will have a child who will be affected by a genetic disease. Because there is a general misperception by the lay public that a “negative” result for the presence of a mutation associated with a genetic disease is indicative of zero risk of having an affected child, reporting the results in an “positive/negative” format is not sufficient. Proper genetic counseling should instead include advising the patient with a negative mutation analysis that, for example, risk is not non-zero, but is instead adjusted downward. A further complicating factor is that many clinicians have difficulty in understanding or appreciating the complexity of analysis of genetic test results, and as a result must refer the patient(s) to a professional with genetic counseling expertise.

Recently, there has been a significant increase in demand for genetic screens for cystic fibrosis (CF). This explosion followed the recommendation by the American College of Medical Genetics (ACMG) and the American College of Obstetricians and Gynecologists (ACOG) that obstetricians in the U.S. nationwide offer preconception and prenatal carrier screening for cystic fibrosis (CF) to all patients regardless of race, ethnicity, or demographics. As with many other genetic diseases, it is best to screen for CF carrier status in partners during preconception pregnancy planning, or as early as possible in pregnancy or in the newborn. CF screening helps prospective parents know if they are carriers and if their unborn child is at risk for the disease. A CF screen of an infant can also help new parents provide the best health care and supportive environment for children who have the disease but have not yet developed symptoms, particularly since early intervention has been shown to improve outcomes for these patients.

Well over 1,000 known different mutations of the cystic fibrosis transmembrane regulator (CFTR) gene are known, which mutations may contribute to the disease. In 2001, ACOG set a minimum standard that tests should screen for the 25 most common mutations of the CFTR gene plus a few variations. “Partial panel” tests usually identify 80% to 90% of Caucasian carriers, depending on how many of the mutations are included; the sensitivity of a partial-panel test is generally even greater for Ashkenazi Jews, but quite a bit lower for those of Hispanic, African, or Asian descent because of the different mutation frequencies within each of these ethnic groups. Some currently available CF genetic screens detect 40 mutations and 4 variants.

However, as noted above, interpretation of such genetic screens can be complicated. For example, since not all possible mutations are evaluated in partial-panel screening tests (such as described above for CF), failure to detect a mutation does not equate to zero risk. Furthermore, a patient's ethnicity and family history affect carrier risk or disease risk.

In short, genetic screens such as those for CFTR mutation analysis, are high-complexity laboratory procedures normally involving sophisticated molecular biology and human genetics expertise. The advent of population carrier screening for CFTR mutations has added, and will continue to add, an extremely large test volume to a procedure of such high complexity and sophistication, a situation unprecedented in the field of laboratory medicine. For at least these reasons, such testing should be performed by laboratories possessing the requisite expertise, experience, and physical resources.

The ACMG has recommended that any laboratory embarking on CF population carrier screening must be able to comply with the stringent quality assurance guidelines specified in the ACMG and CAP checklists and the report of the NIH-DOE Task Force on Genetic Testing, and must participate in the CAP/ACMG quality assurance and proficiency testing programs. The ACMG has also recommended that equal attention must be paid to pre- and postanalytic aspects of testing (e.g., appropriateness of test ordering, interpretation, reporting, and counseling) as to the laboratory test panel itself. Various test results will particularly generate the need for genetic counseling. Such results will include, for example, (1) the identification of positive/negative couples who may request additional mutation analyses or counseling to clarify their residual risk, (2) individuals who have a family history of CF, (3) otherwise healthy males who carry mutations or variants associated with infertility, and (4) positive/positive couples. It is important that individuals and couples receive accurate information about risks, prognostic factors, and range of options available to allow for fully informed decision-making.

However, not all hospitals or clinics have the resources to staff a board-certified genetics counselor on staff, or to have a sufficient number of such counselors to handle the increase in demand for interpretation of genetic screen results. Indeed, while the need exists, the volume of tests at any one site may not justify the expense of a certified molecular geneticist. As a result, interpretation of genetic screen results presents at least one bottle-neck to providing patients with the information they need.

Literature

US Published Application No. US 2002/0052761; U.S. Pat. Nos. U.S. Pat. No. 6,482,156; U.S. Pat. No. 6,246,975; U.S. Pat. No. 6,113,540; U.S. Pat. No. 6,022,315; U.S. Pat. No. 5,868,669; U.S. Pat. No. 5,724,968; U.S. Pat. No. 5,711,297.

Grody et al.” Laboratory Standards and Guidelines for Population-based Cystic Fibrosis Carrier Screening”, Genetics in Medicine, March/April 2001, Vol. 3 No. 2: 149-154.

### SUMMARY OF THE INVENTION

Computer-based methods and systems for facilitating assessment of results of genetic screening tests are provided. The methods and systems can be implemented to, for example, facilitate a risk assessment revision for a subject who may be a carrier of a genetic disease or facilitate a diagnosis of a genetic disease.

Exemplary embodiments of the invention are disclosed herein.

### BRIEF DESCRIPTION OF THE DRAWINGS

It is emphasized that, according to common practice, the various features of the drawings are not necessarily to-scale, and dimensions of the various features are arbitrarily expanded or reduced for clarity. Included in the drawings are the following figures:

FIGS. 1A-1C is a schematic diagram showing exemplary embodiments of input of data by a user. FIG. 1A is an exemplary embodiment of data input for carrier screening embodiment. FIG. 1B is an exemplary embodiment of data input for a diagnostic embodiment. FIG. 1C is an exemplary embodiment of data input where the test type may be either carrier or diagnostic.

FIGS. 2A-2G are schematics illustrating exemplary simulated screens as it may be viewed by a user inputting data.

FIG. 3A-3C is a schematic diagram showing an exemplary embodiment of processing of data

FIG. 4A-4C is a series of schematics illustrating an exemplary report containing a CFIIC interpretative report generated using the methods and systems described herein.

FIG. 5A-5B is a series of schematics illustrating an exemplary report containing an CFITC interpretative report generated using the methods and systems described herein.

FIG. 6A-6B is a series of schematics illustrating an exemplary report containing a CFIID interpretative report generated using the methods and systems described herein.

FIG. 7A-7B is a series of schematics illustrating an exemplary report containing a CFITD interpretative report generated using the methods and systems described herein.

### APPENDIX

The present application includes an Appendix inserted after the claims, which Appendix contains the following tables:

Table—INTERPRETIVE MASTER REPORTING LIST;

CFITC—Table 1, CFITC—Table 2, CFITC—Table 3 and CFITC—Table 4;

CFIIC—Table 1, CFIIC—Table 2, and CFIIC—Table 3;

CFITD—Table 1, CFITD—Table 2, and CFITD—Table 3; and

CFIID—Table 1, CFIID—Table 2, and CFIID—Table 3.

Definitions

“Carrier” (or “carrier subject”) generally refers to an individual who does not display any detectable or significant symptoms of a genetic disease, but harbors the gene (or genes) for a genetic disease, and can pass the disease-causing gene (or genes) to offspring.

“Carrier risk” is used herein to refer to the risk that a carrier will have offspring affected by the genetic disease for which the subject is a carrier.

“Diagnosis” as used herein is meant a positive or negative indication as to whether a patient has, or is at risk of developing, a disease or one or more symptoms of such a disease. A genetic diagnosis is a diagnosis based at least upon detection of the presence or absence of a gene mutation (or variant) that is indicative of a disease (e.g., cystic fibrosis, Huntingto's disease, etc.).

Before additional disclosure of embodiments of the present invention is provided, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, some potential and preferred methods and materials are now described.

All publications mentioned herein are incorporated herein by reference to disclose and describe the methods and/or materials in connection with which the publications are cited. It is understood that the present disclosure supersedes any disclosure of an incorporated publication to the extent there is a contradiction.

It must be noted that as used herein and in the appended claims, the singular forms “a”, “an”, and “the” include plural referents unless the context clearly dictates otherwise. Thus, for example, reference to “a tag” includes a plurality of such tags and reference to “the compound” includes reference to one or more compounds and equivalents thereof known to those skilled in the art, and so forth.

It is further noted that the claims may be drafted to exclude any optional element. As such, this statement is intended to serve as antecedent basis for use of such exclusive terminology as “solely”, “only” and the like in connection with the recitation of claim elements, or the use of a “negative” limitation.

The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed.

### DETAILED DESCRIPTION OF EMBODIMENTS OF THE INVENTION

Computer-based methods and systems for facilitating assessment of results of genetic screening tests are provided. The methods and systems can be implemented to, for example, facilitate a risk assessment revision for a subject who may be a carrier of a genetic disease or facilitate a diagnosis of a genetic disease.

Various exemplary embodiments are described herein. For example, in one exemplary embodiment the methods and systems feature a computerized method of interpretation of genetic test data of a patient comprising receiving patient data; receiving genetic test result data for at least a first allele; generating a flag configuration from the patient data and at least first allele data; and generating a report based on the flag configuration; wherein the report provides an interpretation of genetic test data for a patient. In related exemplary embodiments, receiving genetic test result data further comprises receiving genetic result data for a second allele, and the flag configuration is generated from the patient data, the first allele data, and the second allele data. In further related exemplary embodiments, receiving patient data comprises one or more of receiving patient ethnicity data; receiving personal history data; and receiving family history data; wherein the flag configuration generated includes the patient ethnicity data, personal history data and family history data. In further related exemplary embodiments, said generating a report comprises comparing the flag configuration to a table of defined flag configurations having an associated message code to identify a matching flag configuration; and entering the message code of the matching flag configuration for inclusion of associated text in the report. In related exemplary embodiments, when comparing the flag configuration to the defined flag configurations does not identify a matching flag configuration, no report is generated and is optionally not generated until and/or after manual intervention is completed.

In another exemplary embodiment, a system for analysis of genetic test data is described which system comprises a computing environment; an input device, connected to the computing environment, to receive data from a user, wherein the data received includes patient data and genetic test result data for at least a first allele; an output device, connected to the computing environment, to provide information to the user; and a computer readable storage medium having stored thereon at least one algorithm to provide for generation of a flag configuration from the patient data and the genetic test result data, and comparison of the flag configuration to a table containing defined flag configurations having associated message codes, wherein when the flag configuration generated from the patient data and the genetic test result data matches a defined flag configuration in the table, the associated message code is identified for use in generation of a report; wherein the system provides results that can be used for generation of a report providing an analysis of genetic test data of a patient. In related exemplary embodiments, the computing environment comprises a local computer local to the user and a remote computer at a site remote to the user, wherein the local computer and the remote computer are connected through a network, and wherein the computer readable storage medium is provided on the remote computer.

In another exemplary embodiment, an automated genetic test result interpretation system is provided, which comprises a communications network; a server connected to the communications network; a client computer connected to the communications network; and at least one algorithm executed based on patient data and genetic test result data, to provide for generation of a flag configuration from the patient data and the genetic test result data, and comparison of the flag configuration to a table containing defined flag configurations having associated message codes, wherein when the flag configuration generated from the patient data and the genetic test result data matches a defined flag configuration in the table, the associated message code is identified for use in populating a field of a report. In related exemplary embodiments, the communications network comprises the Internet.

Also described is a computer readable medium comprising a program stored thereon, wherein the program provides for execution of one or more algorithms to execute the methods described herein.

Further details will now be provided.

Genetic Test Platforms and Exemplary Genetic Screens Amenable to Implementation

The methods and systems described herein can be adapted for use in conjunction with any genetic test platform of interest. By “platform” or “genetic test platform” is meant any assay format that provides information about the presence or absence of a mutant allele associated with a disease of interest (e.g., cystic fibrosis). Such assays are generally nucleic-acid based, and involve the detection of the presence or absence of a mutant allele associated with a disease of interest, including determining whether the mutation occurs on one or both alleles.

Exemplary platforms include nucleic acid-based assays involving arrays (especially microarrays), beads, and the like. Exemplary assays for nucleic acid-based detection usually involve some form of nucleic acid amplification (e.g., by polymerase chain reaction (PCR)), and analysis of an amplification product for the presence or absence of a sequence associated with a mutant gene. Exemplary assays include, but are not limited to, INNO-LiPA (Innogenetics, Gent Belgium), InPlex™ (Third Wave Technologies, WI USA), Signature CF (Ambion Diagnostics, Austin Tex. USA)and Tag-It™ (Tm Bioscience Corporation (Toronto, Canada)) assays.

Any genetic screen, particularly one which requires interpretation of results requires consideration of several factors to provide assessment of carrier risk or of diagnosis and/or risk of disease severity (e.g., genetic tests for which a meaningful interpretation requires more than a positive/negative result of the assay). Genetic diseases of particular interest for which genetic screens are available and can be readily adapted to assessment according to the methods and systems described herein include cystic fibrosis (CF), fragile X, Huntington disease, and open neural tube defects.

The methods and systems described herein can be readily adapted to facilitate analysis of genetic tests of any of a variety of mutant genes associated with a disease of interest. The methods and systems described herein are primarily exemplified by genetic screens involving assessing the presence of a mutation on both alleles. However, it is to be understood that the methods can also be used in facilitating assessment of carrier risk and/or diagnosis for diseases on which assessment of only a single allele is necessary, as in autosomal disorders (e.g., an X-linked disorder (e.g., in males), or a Y-linked disorder). The sequences of mutant genes associated with various genetic diseases have been identified and are known in the art. For example, a database devoted to the collection of mutations in the CFTR gene is maintained by the laboratory of Lap-Chee Tsui on behalf of the international Cystic Fibrosis genetics research community, and is available on-line at www.genet.sickkids.on.ca/cftr/.

Methods for manual interpretation of results of genetic screens for these genetic diseases and others are known in the art. For example, CF screens and methods for manual interpretation of such genetic screens are described in, for example, American College of Medical Genetics “Technical Standards and Guidelines for CFTR Mutation Testing” (2005) (www.acmg.net/Pages/ACMG_Activities/stds-2002/cf.htm); The American College of Obstetrics and Gynecologists, “Prenatal and Preconceptional Carrier Screening for Genetic Diseases in Individuals of Eastern European Jewish Descent, (August 2004) ACOG Committee Opinion No. 298 104:425-8, each of which are incorporated herein by reference in its entirety), and, where appropriate, information relating to risk assessment and diagnosis can be readily incorporated into the methods and systems of the invention as exemplified herein.

Methods of Genetic Screen Data Analysis

The methods and systems of the invention generally involve execution of algorithms to facilitate analysis of genetic test results in the context of assessing carrier risk or diagnosis of a genetic disorder.

The methods and systems of the invention are exemplified by a web-based ordering and reporting system, referred to as FocusLink™, which is described in more detail in the Example section below. In this exemplary system, the client (e.g., a lab technician, health professional, or other user) collects selected patient risk assessment data (e.g., ethnicity, personal history, family history). After performing a CF genetic screen in their laboratory on a platform of interest, the client uses FocusLink™ to order platform-specific interpretation services. The client enters the patient risk assessment data and genetic test result information.

The data input by the user is transmitted via the internet off-site (e.g., to Focus Technologies) and processed to provide an electronically-generated interpretive report. This interpretive report is normally subjected to certain quality control parameters by a reviewer, which reviewer is, or is or under the supervision of, a board-certified geneticist, and released for the client. Under certain circumstances, described below in more detail, providing results from which a report can be generated requires manual intervention. Once released, the output is then transmitted via the Internet back to the client. The final report, which contains the interpretive report, can be generated at the client-side, as in the embodiment of the Example below, or can be generated at the reviewer side. The methods and systems described herein can provide for an interpretive report of a genetic screen within 24 hours of receipt of the data in the program (e.g., in FocusLink™). A program can also provide for triggering creation of an invoice for order and corresponding service requested and rendered.

As will be readily appreciated by one of ordinary skill in the art, the FocusLink™ embodiment is but one example of how the methods and systems of the invention can be implemented and application. The methods and systems will now be described more generally and in more detail.

User-Side Data Entry

For clarity, it should be noted that the “user”, which is used interchangeably with “client”, is meant to refer to a person who at least provides for data input, and may be the same person to whom results and/or a report is transmitted, in the methods and systems described herein. In some embodiments the person who inputs the data, and the person who receives the results and/or report may be different persons, but are both referred to as “users” or “clients” herein to avoid confusion. In certain embodiments, e.g., where the methods are completely executed on a single computer, the user or client provides for data input and review of data output. In embodiments where the user only executes a portion of the method, the individual who, after computerized data processing according to the methods of the invention, reviews data output (e.g., results prior to release to provide a complete report, a complete, or reviews an “incomplete” report and provides for manual intervention and completion of an interpretive report) is referred to herein as a “reviewer”. The reviewer may be located at a location remote to the user (e.g., at a service provided separate from a healthcare facility where a user may be located). In this context of a genetic test screen, the reviewer is normally a certified geneticist or under the supervision of a certified geneticist, as may be required by government regulations or laws.

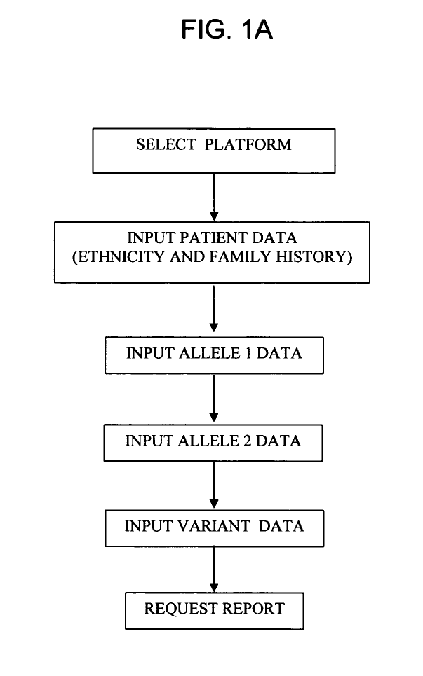

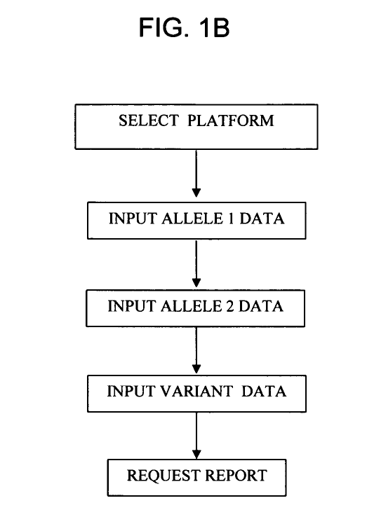

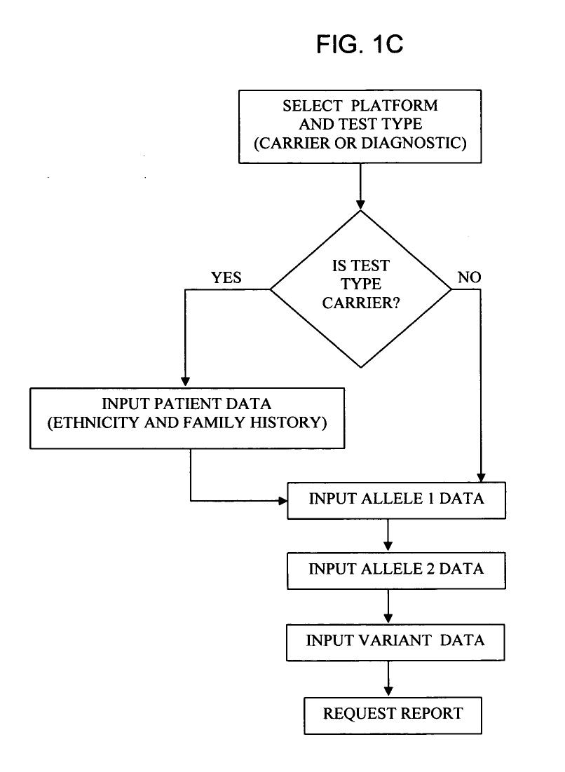

FIGS. 1A-1C provide exemplary embodiments of the user-side data entry method. The user first selects a platform and test type. “Platform” refers to the specific assay used in analysis (e.g., in the context of a CF screen, exemplary platforms include a TagIt™ assay and an Invader™-based assay (e.g., InPlex™)). “Test type” refers to whether the assay is conducted for the purpose of carrier screening or diagnosis. FIG. 1A exemplified the data input for a user who has already selected the “carrier screening” test type. In FIG. 1A, the user selects the platform, and then inputs patient data (ethnicity and family history), data for both alleles (allele 1 data and allele 2 data), and variant data, and then requests a report. FIG. 1B exemplifies the data input for a user who has already selected the “diagnostic” test type. In FIG. 1B, the user selects the platform, and then inputs data for both alleles (allele 1 data and allele 2 data), and variant data, and then requests a report. Ethnicity and family history data are not required for diagnostic assays, although such can optionally be provided. Furthermore, while personal history data is not required for either carrier screening or diagnostic screening, such can be provided. However if not provided, personal history is assumed Negative (or not provided or not solicited) for carrier screening, and assumed Positive for diagnostic screening.

FIG. 1C provides an example where the user is prompted to choose both platform and test type in a single query, with separate queries provided for each of platform and test type where desired. In the embodiment exemplified in FIG. 1C, if the test type is a carrier, then the user is next prompted for patient data, which usually includes both patient ethnicity and patient family history. If the test type is not carrier, then the user is prompted to proceed directly to input of genetic screen result data. The embodiment in FIG. 1C assumes that where the test type is “carrier”, then personal history of the patient is negative, not solicited or not provided, and further where the test type is not carrier (i.e., is diagnostic), then test type is diagnostic. Although not shown in FIG. 1C, the user can also be queried as to the source of the biological sample tested (e.g., blood, buccal swab, mouthwashing, cord blood, unknown, etc.).

In each of the embodiments exemplified in FIGS. 1A-1C, the user enters genetic screen result data by inputting data for Allele 1, which can be Negative, or the name of a particular gene mutation. If the mutant has a variant of interest (e.g., a gene mutation variant that is indicative of a revised carrier or disease risk), the user can be prompted to enter this information. The user can be required to enter an answer even where no mutation is present on either allele, and/or where the mutant selected for Allele 1 or Allele 2 does not have a variant (e.g., “N/A” for not applicable). Alternatively, variant data is not provided as a separate prompt, but is combined in a single step for each allele such that the various gene mutations and gene mutation variants are entered at the prompt to input Allele 1 data. The user is then similarly prompted to enter genetic screen result data for Allele 2.

After the Allele 2 data is entered, then the user requests a report. Although not shown in the figures, the program can allow the user to review the data entered prior to requesting the report. In addition, it should be noted that the order of entry of data is arbitrary, and may be re-ordered as desired and compatible with the methods and systems described herein.

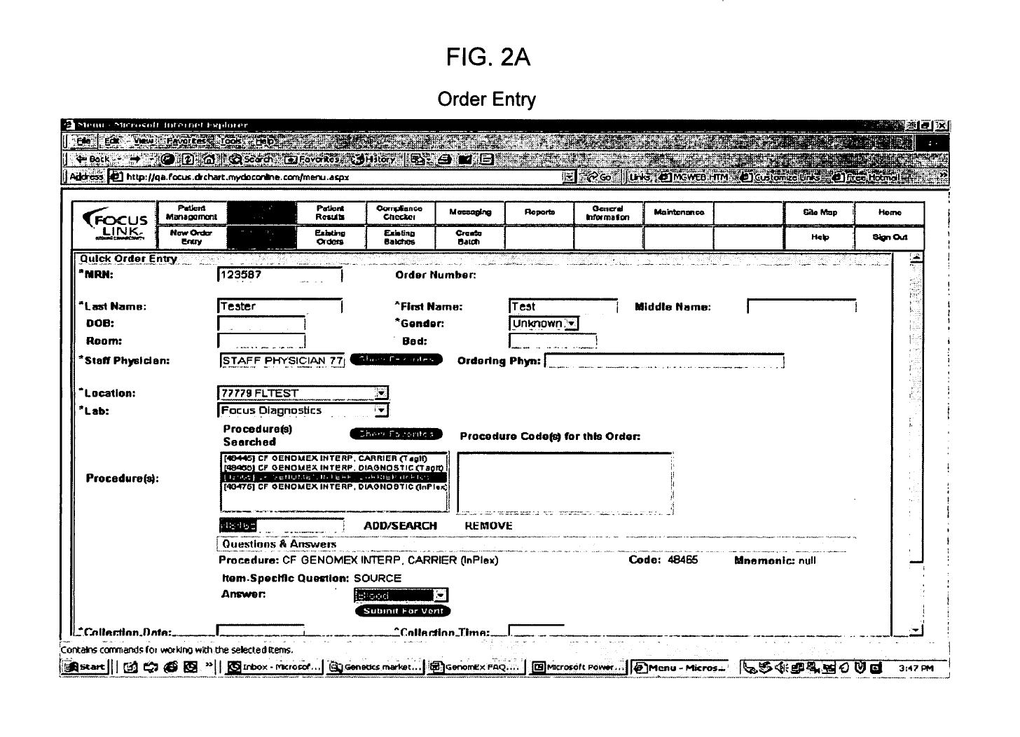

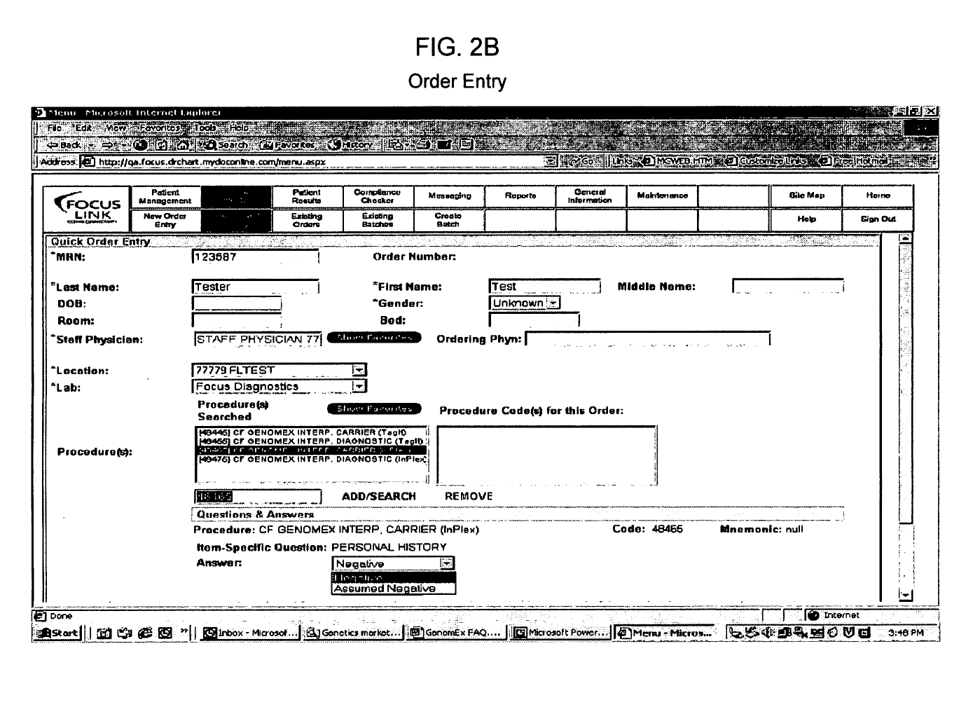

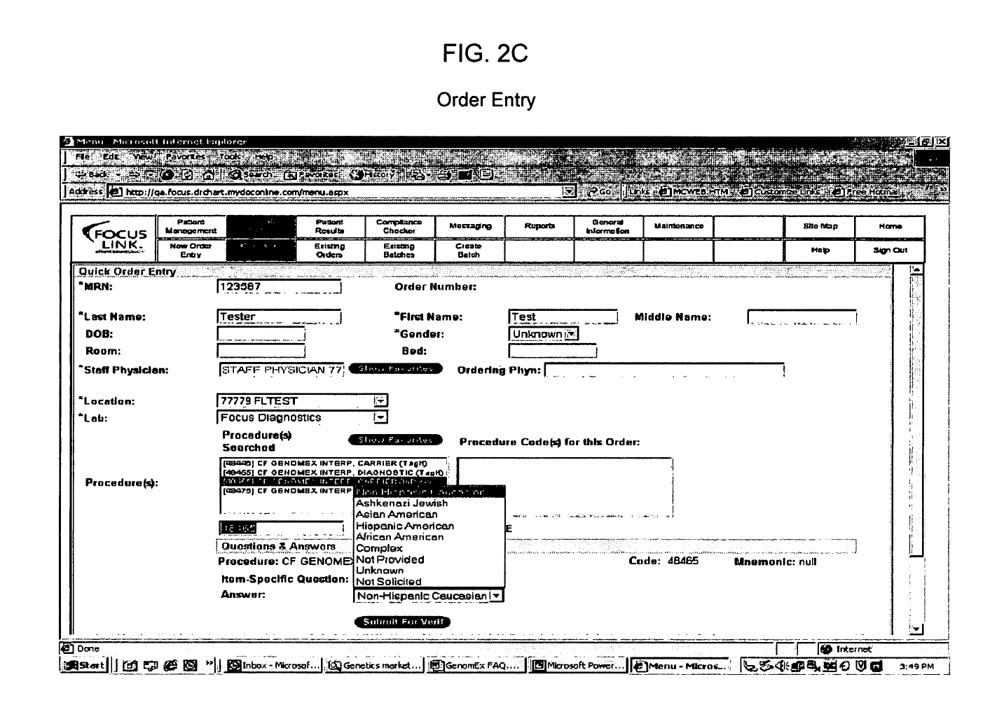

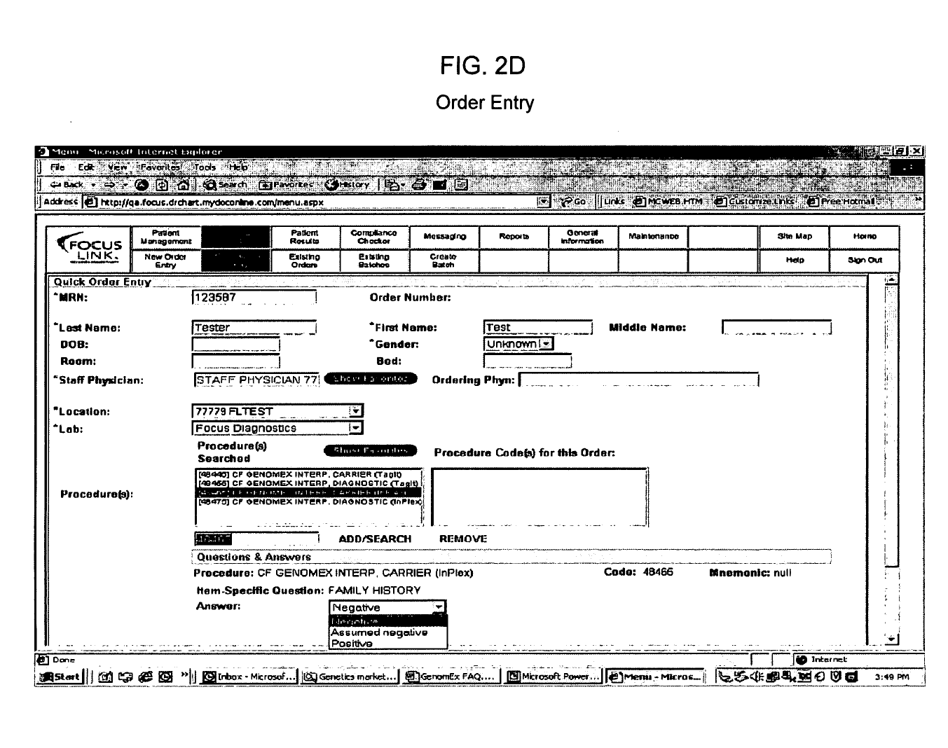

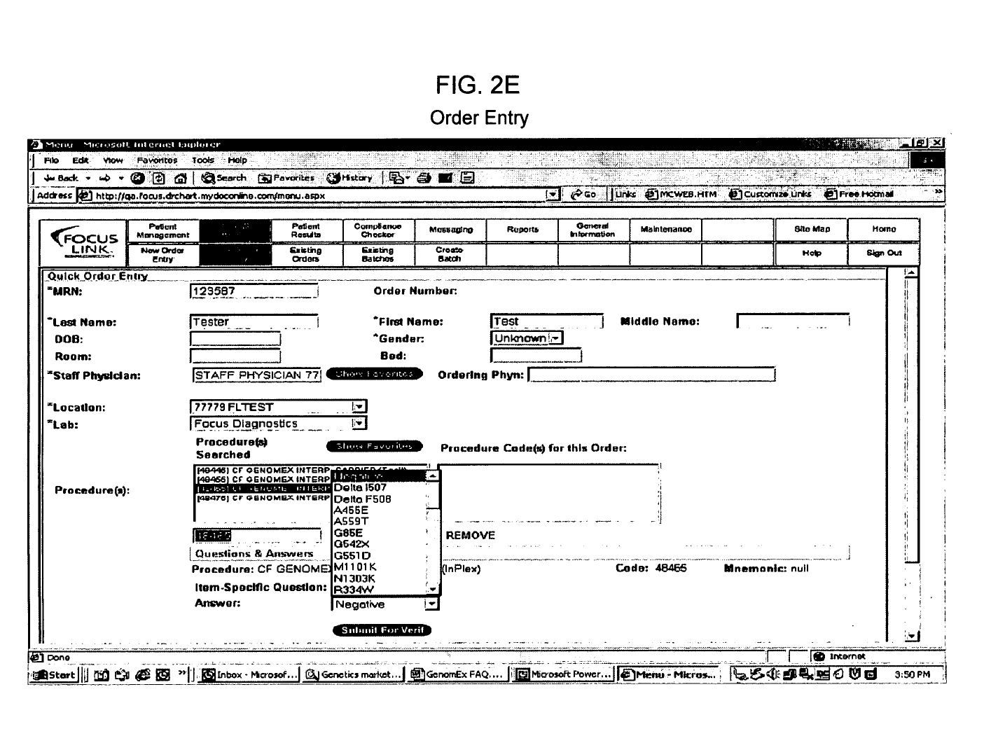

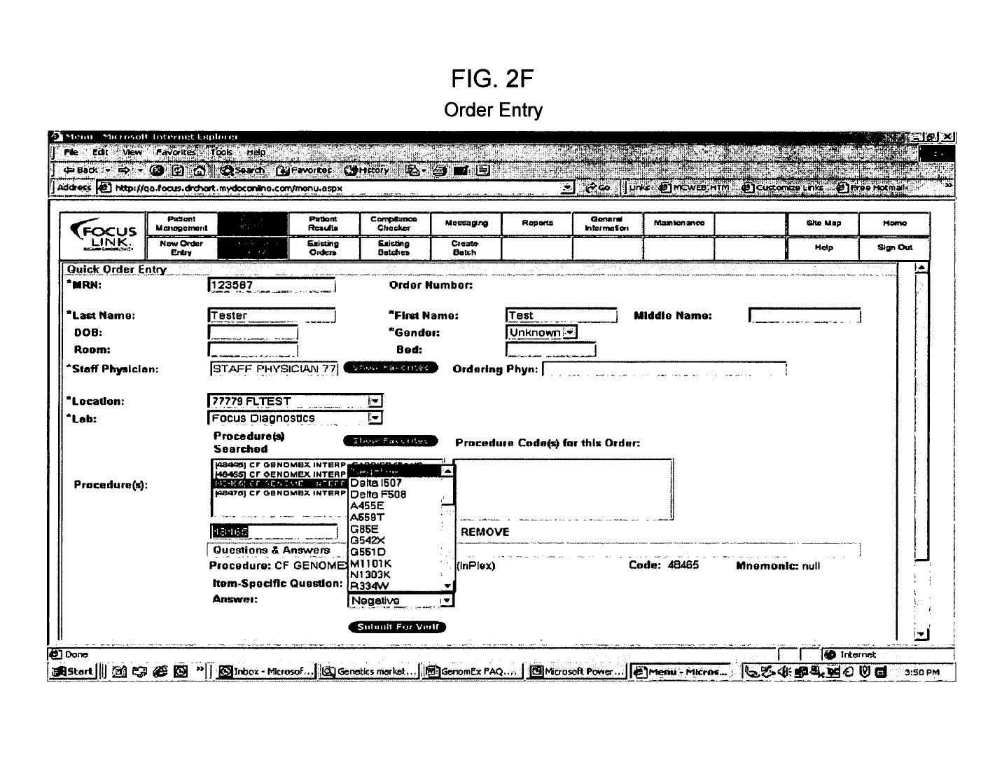

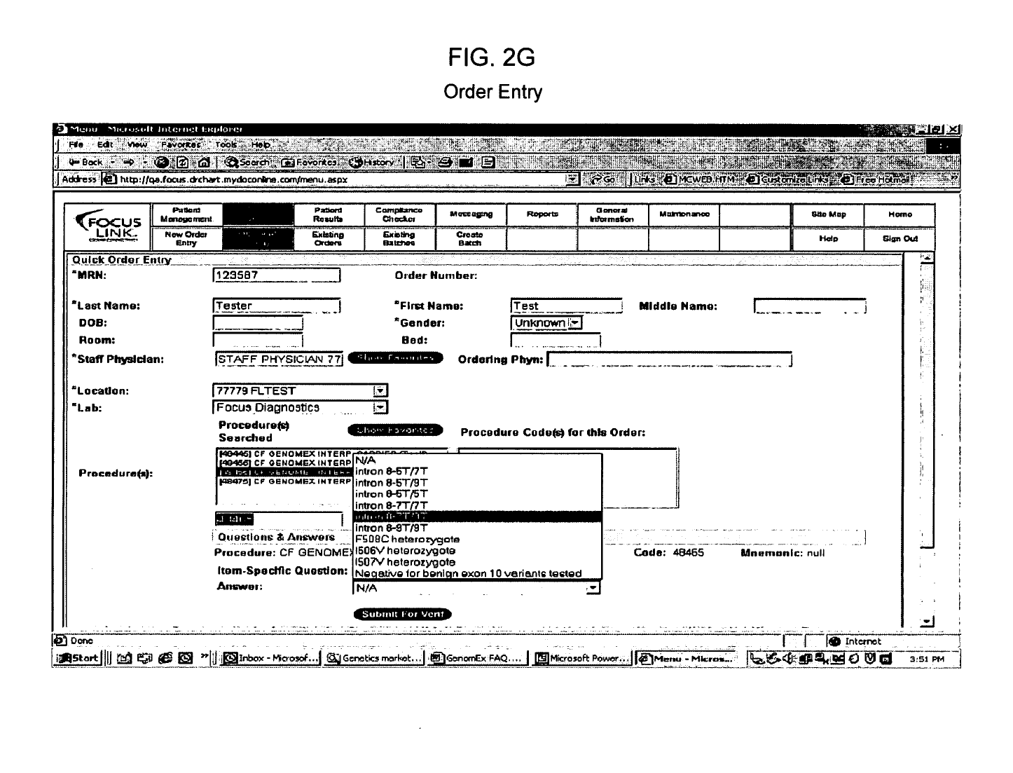

The data input by the user can then be processed on the same computer as used for data entry, or can be transmitted for processing to a computer at a remote site. Transmission can be accomplished via the internet, an intranet, and the like. FIGS. 2A-2G provide an example of

Processing of Data

The data input by the user (e.g., “responses” to the various queries) is then processed and a report generated from the processed data. All or a portion of the data processing and/or report generation can be carried our either at a computer local or remote to the client. For example, the responses can be transmitted to a remote site for data processing, and the processed data released back to the client, and the report generated from the processed data at the client-side.

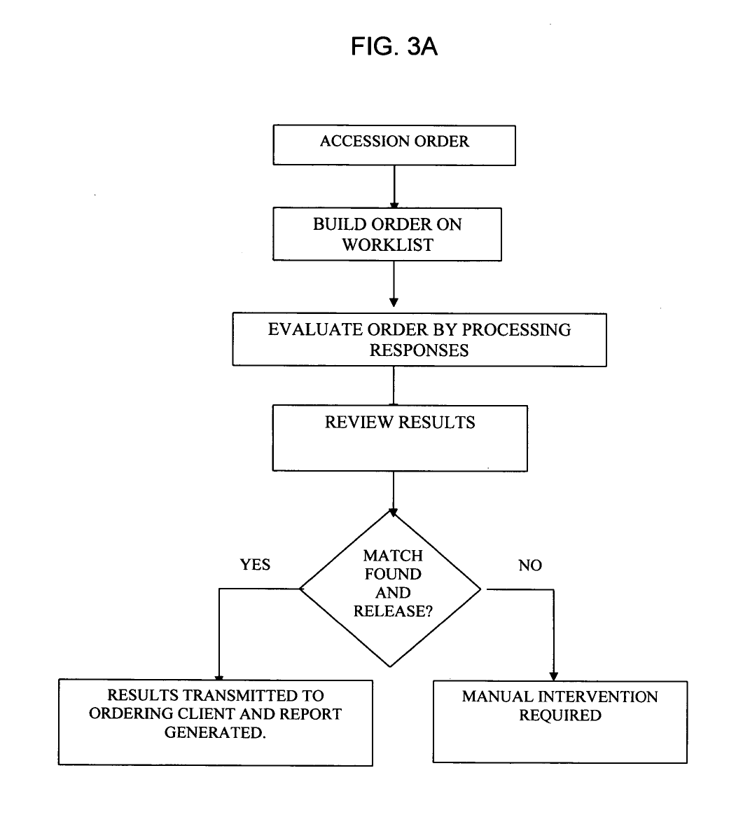

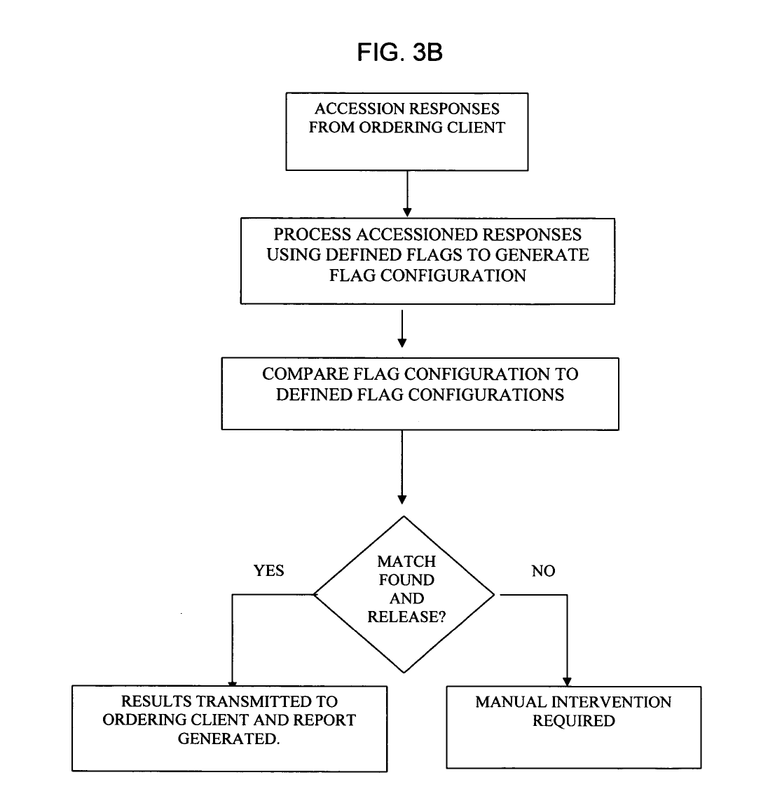

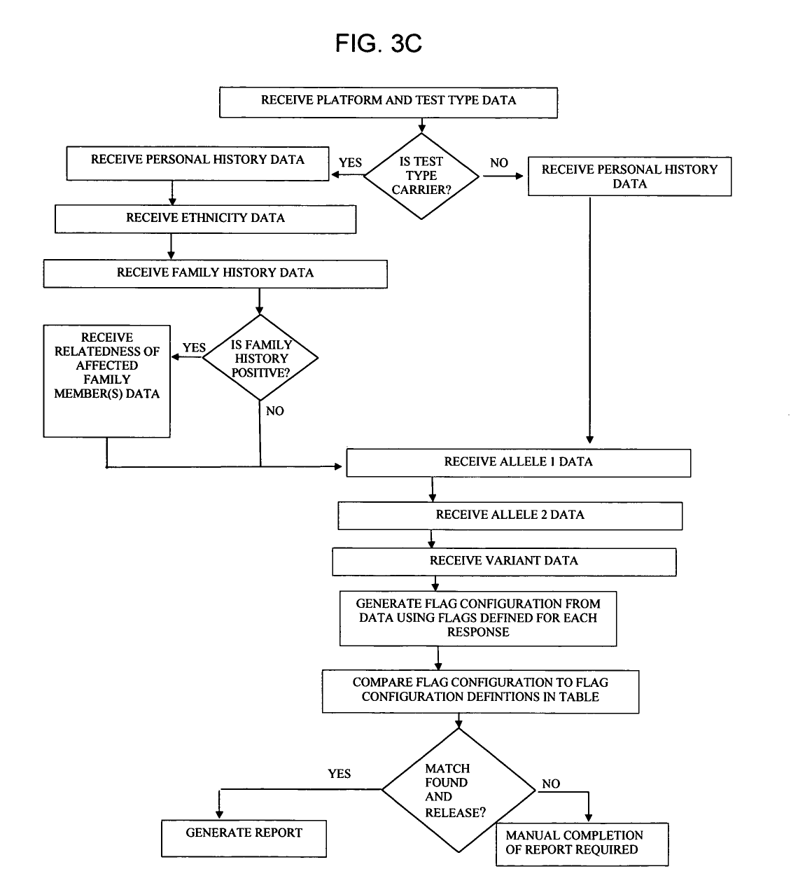

FIG. 3A-3C provide examples of methods of processing data compatible with the methods and systems described herein.

FIG. 3A illustrates an embodiment in which, after receipt of the order, the program provides for accessioning of the order (e.g., into an information system), to make it available for processing. Accessioning provides for loading the response of the ordering client into the appropriate fields and, where desired, assignment of a unique identifier (e.g., to provide for identification of processing of a specific order, referred to in the Example as the “Lab ID” number). Accessioned orders are then available for processing, and the accession order is built on a worklist. At this point, the accessioned orders on the worklist can be manually selected for processing or, optionally, accessioned orders can be automatically processed once placed on the worklist. The orders are then evaluated by processing the responses by comparing the responses for the accession order to a decision tree. The decision tree provides a collection of defined response combinations for which a message code is associated. (The message code provides for text that will be present in the final interpretive report.) If a match is found between the combination of responses in the accessioned order and a combination of responses in the decision tree, then the appropriate message code is assigned to the order. As exemplified in FIG. 3A, after evaluating is completed, the results can be reviewed, which review may be optional or mandatory. If a match was found between the response combination from the order, and a response combination in the decision tree, then the results are transmitted to the ordering client and a report generated. Alternatively, the results can be used to generate a report, and the report transmitted to the client (e.g., rather than the report being generated on the client-side).

FIG. 3B provides a similar example, in which the responses as received from the client in response to the queries are accession from the ordering client. The accessioned responses are then processed using defined flags to generate a flag configuration. A “flag configuration” as used herein refers to an ordered string of flags, where each flag defines a response to a query, and the order of flags in the flag configuration corresponds to the order of responses. The flags can be ordered in the flag configuration in the order in which the corresponding responses are entered, or can be ordered in numerical order according to the number of a test code assigned to each query or data type. A “test code” as used herein refers to a code assigned to a type of data entered, e.g., Personal History, Ethnicity, Family History, Allele 1, Allele 2, Variant (of Allele 1 and/or Allele 2), and the like.

The flag configuration thus represents a particular combination of responses, where each flag in the flag configuration defines a different response to a query. The flag configuration is then compared to defined flag configurations in a table. The table provides flag configurations for which a message code has been assigned.

As exemplified in FIG. 3B, if a match is found between the flag configuration in the order and a flag configuration in the table, then the message code is assigned to the order and the results released. The results can then be transmitted to the ordering client and a report generated. Alternatively, the report can be generated at the reviewer-side, and the report transmitted to the ordering client (rather than being generated at the client-side. If there is not match, then the results are not released and instead manual intervention is required for the report to be completed. Stated differently, if there is not match between the flag configuration of the order and a flag configuration in the table, then there is no message code associated with that flag configuration, and the text for the interpretive report must be generated manually.

FIG. 3C provides a more detailed example of handling of responses (referred to as “data”) by receipt of each, with optional reflex to receive data regarding relatedness of affected family member(s). As exemplified in FIG. 3C, the program receives the platform and test type data (e.g., which may be represented by a unit code that reflects a combination of platform and test type). While FIG. 3C indicates that the platform and test type data are treated together (e.g., each are provided as a single unit code); alternatively each of the platform and test type can be handled as separate responses.

In FIG. 3C, if the test type is carrier, then the program can optionally receive Personal History data. The program, as exemplified in FIG. 3C, then receives data regarding Ethnicity and data regarding Family History are received. While the order of entry is shown in FIG. 3C as receiving Ethnicity data prior to Family History data, this order is arbitrary and can be reversed. It should be noted that the order of entry of data is arbitrary, and may be re-ordered where compatible with analysis. Where Family History is positive, then the program can provide for receiving data regarding relatedness of affected family member(s) (which may be provided from a drop-down list, or in the form of manually entered text). If the test type is diagnostic, the program can optionally receive Personal History data (although presumably such should be positive, although confirmation of such may be required as a precaution).

In either the carrier or diagnostic aspects, Allele 1 data is received. If Allele 1 is positive for a gene mutation, and the mutation as a variant of interest (i.e., a variant that is indicative of changed carrier or disease risk), then the program receives variant data. These steps are repeated for Allele 2 data. In another embodiment, as illustrated in FIG. 3C, variant data can be provided after receipt of Allele 1 and Allele 2 data. In another embodiment, rather than provide for receiving gene mutation and variant data in separate steps, the gene mutation and variant data can be collected for each allele as a single step for each allele.

The program then generates a flag configuration from the data (i.e., the responses to the queries) using flags defined for each response. As discussed above, “flag configuration” as used herein refers to an ordered string of flags, where each flag defines a response to a query, and the order of flags in the flag configuration corresponds to the order of responses. The flags can be ordered in the flag configuration in the order in which the corresponding responses are entered, or can be ordered in numerical order according to the number of a test code assigned to each query or data type. A “test code” as used herein refers to a code assigned to a type of data entered, e.g., Personal History, Ethnicity, Family History, Allele 1, Allele 2, Variant (of Allele 1 and/or Allele 2), and the like.

The generated flag configurations are then compared to a table having flag configurations that correspond to a particular message code. If a match if found between the generated flag configuration and a flag configuration defined in the table, then the corresponding message code is assigned to the order, the results released, and the report generated. If there is no match, then manual completion of the report is required.

The message codes are provided for particular response combinations (e.g., flag configurations) in the table as deemed practical. For example, in carrier screening analysis if Allele 1 and Allele 2 data are negative for mutations, then the carrier risk is based on family history and ethnicity. If family history is negative (or assumed negative, if, not provided or not solicited), then an electronic report can be readily generated based on population-based carrier risk from the ethnicity response. For example, if a flag configuration indicates a Personal History and Family History that are Negative, Not Solicited, or Not Provided; a Negative result for both Allele 1 and Allele 2, and thus Variant N/A, the flag configuration has an assigned a message code, and a report generated provides a Revised Carrier Risk based on population risk according to the Ethnicity response flag (e.g., Not solicited, non-Hispanic Caucasian, Ashkenazi Jewish, Hispanic American, African American, Asian American, Complex, or Not provided).

If family history is positive, then, where possible, a report can be generated with carrier risk based on family history. In certain embodiments, it may be desirable for an indication of positive family history to have no match with response combinations (e.g., flag configurations) having a pre-assigned message code, and thus require manual intervention for completion. In other embodiments, a message code can be provided for flag configurations indicative of particular relatedness data indicating the relation of the affected family member(s) to the patient.

In some embodiments of carrier screening analysis, where at least one allele is positive for a mutation, carrier risk is based on the presence of the mutation, or a particular variant of a mutation. In some embodiments, where at least one allele is positive for a mutation, the carrier risk is based on the presence of the mutation or a particular variant of the mutation without adjusting carrier risk for ethnicity or family history data. In some embodiment, where both alleles are positive for a mutation, it may be desirable to require manual completion of the report. For example, in the specific example provided, if the flag configuration indicates a positive Family History, then manual completion is required. Also in the specific example provided, if a flag configuration indicates both Allele 1 and Allele 2 has a non-Delta F508 mutation mutation, then manual completion is required.

In general, if a combination of response to the queries (e.g., a flag configuration) do not correspond to a specific reflex message code (e.g., which contains a particular reporting message which provide information about revised carrier risk or diagnosis), then the order remains as pending, release does not occur, and no report is generated. Manual intervention is thus required for completion of the report and release to the client. Alternatively, a particular combination of responses could instead be associated with an “alert” in the definitions table, which then highlights an order as requiring manual intervention for report completion.

An algorithm is then executed on the flag configuration to generate a report, where different flag configurations are assigned to different report codes. The report codes correspond to selected text, which is then used to populate one or more report fields of a report.

It will be appreciated that the methods and systems can be readily modified to provide additional message codes for additional responses (e.g., flag configurations), so that more reports can be generated completely electronically. However, such may not be desired, e.g., in view of the number of message codes required, and/or the probability of rare response combinations (e.g., flag configurations) occurring, making it impractical from a business standpoint). Alternatively or in addition, manual intervention by the reviewer may be desired in particular situations, where it may be desirable to convey additional information in the report that may be unique to a patient's genetic screen results.

Reports

A “report” as described herein is an electronic or tangible document which is composed of report elements that provide information of interest relating to the genetic screen and its results. A report can be completely or partially electronically generated, and can include all or a portion of the details of the genetic test data (e.g., platform, test type), patient data (e.g., ethnicity, family history, personal history), and genetic test result data (e.g., data for one or both alleles (allele 1 data and allele 2 data), which generally includes data indicating the presence or absence of a gene mutation, which may include information about variants of the gene mutation).

Reports are generally generated after release of processing results as described in the methods herein. If processing does not provide for a message code for an interpretive report field (as a result of a response combination failing to match defined response combinations in a table associating response combinations with message codes), then release is not possible, and report generation is not possible, without manual intervention to complete the interpretive report field(s). Alternatively, processed results that lack one or more fields can be associated with an alert to distinguish such situations from processed results that contain all fields and can thus be released. In some embodiments, the computerized methods include an algorithm to direct sorting of processed results that are suitable for quality control review and release (i.e., can provide for generation of a final report) and those that require manual intervention for completion, and can be stored at least temporarily in separate databases where desired. Such sorting can facilitate production of reports.

Where government regulations or other restrictions apply (e.g., requirements by health, malpractice, or liability insurance), all results, whether generated wholly or partially electronically, are subjected to a quality control routine prior to release to the user.

A “report field ”, which may also be referred to as a “report element”, is a portion of a report that corresponds to input or output data. Examples of such report fields include a genetic test data fields (e.g., platform field, test type field), patient data fields (e.g., ethnicity field, family history field, personal history field), and genetic test result data fields (e.g., allele 1 data field, allele 2 data field, which can be for one or both alleles (allele 1 data and allele 2 data), which generally includes data indicating the presence or absence of a gene mutation, which may include information about variants of the gene mutation). Other report fields can include recommendations, which are provided in the report as a recommendation field, which can be part of an interpretive report field.

In general, the reports are generated by population of report fields with data that correspond to the data entered or a result obtained by execution of algorithm(s) on responses provided by a client, according to the methods described herein.

As noted above, the reports can be partially or completely electronically generated. Routine Carrier Screening and Routine Diagnostic interpretive report fields of a report can be completely electronically generated, with review by or under the supervision of a board-certified geneticist.

As noted above, processed results that require manual completion can contain an alert (e.g., text, symbol, color-coding, and the like) which prompts manual intervention by a reviewer to review and complete the report (e.g., edit the text in-the report, delete the report and generate a completely manual report, etc.). The alert can be generated in response to a key code (e.g., request for a diagnostic interpretive report), a flag (e.g., positive family history; presence of at least one allele having a mutation that has variants relevant to analysis of risk assessment), and/or a flag configuration (e.g., an indication of the presence of mutant genes on both alleles). In the context of CF genetic screens, alerts for manual intervention in report completion can be provided for, for example, a positive Family History (which can require review of relatedness of the affected family member(s)); the presence of a R117H mutation (which mutation has several variants (polyT tract variants designated as 5T, 7T, and 9T, where the presence of 5T is indicative of a higher carrier risk than the presence of 7T or 9T); the presence of mutations on both alleles; or when a diagnostic test is requested. Alternatively, rather than provide such an alert, such processed results can simply be held as “pending” and cannot be released until manual intervention is provided.

Thus the methods and systems of the invention can provide for both wholly electronically-generated carrier reports, as well as partially electronic, at least partially manual reports for complex presentations (e.g., for reports for certain types of carriers and for certain types of diagnostic reports, where desired).

The various data relating to different report fields may appear in the report in the same of adjacent report regions of the report, or may be distributed over different, discontinuous portions of the report. In addition, the same or similar data may be repeated in different report fields as may be helpful in reading, analysis, or understanding the report or its implications. The following are exemplary report fields and data which may be included in the reports generated by the methods and systems described herein.

Testing Facility

The report can include information about the testing facility, which information is relevant to the hospital, clinic, or lab in which the genetic screen was conducted. This information can include one or more details relating to, for example, the name and location of the testing facility, the identity of the lab technician who conducted the assay and/or who entered the input data, the date and time the assay was conducted and/or analyzed, the location where the sample and/or result data is stored, the lot number of the reagents (e.g., kit, etc.) used in the assay, and the like. Report fields with this information can generally be populated using information provided by the user.

Order Data

The order data in the report can include information relevant to the particular order requested by the user. This can include Procedure code(s) (which generally also include a short descriptor assigned to the procedure code) to identify the platform used and the test type (carrier or diagnostic) desired. Procedure code(s) can be accompanied by a pre-assigned description. The order data can also include the name of the user entering the data, and can further include the date and time of data entry. This order data can also include an order number, which can be assigned to facilitate report tracking and, where desired, invoicing. Report fields with order data information can generally be can be populated using data entered by the user, which can be selected from among pre-scripted selections (e.g., using a drop-down menu).

Service Provider

The report can include information about the service provider, which may be located outside the healthcare facility at which the user is located, or within the healthcare facility. Examples of such information can include the name and location of the service provider, the name of the reviewer, and where necessary or desired the name of the certified geneticist. Report fields with this information can generally be populated using data entered by the user, which can be selected from among pre-scripted selections (e.g., using a drop-down menu). Other service provider information in the report can include contact information for technical information about the result and/or about the interpretive report.

Patient Data

The patient data can include patient data relevant to genetic screening, which data has been subjected to the algorithms described herein to generate a report and can include ethnicity, family history (which may include data about relatedness of any affected family member(s)), and personal history. Ethnicity and family history data can be particularly relevant in a report for carrier screening, e.g., where both alleles are negative for a mutation. The report can also include administrative patient data (that is, data that is not essential to the analysis of genetic test results), such as information to identify the patient (e.g., name, patient date of birth (DOB), gender, mailing and/or residence address, medical record number (MRN), room and/or bed number in a healthcare facility), insurance information, and the like), the name of the patient's physician or other health professional who ordered the genetic test and, if different from the ordering physician, the name of a staff physician who is responsible for the patient's care (e.g., primary care physician). Report fields with this information can generally be populated using data entered by the user.

Genetic Screen

The genetic screen information (which may also be referred to as a genetic test information) refer to the information relevant to the genetic screen used and the results obtained from the genetic screen. This information can thus include the number of mutations analyzed; the names of the mutations analyzed (e.g., in the context of CF, “Delta 1507”); and text indicating whether the mutations screened include those recommended for analysis by a professional organization (e.g., ACOG, ACMG, ACHG, etc.). Report fields with this information can generally be populated automatically based on the information provided with respect to the platform data, which may be entered as order data above.

The portion of the report indicating the genetic screen information can also include the results of the genetic screen conducted as entered by the user relating to the presence or absence of a mutant gene. This information can include the name of the gene screened; the presence or absence of a mutation detected on a first allele and, where desired, presence or absence of a mutation detected on a second allele; the identity of any mutation detected (e.g., in the context of CFTR gene analysis, ΔF508); and identity of a mutation variant detected if applicable (e.g., in the context of CFTR gene analysis, R117H, intron 8-5T/7T). The presence of a mutation and/or variant can be indicated simply by providing the name of the mutation. Report fields with this information can generally be population using information entered by the user.

Sample Data

The sample data can provide information about the biological sample analyzed in the genetic screen such as the source of biological sample obtained from the patient (e.g., blood, buccal swab, mouthwashing, cord blood, unknown, etc.) and the date and time collected. Report fields with this information can generally be populated using data entered by the user, some of which may be provided as pre-scripted selections (e.g., using a drop-down menu).

Interpretive Report

The interpretive report portion of the report includes information generated after processing of the data as described herein. As described in more detail below, the interpretive report can further include information of particular relevance to the data processing, such as Indication (e.g., Carrier Screening or Diagnosis) and genetic test result (e.g., “Negative for mutations tested”). It will be appreciated that interpretive report will vary according to the analysis requested (e.g., carrier or diagnostic).

The interpretive report can include, for example, Indication (e.g., carrier screening, diagnosis of a symptom associated with CF, etc.); Family History Details (which, when positive, can include narrative describing the relatedness of the affected family member(s)); Prior Carrier Risk (e.g., based solely on population risk, e.g., based solely on population risk according to patient's ethnicity or Prior Diagnosis (if any based on, e.g., symptoms);); Result of genetic screen (e.g., “Negative for mutations tested”), Revised Carrier Risk or Revised Diagnosis (or “Diagnosis”); Interpretation; and, optionally, Recommendation(s). Exemplary Recommendations are described below in more detail.

The Revised Carrier Risk, Revised Diagnosis (or “Diagnosis), and Interpretation are portion of report that are generated as a result of processing of the data according to the methods and systems described herein. For example, as set out in the Example below, if processing of the data provided by the user generates a response combination (e.g., flag configuration) which is assigned a corresponding message code, then the text of that message code appears in the Interpretation. Also, since generation of the report can require manual intervention, the Interpretation can be composed of text elements that are partially or completely auto-populated, or which are completely or partially manually generated.

Recommendations

The Interpretation portion of the report can include a Recommendation(s). This recommendation can be assigned to a particular response combination (e.g., flag configuration) for automatic inclusion in a report, or can be generated by manual intervention (e.g., in response to an alert). For example, in the context of a carrier risk analysis, exemplary recommendations can include, but are not necessarily limited to:
Genetic counseling for patient and partner; carrier study for partner
Refer relative (e.g. an affected family member) for mutation analysis to identify familial mutation; genetic counseling for patient and partner
Refer affected sibling or both parents for mutation analysis to identify familial mutation; genetic counseling for patient and partner
Refer patient's co-parent for mutation analysis; genetic counseling for patient and co-parent
Determine details of positive family history; genetic counseling for patient and partner
Validation by other testing of patient (e.g., sweat electrolyte evaluation in the context of CF testing)
Validation by other testing of patient (e.g., sweat electrolyte evaluation in the context of CF testing); genetic counseling for parents

In the context of diagnostic assays, recommendations can include recommendations for validation of diagnosis by other methods, suggestions for possible supportive or therapeutic intervention, and the like.

Other features

It will be readily appreciated that the reports can include all or some of the elements above, with the proviso that the report generally includes at least the elements sufficient to provide the analysis requested by the user (e.g., information relevant to providing a carrier risk assessment (or revised carrier risk assessment) or diagnosis as requested by the user).

It will also be readily appreciated that the reports can include additional elements or modified elements. For example, where electronic, the report can contain hyperlinks which point to internal or external databases which provide more detailed information about selected elements of the report. For example, the genetic test platform report element can include a hyperlink to a website of the manufacturer of the genetic test platform. The patient data element of the report can include a hyperlink to an electronic patient record, or a site for accessing such a patient record, which patient record is maintained in a confidential database. This latter embodiment may be of particular interest in an in-hospital system or -in-clinic setting.

Computer-Based Systems and Methods

The methods and systems described herein can be implemented in numerous ways. In one embodiment of particular interest, the methods involve use of a communications infrastructure, for example the internet. Several embodiments of the invention are discussed below. It is also to be understood that the present invention may be implemented in various forms of hardware, software, firmware, processors, or a combination thereof. The methods and systems described herein can be implemented as a combination of hardware and software. The software can be implemented as an application program tangibly embodied on a program storage device, or different portions of the software implemented in the user's computing environment (e.g., as an applet) and on the reviewer's computing environment, where the reviewer may be located at a remote site associated (e.g., at a service provider's facility).

For example, during or after data input by the user, portions of the data processing can be performed in the user-side computing environment. For example, the user-side computing environment can be programmed to provide for defined test codes to denote platform, carrier/diagnostic test, or both; processing of data using defined flags, and/or generation of flag configurations, where the responses are transmitted as processed or partially processed responses to the reviewer's computing environment in the form of test code and flag configurations for subsequent execution of one or more algorithms to provide a results and/or generate a report in the reviewer's computing environment.

The application program for executing the algorithms described herein may be uploaded to, and executed by, a machine comprising any suitable architecture. In general, the machine involves a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof) which is executed via the operating system. In addition, various other peripheral devices may be connected to the computer platform such as an additional data storage device and a printing device.

As a computer system, the system generally includes a processor unit. The processor unit operates to receive information, which generally includes genetic test data (e.g., platform, test type), patient data (e.g., ethnicity, family history, personal history), and genetic test result data (e.g., data for one or both alleles (allele 1 data and allele 2 data), which generally includes data indicating the presence or absence of a gene mutation, which may include information about variants of the gene mutation). This information received can be stored at least temporarily in a database, and data analyzed to generate a report as described above.

Part or all of the input and output data can also be sent electronically; certain output data (e.g., reports) can be sent electronically or telephonically (e.g., by facsimile, e.g., using devices such as fax back). Exemplary output receiving devices can include a display element, a printer, a facsimile device and the like. Electronic forms of transmission and/or display can include email, interactive television, and the like. In an embodiment of particular interest, all or a portion of the input data and/or all or a portion of the output data (e.g., usually at least the final report) are maintained on a web server for access, preferably confidential access, with typical browsers. The data may be accessed or sent to health professionals as desired. The input and output data, including all or a portion of the final report, can be used to populate a patient's medical record which may exist in a confidential database at the healthcare facility.

A system for use in the methods described herein generally includes at least one computer processor (e.g., where the method is carried out in its entirety at a single site) or at least two networked computer processors (e.g., where data is to be input by a user (also referred to herein as a “client”) and transmitted to a remote site to a second computer processor for analysis, where the first and second computer processors are connected by a network, e.g., via an intranet or internet). The system can also include a user component(s) for input; and a reviewer component(s) for review of data, generated reports, and manual intervention. Additional components of the system can include a server component(s); and a database(s) for storing data (e.g., as in a database of report elements, e.g., interpretive report elements, or a relational database (RDB) which can include data input by the user and data output. The computer processors can be processors that are typically found in personal desktop computers (e.g., IBM, Dell, Macintosh), portable computers, mainframes, minicomputers, or other computing devices.

The networked client/server architecture can be selected as desired, and can be, for example, a classic two or three tier client server model. A relational database management system (RDMS), either as part of an application server component or as a separate component (RDB machine) provides the interface to the database.

In one embodiment, the architecture is provided as a database-centric client/server architecture, in which the client application generally requests services from the application server which makes requests to the database (or the database server) to populate the report with the various report elements as required, particularly the interpretive report elements, especially the interpretation text and alerts. The server(s) (e.g., either as part of the application server machine or a separate RDB/relational database machine) responds to the client's requests.

The input client components can be complete, stand-alone personal computers offering a full range of power and features to run applications. The client component usually operates under any desired operating system and includes a communication element (e.g., a modem or other hardware for connecting to a network), one or more input devices (e.g., a keyboard, mouse, keypad, or other device used to transfer information or commands), a storage element (e.g., a hard drive or other computer-readable, computer-writable storage medium), and a display element (e.g., a monitor, television, LCD, LED, or other display device that conveys information to the user). The user enters input commands into the computer processor through an input device. Generally, the user interface is a graphical user interface (GUI) written for web browser applications.

The server component(s) can be a personal computer, a minicomputer, or a mainframe and offers data management, information sharing between clients, network administration and security. The application and any databases used can be on the same or different servers.

Other computing arrangements for the client and server(s), including processing on a single machine such as a mainframe, a collection of machines, or other suitable configuration are contemplated. In general, the client and server machines work together to accomplish the processing of the present invention.

Where used, the database(s) is usually connected to the database server component and can be any device which will hold data. For example, the database can be a any magnetic or optical storing device for a computer (e.g., CDROM, internal hard drive, tape drive). The database can be located remote to the server component (with access via a network, modem, etc.) or locally to the server component.

Where used in the system and methods, the database can be a relational database that is organized and accessed according to relationships between data items. The relational database is generally composed of a plurality of tables (entities). The rows of a table represent records (collections of information about separate items) and the columns represent fields (particular attributes of a record). In its simplest conception, the relational database is a collection of data entries that “relate” to each other through at least one common field.

Additional workstations equipped with computers and printers may be used at point of service to enter data and, in some embodiments, generate appropriate reports, if desired. The computer(s) can have a shortcut (e.g., on the desktop) to launch the application to facilitate initiation of data entry, transmission, analysis, report receipt, etc. as desired.

Computer-Readable Storage Media

The invention also contemplates a computer-readable storage medium (e.g. CD-ROM, memory key, flash memory card, diskette, etc.) having stored thereon a program which, when executed in a computing environment, provides for implementation of algorithms to carry out all or a portion of the methods of analysis of genetic test results as described herein. Where the computer-readable medium contains a complete program for carrying out the methods described herein, the program includes program instructions for collecting, analyzing and generating output, and generally includes computer readable code devices for interacting with a user as described herein, processing that data in conjunction with analytical information, and generating unique printed or electronic media for that user.

Where the storage medium provides a program which provides for implementation of a portion of the methods described herein (e.g., the user-side aspect of the methods (e.g., data input, report receipt capabilities, etc.)), the program provides for transmission of data input by the user (e.g., via the internet, via an intranet, etc.) to a computing environment at a remote site. Processing or completion of processing of the data is carried out at the remote site to generate a report. After review of the report, and completion of any needed manual intervention, to provide a complete report, the complete report is then transmitted back to the user as an electronic document or printed document (e.g., fax or mailed paper report). The storage medium containing a program according to the invention can be packaged with instructions (e.g., for program installation, use, etc.) recorded on a suitable substrate or a web address where such instructions may be obtained. The computer-readable storage medium can also be provided in combination with one or more reagents for carrying out a genetic test (e.g., primers, probes, arrays, or other genetic test kit components).

### EXAMPLES

The following examples are put forth so as to further provide those of ordinary skill in the art a disclosure and description of how to make and use various aspects of the present invention, and are not intended to limit the scope of what is regarded as the invention, nor are they intended to represent that the examples below are all or the only actual reduction to practice.

### Example

### Focuslink™—A Computer-Assisted Analysis of CF Genetic Screen Results

The methods and systems of the invention are exemplified by a web-based ordering and reporting system, referred to as FocusLink™. In this system, the client (e.g., a lab technician, health professional, or other user) collects selected patient risk assessment data (e.g., ethnicity, personal history, family history). After performing a CF genetic screen in their laboratory on a platform of interest, the client uses FocusLink™ to order platform-specific interpretation services. The client enters the patient risk assessment data and genetic test result information. The data is transmitted via the internet off-site (e.g., to Focus Technologies) and processed to provide an electronically-generated interpretive report. This interpretive report is then subjected to certain quality control parameters by a reviewer, which reviewer is, or is or under the supervision of, a board-certified geneticist, and released for the client. Under certain circumstances, described below in more detail, the electronically-generated report requires manual intervention for preparation of a complete report; after report completion in this case, the report is then released. Once the report is released, it is then transmitted via the Internet back to the client. This can provide for an interpretive report of a CF genetic screen within 24 hours of receipt of the data in FocusLink™. A unit code also triggers creation of an invoice for the client for the service rendered.

The present example provides for 50 interpretive ” Routine Carrier” reports, and 50 “Routine Diagnostic” reports, where such routine reports can be generated completely electronically.

FocusLink™ thus can alleviate internal and external concern about “incomplete” test offering (e.g., test results without appropriate interpretation), delivers patient and platform-specific reports, and provides a service that is platform-neutral (i.e., the service can be used regardless of the type of platform in which the genetic screen was conducted),

FIGS. 2A-2G are schematics illustrating the user interface for FocusLink™. FIG. 2A provides a screenshot of a user interface which provides fields for entering a medical record number (MRN), patient name, patient date of birth (DOB), gender, room and bed (if in hospital), staff physician name, ordering physician name (“Ordering Phyn”), Location, lab, and procedure performed or requested, as well as procedures codes for the order. As can be seen from FIG. 2A, some of this data is entered by typing in text, while other data can be entered using drop-down menus.

In this example, selection of a procedure from a list of procedures provides for a predetermined set of assumptions and a predetermined set of queries for the user, which are designed to help reduce the amount of data that needs to be entered and user error. The user can select either “CF GENOMEX INTERP, CARRIER (TagIt), which is indicative of both the TagIt™ 40+4 test platform and the test type “carrier”, “CF GENOMEX INTERP, DIAGNOSTIC (TagIt), which is indicative of both the TagIt™ 40+4 test platform and the test type “diagnostic”,“CF GENOMEX INTERP, CARRIER (InPlex), which is indicative of both the InPlex, Invader™-based platform and the test type “carrier” or “CF GENOMEX INTERP, DIAGNOSTIC (InPlex), which is indicative of both the InPlex, Invader™-based platform and the test type “diagnostic”.

Furthermore, in this example, if the user selects a carrier test, then the program assumes the patient's personal history is negative or assumed negative; if a diagnostic test is selected, then the program assumes the patient's personal history is positive (or assumed positive). However, the program can still contain queries for this information regardless of whether a carrier or diagnostic procedure is requested.

The user is then subjected to a series of queries (under the heading “Questions and Answers”). FIG. 2A exemplifies a query relating to the source of the specimen assayed, which may be selected from a drop down list with the answers Blood, Buccal swab, Mouthwashing, Cord blood, or Unknown.

FIG. 2B shows a screenshot in which the user is queried as to the patient's personal history. The user selects an answer from a drop-down menu which includes Negative or Assume Negative. FIG. 2C shows a screenshot in which the user is queried as to the patient's ethnicity. The user selects an answer from a drop-down menu which includes Non-Hispanic Caucasian, Ashkenazi Jewish, Asian American, Hispanic American, African American, Complex, Not Provided, Unknown, and Not Solicited.

FIG. 2D shows a screenshot in which the user is queried as to the patient's family history. The user selects an answer from a drop-down menu which includes Negative, Assumed negative, and Positive. If Positive is selected, then the user is prompted to provide a description of the relatedness of the affected family member(s) (not shown).

FIGS. 2E and 2F show screenshots in which the user is queried as to the results of the genetic screens for CFTR mutations on both alleles of the patient (arbitrarily designated as “Allele 1” and “Allele 2”). The user selects an answer from a drop-down menu which includes Negative and the names of the mutations that were screened in the platform used in the test. The mutations listed are limited to those that are tested in the platform; thus the possible answers from which the user can choose are limited according to the unit code corresponding to the platform (“InPlex™” or “TagIt™”). As shown in FIG. 2G, if the selected mutation has a variant, or there are other special considerations associated with a particular genotype, then the user can select the variant (e.g., a variant of R117H, selected from intron 8-5T/7T, intron 8-5T/9T, intron 8-5T/5T, intron 8-7T/7T, intron 8-7T/9T and intron 8-9T/9T), or special consideration.

The data is then transmitted via the internet to a remote server, where the data is then processed.

Data processing involves 1) Accessioning the order into the Laboratory Information System, 2), Building the accessions(s) on a worklist (CFIIC, CFIID, CFITC, CFITD) and 3) Result entry and release) During Result entry, each accessions results are evaluated as defined in the Interpretive Reporting Master List (Table 1 of the Appendix). In the program,, as shown in the Master List, each possible response for each Test Code is defined by a “flag” (e.g., if the response to Ethnicity is African America, then the test code 8045 in the CFITC worklist is defined by “A”). The responses are then loaded to generate a flag configuration, and the flag configuration compared to determine if it matches a flag configuration assigned to a message code (“MC”). If there is a match, then the appropriate corresponding message code will be assigned to the accession of the order, and the order will remain on the pending list until released. If there is no match, then the order remains on the pending list, and manual intervention is required for completion. An accession that is incomplete after processing and on the pending list cannot be released until after manual intervention to provide an interpretive message. Attempts to manually release such an accession will result in the message ALL RESULTS NOT ENTERED.

The Interpretive Reporting Master List lists the definitions for each of the four types of procedures that can be requested (CFITC, CFITD, CFIIC and CFIID). Each definition contains all of the possible values where a reflex will occur. The table below provides a key to this master list.

Table of Abbreviations and Terms Used in the INTERPRETIVE REPORTING
MASTER LIST of Appendix 1

| | |
|---|---|
| KEY | REFERS TO A DEFINED INTERPRETIVE REPORT (E.G., FOR A |
| | PARTICULAR COMBINATION OF PLATFORM (E.G., INVADER ™ |
| | OR TAGIT ™) AND TEST TYPE (E.G., CARRIER OR |
| | DIAGNOSTIC)) |
| CFIIC | CYSTIC FIBROSIS INTERPRETATIVE WORKLIST, INVADER ™ |
| | PLATFORM, CARRIER TEST |
| CFIID | CYSTIC FIBROSIS INTERPRETATIVE WORKLIST, INVADER ™ |
| | PLATFORM, DIAGNOSTIC TEST |
| CFITC | CYSTIC FIBROSIS INTERPRETATIVE WORKLIST, TAGIT ™ |
| | PLATFORM, CARRIER TEST |
| CFITD | CYSTIC FIBROSIS INTERPRETATIVE WORKLIST, TAGIT ™ |
| | PLATFORM, DIAGNOSTIC TEST |
| TEST CODE | CODE ASSIGNED TO CATEGORY OF DATA INPUT (E.G., |
| | ETHINICITY, PERSONAL HISTORY, FAMILY HISTORY, |
| | ALLELE1, ALLELE2, VARIANT, ETC.) |
| FLAG | DENOTES VARIABLE ASSIGNED TO TEST CODE |
| EVALUATION | DETAILS OF DATA ASSIGNED TO FLAG |
| R EQ | RESULT EQUALS |
| R CON | RESULT CONTAINS |
| N/A | NOT APPLICABLE |
| INTERP | INTERPRETATION |
| FLAG | ORDER OF FLAGS, WHERE ORDER IS DETERMINED BY ORDER |
| CONFIGURATION | OF TEST CODE IN WORKLIST (HERE TEST CODES ARE |
| | ORDERED NUMERICALLY BY TEST CODE NUMBER) |
| #CF | NUMBER ASSIGNED IN DATABASE TO MESSAGE CODE TEXT FOR |
| | REPORT FIELD |

Thus, depending on the procedure selected by the client (CFITC, CFITD, CFIIC and CFIID), during the result entry process, each accessions' results (the client responses) will be processed according to the algorithms set forth in this master list. The flag configurations are then processed to generate a report.

In general, if a flag configuration indicates a Personal History and Family History that are Negative, Not Solicited, or Not Provided; a Negative result for both Allele 1 and Allele 2, and Variant is N/A, the flag configuration is assigned a report code, and a report generated provides a Revised Carrier Risk based only on population risk according to the Ethnicity response flag (e.g., Not solicited, non-Hispanic Caucasian, Ashkenazi Jewish, Hispanic American, African American, Asian American, Complex, or Not provided).

If a flag configuration indicates that at least one allele is positive for a mutation (i.e., is not “Negative”), then a report code (also referred to as a “message code” is assigned, and a report generated based on a flag configuration composed of Personal History, Allele 1, Allele 2, and Variant data flags. In this latter example, thus, the flags for Ethnicity and Family History are not used in generating the flag configuration to identify a report code for population of an Interpretation report field.

If a flag configuration indicates a positive Family History, Personal History are any of Negative, Not Solicited, or Not Provided; and a Negative result for both Allele 1 and Allele 2 (with variant being N/A), no message code is assigned. This interpretive report will require manual intervention by the reviewer.

If a flag configuration indicates the presence of two different mutations at least one of which is R117H, and the procedure unit code corresponds to a procedures that is either a carrier screening or a diagnostic test, no message code is assigned. This will require manual intervention by the reviewer for completion of the interpretive report. If the key code is a diagnostic and a R117H mutation is present on either Allele 1 or Allele 2 or both, then an indication of disease severity can optionally be provided.

If a flag configuration indicates both Allele 1 and Allele 2 have a non-Delta F508 mutation, then the flag configuration is assigned, no message code is assigned. This will require manual intervention by the reviewer for completion of the interpretive report.

The FocusLink™ provides four different procedures for carrier screening or diagnosis using either the Invader™ or TagIt™ platforms. The flags, flag configurations, and test codes assigned to various flag configurations are provided in the Tables I in the Appendix.

For example, for the Invader™-based platform, carrier test (CFIIC), the program includes a worklist of test codes 8045-ETHNICITY, 8145-FAMHIS (Family History), 8245-PERHIST (Personal History), 9045-ALLELE1, 9046-ALLELE2, and 8345-VARIANT, with flags defined according to the responses indicated.

The flags for each test code are processed to generate a flag configuration. The flag configuration is composed of a string of flags for each test code, with the flags ordered in the string according to the test code number, i.e., so that the flags are provided in numerical order according to the test code to which they are assigned. Thus for the CFIIC example, the flags for the test codes are ordered numerically by the numbers 8045, 8145, 8245, 9045, 9046, and 8345, and a flag positioned indicative of the user's response to the corresponding data queries for Ethnicity, Family History, Personal History, Allele 1, Allele 2, and Variant, respectively. The test code 8745-INTERP (Interpretation) is added to the worklist. For example, if the user indicated African America, Negative Family History, Negative Personal History, Negative Allele 1, Negative Allele 2, and N/A for Variant, the flag configuration generated for the CFIIC worklist would be AAAAAA.

The flag configuration is then analyzed, and a report code assigned to the 87455-INTERP test code. The report codes correspond to different combination of interpretive report elements, which are then in the Interpretation report field of the report. The report codes correspond to different combinations of text for the Report Fields “Indication” (e.g., Carrier Screening, Diagnosis of a symptomatic patient”, etc.); “Result” (e.g., “Negative for mutations tested”); Recommendations; Interpretation; and a Field referred to as a “Reporting Message”, which corresponds to pre-written text, which contains the interpretive statements that apply to the combination of patient information and results of mutation analysis.

If the flag configuration indicates both allele 1 and allele 2 are negative, then a report code is assigned based on all 6 flags set out above.

For example, a CFIIC worklist having the flag configuration AAAAAA is assigned the report code #CF0005, which is associated with the following text for the Interpretation field of the report:
INDICATION: Carrier screening
PRIOR CARRIER RISK: 1 in 62
RESULT: Negative for mutations analyzed
REVISED CARRIER RISK: 1 in 198
INTERPRETATION: This patient is negative for common mutations that comprise 69% of cystic fibrosis (CF) mutations in his/her ethnic group. We understand that this patient has no personal or family history of CF. Risk calculations are based on reported patient family history and ethnicity.
   The revised risk that this patient is a carrier, based on African American ethnicity, negative family/personal history of CF and negative mutation analysis, is 1 in 198 (0.5%). Although the risk that this patient's child will have CF is decreased, this risk also depends on the carrier status of his/her partner.
      No text is provided in the Recommendation field as the #CF0005 report code instructions that such be omitted.

If a flag configuration indicates a mutation at either Allele2 or Allele2, then the program assigns a report code based on a flag configuration composed of only the Personal History flag (8245-PERHIST), Allele 1 (9045-ALLELE1), Allele 2 (9046-ALLELE2), and Variant (8345-VARIANT).

Tables are included in the Appendix as part of this specification which provide
1) the order of user queries to solicit responses for each of the CFIIC, CFITC, CFIID, and CFITD key codes (CFIIC—Table 1, CFITC—Table 1, CFIID—Table 1, and CFITD—Table 1);
2) the possible response for each of the test codes, and the different report codes assigned to the combinations of possible responses for each test code for each of the CFIIC, CFITC, CFIID, and CFITD key codes (CFIIC—Table 2, CFITC—Table 2, CFIID—Table 2, and CFITD—Table 2);
3) the client responses, report codes, and report field data for the report codes for each of the CFIIC, CFITC, CFIID, and CFITD key codes (CFIIC—Table 3, CFITC—Table 3, CFIID—Table 3, and CFITD—Table 3); and
   These tables are provided as part of the Appendix of this specification.

After flag configuration analysis and assignment of report code(s), the report is generated using the report codes. The report codes direct population of the report fields of the report.

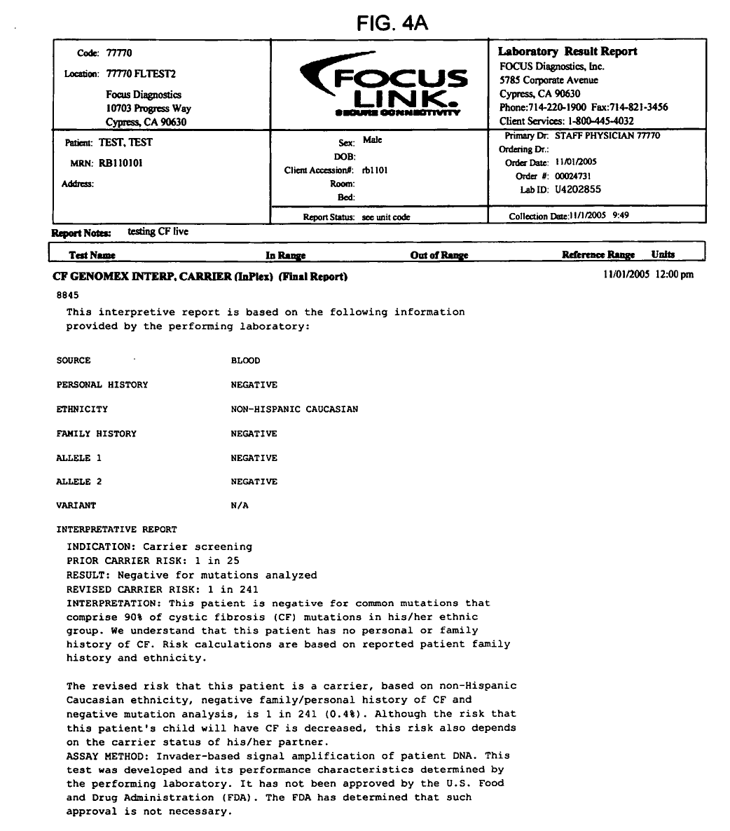

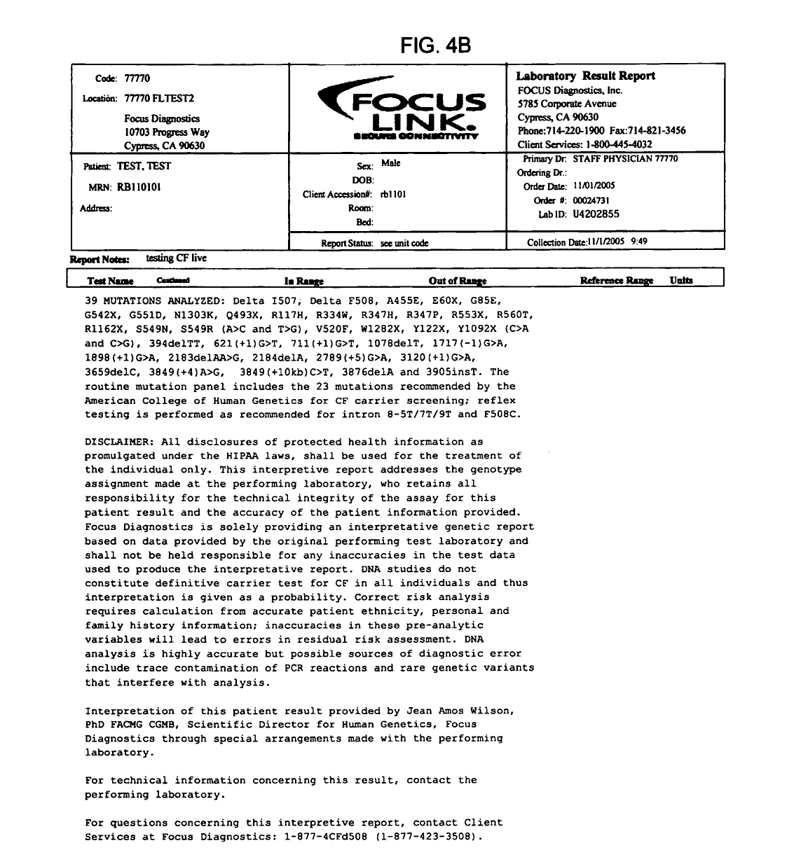

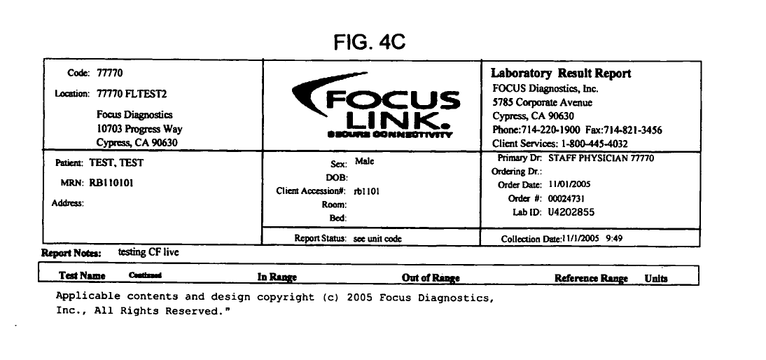

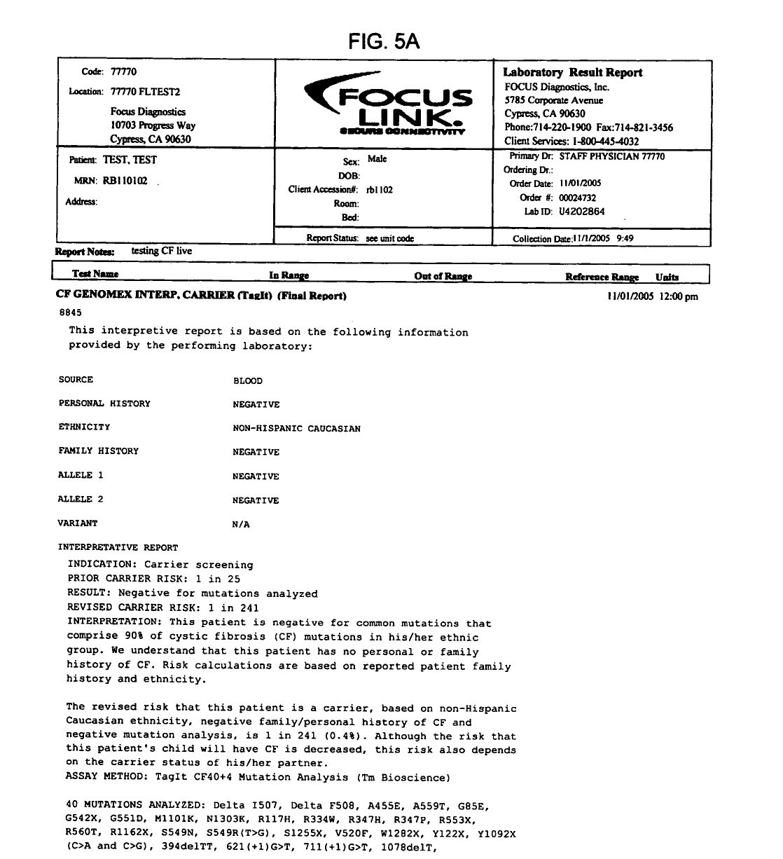

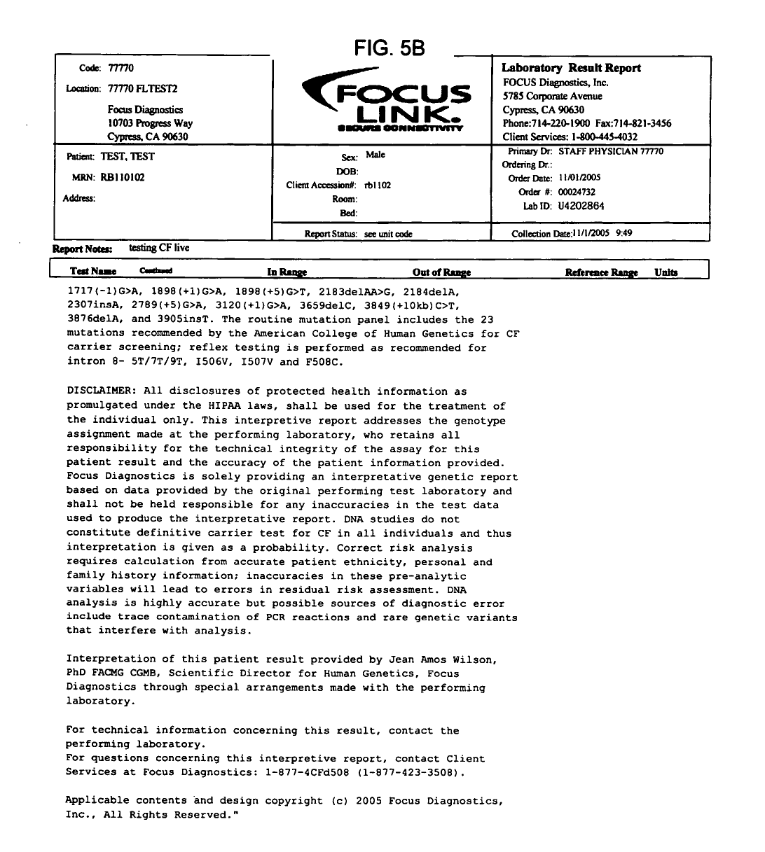

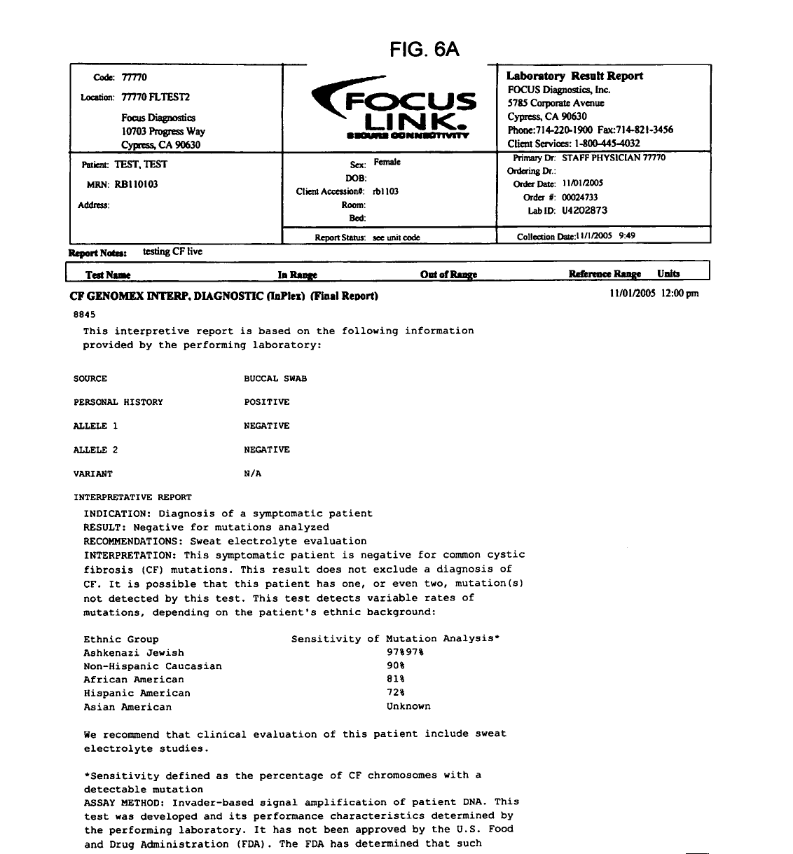

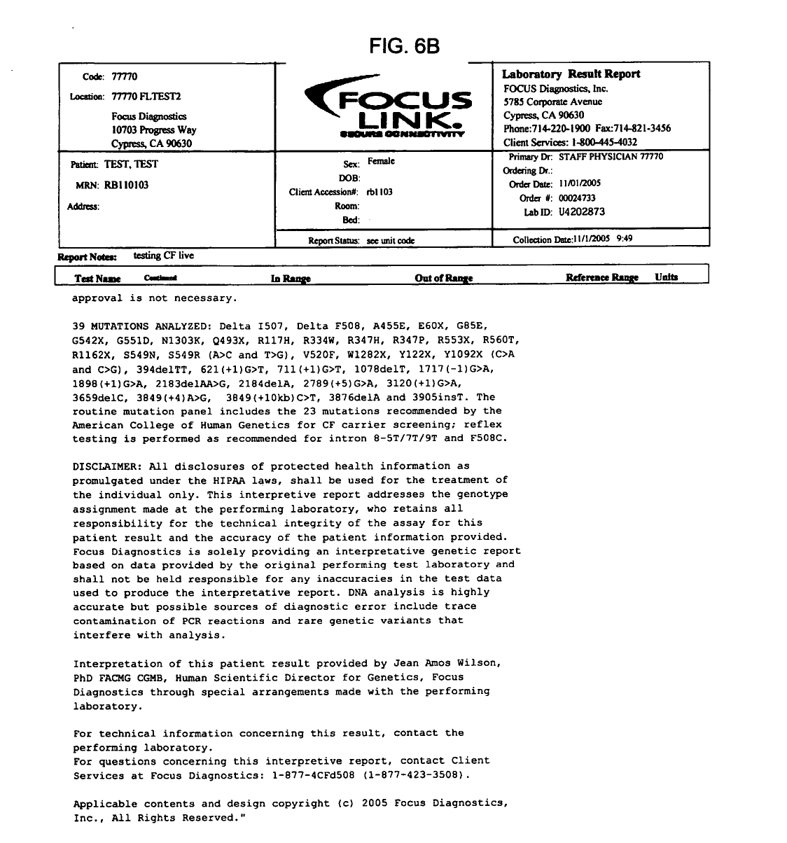

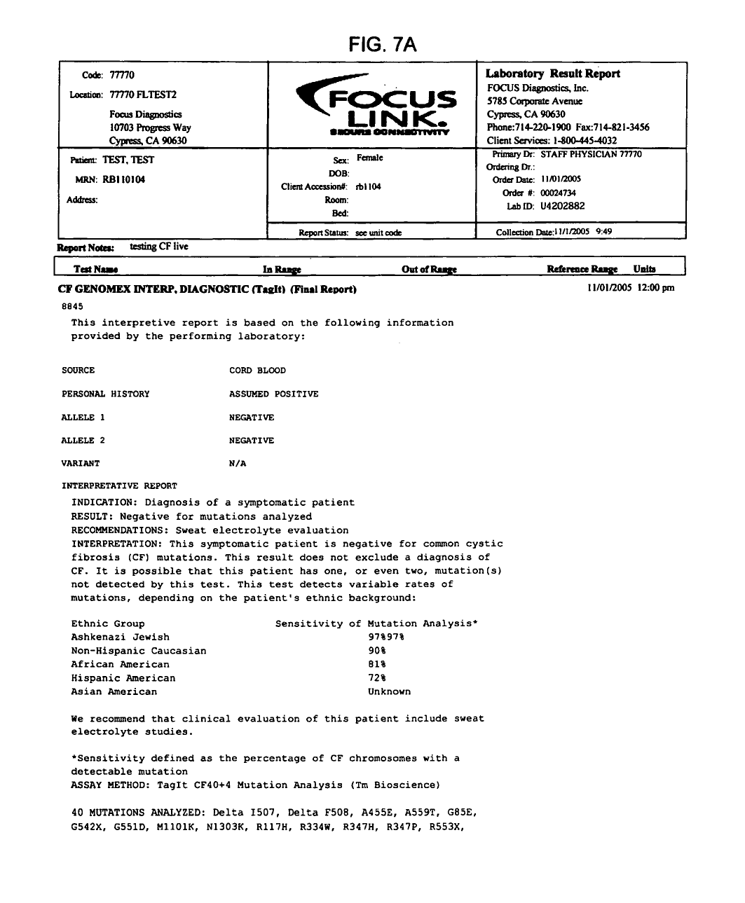

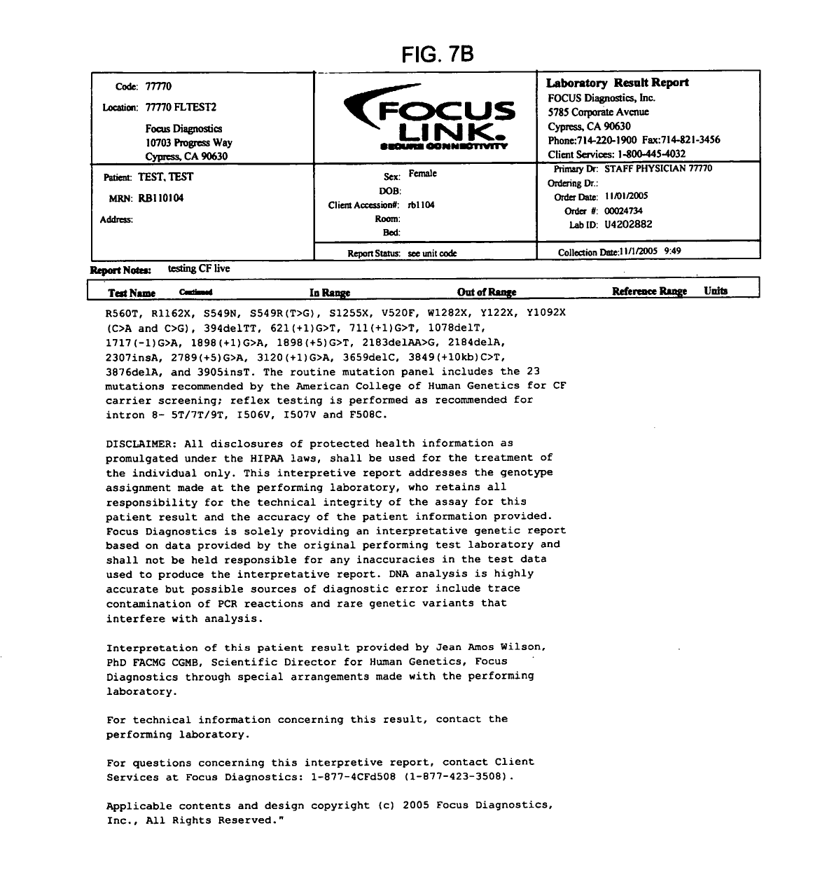

An exemplary report is provided generated from a mock order for a CFIIC procedure is provided in FIGS. 4A-4D.

The preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding some of the principles of the invention and the concepts contributed by the inventors to furthering the art, and are to be construed as being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, e.g., any elements developed that perform substantially the same function, regardless of structure.

Furthermore, while the invention has been illustrated and described in detail in the drawings and foregoing description, the same is to be considered as illustrative and not restrictive in character, it being understood that only exemplary embodiments have been shown and described and that all changes and modifications that come within the spirit of the invention are desired to be protected. A person of ordinary skill in the computer software art is readily capable of practicing this invention based upon this detailed description of the preferred embodiment to date without undue experimentation. A person of ordinary skill in the relevant art, e.g., the computer software art, will also recognize that the architecture exemplified, user interface features, including the window navigation style, mechanism for selecting options, screen content and layouts can be organized differently on the same screen or different screens than as portrayed in the illustrations and still be within the spirit of the invention. The scope of the present invention, therefore, is not intended to be limited to the exemplary embodiments shown and described herein. Rather, the scope and spirit of present invention is embodied by the appended claims.

CFIID TABLE 3
APPENDIX
CFIID Interpretive Report Data
NTERPRETATIVE REPORT, CYSTIC
FIBROSIS DIAGNOSTIC TEST, INVADER PLATFORM
Report Header

| | | WORD # | | | |
|---|---|---|---|---|---|
| | | 55 | 56 | 56a | 57 |
| Client enter | Source | Any value | Any value | Any value | Any value |
| | Ethnicity | Any value | Any value | Any value | Any value |
| | Family history | Any value | Any value | Any value | Any value |
| | Personal History | Positive | Positive | Positive | Positive |
| | Allele 1 | Negative | Delta I507 | Negative | Delta F508 |
| | Allele 2 | Negative | Negative | Delta I507 | Negative |
| | Variant | N/A | N/A | N/A | N/A |
| Code | | CF0055 | CF0056 | CF0056 | CF0057 |
| Report Field | Indication | Diagnosis of a | Diagnosis of a | Diagnosis of a | Diagnosis of a |
| | | symptomatic patient | symptomatic patient | symptomatic patient | symptomatic patient |
| | Result | Negative for mutations | Delta I507 heterozygote; | Delta I507 heterozygote; | Delta F508 heterozygote; |
| | | analyzed | one mutation detected | one mutation detected | one mutation detected |
| | Recommendations | text | text | text | text |
| | Interpretation | text | text | text | text |
| | Canned Message | CF005 | CF005 | CF005 | CF005 |

| 57b | 58 | 58a | 121 | 121b |
|---|---|---|---|---|
| Any value | Any value | Any value | Any value | Any value |
| Any value | Any value | Any value | Any value | Any value |
| Any value | Any value | Any value | Any value | Any value |
| Positive | Positive | Positive | Positive | Positive |
| Negative | A455E | Negative | E60X | Negative |
| Delta F508 | Negative | A455E | Negative | E60X |
| N/A | N/A | N/A | N/A | N/A |
| CF0057 | CF0058 | CF0058 | CF0121 | CF0121 |
| Diagnosis of a | Diagnosis of a | Diagnosis of a | Diagnosis of a | Diagnosis of a |
| symptomatic patient | symptomatic patient | symptomatic patient | symptomatic patient | symptomatic patient |
| Delta F508 heterozygote; | A455E heterozygote; | A455E heterozygote; | E60X heterozygote; one | E60X heterozygote; one |
| one mutation detected | one mutation detected | one mutation detected | mutation detected | mutation detected |
| text | text | text | text | text |
| text | text | text | text | text |
| CF005 | CF005 | CF005 | CF005 | CF005 |
| 60 | 60b | 61 | 61b | 62 |
| Any value | Any value | Any value | Any value | Any value |
| Any value | Any value | Any value | Any value | Any value |
| Any value | Any value | Any value | Any value | Any value |
| Positive | Positive | Positive | Positive | Positive |
| G85E | Negative | G542X | Negative | G551D |
| Negative | G85E | Negative | G542X | Negative |
| N/A | N/A | N/A | N/A | N/A |
| CF0060 | CF0060 | CF0061 | CF0061 | CF0062 |
| Diagnosis of a | Diagnosis of a | Diagnosis of a | Diagnosis of a | Diagnosis of a |
| symptomatic patient | symptomatic patient | symptomatic patient | symptomatic patient | symptomatic patient |
| G85E heterozygote; one | G85E heterozygote; one | G542X heterozygote; | G542X heterozygote; | G551D heterozygote; |
| mutation detected | mutation detected | one mutation detected | one mutation detected | one mutation detected |
| text | text | text | text | text |
| text | text | text | text | text |
| CF005 | CF005 | CF005 | CF005 | CF005 |
| 62b | 64 | 64b | 122 | 122b |
| Any value | Any value | Any value | Any value | Any value |
| Any value | Any value | Any value | Any value | Any value |
| Any value | Any value | Any value | Any value | Any value |
| Positive | Positive | Positive | Positive | Positive |
| Negative | N1303K | Negative | Q493X | Negative |
| G551D | Negative | N1303K | Negative | Q493X |
| N/A | N/A | N/A | N/A | N/A |
| CF0062 | CF0064 | CF0064 | CF0122 | CF0122 |
| Diagnosis of a | Diagnosis of a | Diagnosis of a | Diagnosis of a | Diagnosis of a |
| symptomatic patient | symptomatic patient | symptomatic patient | symptomatic patient | symptomatic patient |
| G551D heterozygote; | N1303K heterozygote; | N1303K heterozygote; | Q493X heterozygote; | Q493X heterozygote; |
| one mutation detected | one mutation detected | one mutation detected | one mutation detected | one mutation detected |
| text | text | text | text | text |
| text | text | text | text | text |
| CF005 | CF005 | CF005 | CF005 | CF005 |
| 65 | 65b | 66 | 66b | 67 |
| Any value | Any value | Any value | Any value | Any value |
| Any value | Any value | Any value | Any value | Any value |
| Any value | Any value | Any value | Any value | Any value |
| Positive | Positive | Positive | Positive | Positive |
| R334W | Negative | R347H | Negative | R347P |
| Negative | R334W | Negative | R347H | Negative |
| N/A | N/A | N/A | N/A | N/A |
| CF0065 | CF0065 | CF0066 | CF0066 | CF0067 |
| Diagnosis of a | Diagnosis of a | Diagnosis of a | Diagnosis of a | Diagnosis of a |
| symptomatic patient | symptomatic patient | symptomatic patient | symptomatic patient | symptomatic patient |
| R334W heterozygote; | R334W heterozygote; | R347H heterozygote; | R347H heterozygote; | R347P heterozygote; |
| one mutation detected | one mutation detected | one mutation detected | one mutation detected | one mutation detected |
| text | text | text | text | text |
| text | text | text | text | text |
| CF005 | CF005 | CF005 | CF005 | CF005 |
| 67b | 68 | 68b | 69 | 69b |
| Any value | Any value | Any value | Any value | Any value |
| Any value | Any value | Any value | Any value | Any value |
| Any value | Any value | Any value | Any value | Any value |
| Positive | Positive | Positive | Positive | Positive |
| Negative | R553X | Negative | R560T | Negative |
| R347P | Negative | R553X | Negative | R560T |
| N/A | N/A | N/A | N/A | N/A |
| CF0067 | CF0068 | CF0068 | CF0069 | CF0069 |
| Diagnosis of a | Diagnosis of a | Diagnosis of a | Diagnosis of a | Diagnosis of a |
| symptomatic patient | symptomatic patient | symptomatic patient | symptomatic patient | symptomatic patient |
| R347P heterozygote; | R553X heterozygote; | R553X heterozygote; | R560T heterozygote; | R560T heterozygote; |
| one mutation detected | one mutation detected | one mutation detected | one mutation detected | one mutation detected |
| text | text | text | text | text |
| text | text | text | text | text |
| CF005 | CF005 | CF005 | CF005 | CF005 |
| 70 | 70b | 71 | 71b | 123 |
| Any value | Any value | Any value | Any value | Any value |
| Any value | Any value | Any value | Any value | Any value |
| Any value | Any value | Any value | Any value | Any value |
| Positive | Positive | Positive | Positive | Positive |
| R1162X | Negative | S549N | Negative | S549R(A > C) |
| Negative | R1162X | Negative | S549N | Negative |
| N/A | N/A | N/A | N/A | N/A |
| CF0070 | CF0070 | CF0071 | CF0071 | CF0123 |
| Diagnosis of a | Diagnosis of a | Diagnosis of a | Diagnosis of a | Diagnosis of a |
| symptomatic patient | symptomatic patient | symptomatic patient | symptomatic patient | symptomatic patient |
| R1162X heterozygote; | R1162X heterozygote; | S549N heterozygote; | S549N heterozygote; | S549R(A > C) |
| one mutation detected | one mutation detected | one mutation detected | one mutation detected | heterozygote; one |
| | | | | mutation detected |
| text | text | text | text | text |
| text | text | text | text | text |
| CF005 | CF005 | CF005 | CF005 | CF005 |
| 123b | 72 | 72b | 73 | 73b |
| Any value | Any value | Any value | Any value | Any value |
| Any value | Any value | Any value | Any value | Any value |
| Any value | Any value | Any value | Any value | Any value |
| Positive | Positive | Positive | Positive | Positive |
| Negative | S549R(T > G) | Negative | S1255X | Negative |
| S549R(A > C) | Negative | S549R(T > G) | Negative | S1255X |
| N/A | N/A | N/A | N/A | N/A |
| CF0123 | CF0072 | CF0072 | CF0073 | CF0073 |
| Diagnosis of a | Diagnosis of a | Diagnosis of a | Diagnosis of a | Diagnosis of a |
| symptomatic patient | symptomatic patient | symptomatic patient | symptomatic patient | symptomatic patient |
| S549R(A > C) | S549R(T > G) | S549R(T > G) | S1255X heterozygote; | S1255X heterozygote; |
| heterozygote; one | heterozygote; one | heterozygote; one | one mutation detected | one mutation detected |
| mutation detected | mutation detected | mutation detected | | |
| text | text | text | text | text |
| text | text | text | text | text |
| CF005 | CF005 | CF005 | CF005 | CF005 |
| 74 | 74b | 75 | 75b | 76 |
| Any value | Any value | Any value | Any value | Any value |
| Any value | Any value | Any value | Any value | Any value |
| Any value | Any value | Any value | Any value | Any value |
| Positive | Positive | Positive | Positive | Positive |
| V520F | Negative | W1282X | Negative | Y122X |
| Negative | V520F | Negative | W1282X | Negative |
| N/A | N/A | N/A | N/A | N/A |
| CF0074 | CF0074 | CF0075 | CF0075 | CF0076 |
| Diagnosis of a | Diagnosis of a | Diagnosis of a | Diagnosis of a | Diagnosis of a |
| symptomatic patient | symptomatic patient | symptomatic patient | symptomatic patient | symptomatic patient |
| V520F heterozygote; one | V520F heterozygote; one | W1282X heterozygote; | W1282X heterozygote; | Y122X heterozygote; |
| mutation detected | mutation detected | one mutation detected | one mutation detected | one mutation detected |
| text | text | text | text | text |
| text | text | text | text | text |
| CF005 | CF005 | CF005 | CF005 | CF005 |
| 76b | 77 | 77b | 78 | 78b |
| Any value | Any value | Any value | Any value | Any value |
| Any value | Any value | Any value | Any value | Any value |
| Any value | Any value | Any value | Any value | Any value |
| Positive | Positive | Positive | Positive | Positive |
| Negative | Y1092X(C > A) | Negative | Y1092X(C > G) | Negative |
| Y122X | Negative | Y1092X(C > A) | Negative | Y1092X(C > G) |
| N/A | N/A | N/A | N/A | N/A |
| CF0076 | CF0077 | CF0077 | CF0078 | CF0078 |
| Diagnosis of a | Diagnosis of a | Diagnosis of a | Diagnosis of a | Diagnosis of a |
| symptomatic patient | symptomatic patient | symptomatic patient | symptomatic patient | symptomatic patient |
| Y122X heterozygote; | Y1092X(C > A) | Y1092X(C > A) | Y1092X(C > G) | Y1092X(C > G) |
| one mutation detected | heterozygote; one | heterozygote; one | heterozygote; one | heterozygote; one |
| | mutation detected | mutation detected | mutation detected | mutation detected |
| text | text | text | text | text |
| text | text | text | text | text |
| CF005 | CF005 | CF005 | CF005 | CF005 |
| 79 | 79b | 80 | 80b | 81 |
| Any value | Any value | Any value | Any value | Any value |
| Any value | Any value | Any value | Any value | Any value |
| Any value | Any value | Any value | Any value | Any value |
| Positive | Positive | Positive | Positive | Positive |
| 394delTT | Negative | 621(+1)G > T | Negative | 711(+1)G > T |
| Negative | 394delTT | Negative | 621(+1)G > T | Negative |
| N/A | N/A | N/A | N/A | N/A |
| CF0079 | CF0079 | CF0080 | CF0080 | CF0081 |
| Diagnosis of a | Diagnosis of a | Diagnosis of a | Diagnosis of a | Diagnosis of a |
| symptomatic patient | symptomatic patient | symptomatic patient | symptomatic patient | symptomatic patient |
| 394delTT heterozygote; | 394delTT heterozygote; | 621(+1)G > T | 621(+1)G > T | 711(+1)G > T |
| one mutation detected | one mutation detected | heterozygote; one | heterozygote; one | heterozygote; one |
| | | mutation detected | mutation detected | mutation detected |
| text | text | text | text | text |
| text | text | text | text | text |
| CF005 | CF005 | CF005 | CF005 | CF005 |
| 81b | 82 | 82b | 83 | 83b |
| Any value | Any value | Any value | Any value | Any value |
| Any value | Any value | Any value | Any value | Any value |
| Any value | Any value | Any value | Any value | Any value |
| Positive | Positive | Positive | Positive | Positive |
| Negative | 1078delT | Negative | 1717(−1)G > A | Negative |
| 711(+1)G > T | Negative | 1078delT | Negative | 1717(−1)G > A |
| N/A | N/A | N/A | N/A | N/A |
| CF0081 | CF0082 | CF0082 | CF0083 | CF0083 |
| Diagnosis of a | Diagnosis of a | Diagnosis of a | Diagnosis of a | Diagnosis of a |
| symptomatic patient | symptomatic patient | symptomatic patient | symptomatic patient | symptomatic patient |
| 711(+1)G > T | 1078delT heterozygote; | 1078delT heterozygote; | 1078delT heterozygote; | 1078delT heterozygote; |
| heterozygote; one | one mutation detected | one mutation detected | one mutation detected | one mutation detected |
| mutation detected | | | | |
| text | text | text | text | text |
| text | text | text | text | text |
| CF005 | CF005 | CF005 | CF005 | CF005 |
| 84 | 84b | 85 | 85b | 86 |
| Any value | Any value | Any value | Any value | Any value |
| Any value | Any value | Any value | Any value | Any value |
| Any value | Any value | Any value | Any value | Any value |
| Positive | Positive | Positive | Positive | Positive |
| 1898(+1)G > A | Negative | 1898(+5)G > T | Negative | 2183delAA > G |
| Negative | 1898(+1)G > A | Negative | 1898(+5)G > T | Negative |
| N/A | N/A | N/A | N/A | N/A |
| CF0084 | CF0084 | CF0085 | CF0085 | CF0086 |
| Diagnosis of a | Diagnosis of a | Diagnosis of a | Diagnosis of a | Diagnosis of a |
| symptomatic patient | symptomatic patient | symptomatic patient | symptomatic patient | symptomatic patient |
| 1898(+1)G > A | 1898(+1)G > A | 1898(+5)G > T | 1898(+5)G > T | 2183delAA > G |
| heterozygote; one | heterozygote; one | heterozygote; one | heterozygote; one | heterozygote; one |
| mutation detected | mutation detected | mutation detected | mutation detected | mutation detected |
| text | text | text | text | text |
| text | text | text | text | text |
| CF005 | CF005 | CF005 | CF005 | CF005 |
| 86b | 87 | 87b | 88 | 88b |
| Any value | Any value | Any value | Any value | Any value |
| Any value | Any value | Any value | Any value | Any value |
| Any value | Any value | Any value | Any value | Any value |
| Positive | Positive | Positive | Positive | Positive |
| Negative | 2184delA | Negative | 2307insA | Negative |
| 2183delAA > G | Negative | 2184delA | Negative | 2307insA |
| N/A | N/A | N/A | N/A | N/A |
| CF0086 | CF0087 | CF0087 | CF0088 | CF0088 |
| Diagnosis of a | Diagnosis of a | Diagnosis of a | Diagnosis of a | Diagnosis of a |
| symptomatic patient | symptomatic patient | symptomatic patient | symptomatic patient | symptomatic patient |
| 2183delAA > G | 2184delA heterozygote; | 2184delA heterozygote; | 2307insA heterozygote; | 2307insA heterozygote; |
| heterozygote; one | one mutation detected | one mutation detected | one mutation detected | one mutation detected |
| mutation detected | | | | |
| text | text | text | text | text |
| text | text | text | text | text |
| CF005 | CF005 | CF005 | CF005 | CF005 |
| 89 | 89b | 90 | 90b | 91 |
| Any value | Any value | Any value | Any value | Any value |
| Any value | Any value | Any value | Any value | Any value |
| Any value | Any value | Any value | Any value | Any value |
| Positive | Positive | Positive | Positive | Positive |
| 2789(+5)G > A | Negative | 3120(+1)G > A | Negative | 3659delC |
| Negative | 2789(+5)G > A | Negative | 3120(+1)G > A | Negative |
| N/A | N/A | N/A | N/A | N/A |
| CF0089 | CF0089 | CF0090 | CF0090 | CF0091 |
| Diagnosis of a | Diagnosis of a | Diagnosis of a | Diagnosis of a | Diagnosis of a |
| symptomatic patient | symptomatic patient | symptomatic patient | symptomatic patient | symptomatic patient |
| 2789(+5)G > A | 2789(+5)G > A | 3120(+1)G > A | 3120(+1)G > A | 3659delC heterozygote; |
| heterozygote; one | heterozygote; one | heterozygote; one | heterozygote; one | one mutation detected |
| mutation detected | mutation detected | mutation detected | mutation detected | |
| text | text | text | text | text |
| text | text | text | text | text |
| CF005 | CF005 | CF005 | CF005 | CF005 |
| 91b | 124 | 124b | 92 | 92b |
| Any value | Any value | Any value | Any value | Any value |
| Any value | Any value | Any value | Any value | Any value |
| Any value | Any value | Any value | Any value | Any value |
| Positive | Positive | Positive | Positive | Positive |
| Negative | 3849(+4)A > G | Negative | 3849(+10 kb)C > T | Negative |
| 3659delC | Negative | 3849(+4)A > G | Negative | 3849(+10 kb)C > T |
| N/A | N/A | N/A | N/A | N/A |
| CF0091 | CF0124 | CF0124 | CF0092 | CF0092 |
| Diagnosis of a | Diagnosis of a | Diagnosis of a | Diagnosis of a | Diagnosis of a |
| symptomatic patient | symptomatic patient | symptomatic patient | symptomatic patient | symptomatic patient |
| 3659delC heterozygote; | 3849(+4)A > G | 3849(+4)A > G | 3849(+10 kb)C > T | 3849(+10 kb)C > T |
| one mutation detected | heterozygote; one | heterozygote; one | heterozygote; one | heterozygote; one |
| | mutation detected | mutation detected | mutation detected | mutation detected |
| text | text | text | text | text |
| text | text | text | text | text |
| CF005 | CF005 | CF005 | CF005 | CF005 |
| 93 | 93b | 94 | 94b | 95 |
| Any value | Any value | Any value | Any value | Any value |
| Any value | Any value | Any value | Any value | Any value |
| Any value | Any value | Any value | Any value | Any value |
| Positive | Positive | Positive | Positive | Positive |
| 3876delA | Negative | 3905insC | Negative | R117H |
| Negative | 3876delA | Negative | 3905insC | Negative |
| N/A | N/A | N/A | N/A | 5T/7T |
| CF0093 | CF0093 | CF0094 | CF0094 | CF0095 |
| Diagnosis of a | Diagnosis of a | Diagnosis of a | Diagnosis of a | Diagnosis of a |
| symptomatic patient | symptomatic patient | symptomatic patient | symptomatic patient | symptomatic patient |
| 3876delA heterozygote; | 3876delA heterozygote; | 3905insC heterozygote; | 3905insC heterozygote; | R117H heterozygote; |
| one mutation detected | one mutation detected | one mutation detected | one mutation detected | one mutation detected; |
| | | | | positive with respect to |
| | | | | intron 8 variant, 5T/7T |
| text | text | text | text | text |
| text | text | text | text | text |
| CF005 | CF005 | CF005 | CF005 | CF005 |
| 95b | 96 | 96b | 97 | 97b |
| Any value | Any value | Any value | Any value | Any value |
| Any value | Any value | Any value | Any value | Any value |
| Any value | Any value | Any value | Any value | Any value |
| Positive | Positive | Positive | Positive | Positive |
| Negative | R117H | Negative | R117H | Negative |
| R117H | Negative | R117H | Negative | R117H |
| 5T/7T | 5T/9T | 5T/9T | 5T/5T | 5T/5T |
| CF0095 | CF0096 | CF0096 | CF0097 | CF0097 |
| Diagnosis of a | Diagnosis of a | Diagnosis of a | Diagnosis of a | Diagnosis of a |
| symptomatic patient | symptomatic patient | symptomatic patient | symptomatic patient | symptomatic patient |
| R117H heterozygote; | R117H heterozygote; | R117H heterozygote; | R117H heterozygote; | R117H heterozygote; |
| one mutation detected; | one mutation detected; | one mutation detected; | one mutation detected; | one mutation detected; |
| positive with respect to | positive with respect to | positive with respect to | positive with respect to | positive with respect to |
| intron 8 variant, 5T/7T | intron 8 variant, 5T/9T | intron 8 variant, 5T/9T | intron 8 variant, 5T/5T | intron 8 variant, 5T/5T |
| text | text | text | text | text |
| text | text | text | text | text |
| CF005 | CF005 | CF005 | CF005 | CF005 |
| 98 | 98b | 99 | 99b | 100 |
| Any value | Any value | Any value | Any value | Any value |
| Any value | Any value | Any value | Any value | Any value |
| Any value | Any value | Any value | Any value | Any value |
| Positive | Positive | Positive | Positive | Positive |
| R117H | Negative | R117H | Negative | R117H |
| Negative | R117H | Negative | R117H | Negative |
| 7T/7T | 7T/7T | 7T/9T | 7T/9T | 9T/9T |
| CF0098 | CF0098 | CF0099 | CF0099 | CF0100 |
| Diagnosis of a | Diagnosis of a | Diagnosis of a | Diagnosis of a | Diagnosis of a |
| symptomatic patient | symptomatic patient | symptomatic patient | symptomatic patient | symptomatic patient |
| R117H heterozygote, | R117H heterozygote, | R117H heterozygote; | R117H heterozygote; | R117H heterozygote, |
| one mutation detected; | one mutation detected; | one mutation detected; | one mutation detected; | one mutation detected; |
| negative with respect to | negative with respect to | negative with respect to | negative with respect to | negative with respect to |
| intron 8-5T, 7T/7T | intron 8-5T, 7T/7T | intron 8 variant, 7T/9T | intron 8 variant, 7T/9T | intron 8-5T, 9T/9T |
| text | text | text | text | text |
| text | text | text | text | text |
| CF005 | CF005 | CF005 | CF005 | CF005 |

| 100b | 101 | 102 | 102b | 103 | 104 |
|---|---|---|---|---|---|
| Any value | Any value | Any value | Any value | Any value | Any value |
| Any value | Any value | Any value | Any value | Any value | Any value |
| Any value | Any value | Any value | Any value | Any value | Any value |
| Positive | Positive | Positive | Positive | Any value | Any value |
| Negative | Delta F508 | Delta F508 | Negative | Any value except | Any value except |
| | | | | negative or Delta F508 | negative |
| | | | | and | |
| R117H | Delta F508 | Negative | Delta F508 | Any value except | Negative |
| | | | | negative | |
| 9T/9T | N/A | F508C | F508C | Any value | Any value except N/A |
| CF0100 | CF0101 | CF0102 | CF0102 | | |
| Diagnosis of a | Diagnosis of a | Diagnosis of a | Diagnosis of a | Manual | Manual |
| symptomatic patient | symptomatic patient | symptomatic patient | symptomatic patient | | |
| R117H heterozygote, | Delta F508 | | | | |
| one mutation detected; | homozygote; | | | | |
| negative with | affected with cystic | | | | |
| respect to | fibrosis | | | | |
| intron 8-5T, | | | | | |
| 9T/9T | | | | | |
| text | text | text | text | | |
| text | text | text | text | | |
| CF005 | CF005 | CF005 | CF005 | CF005 | CF005 |

CFIID TABLE 2
APPENDIX
Cystic Fibrosis, Invader (TM) Platform, Diagnostic (CFIID) Test Data and Report Codes

| 0 | 8445 | 88245 | 9045 | 9046 | 8345 | 8745 |
|---|---|---|---|---|---|---|
| INT | Source | Personal History | Allele 1 | Allele 2 | Variant | MC |
| | 1 | Positive | Negative | Negative | N/A | CF0055 |
| | 1 | Positive | Delta I507 | Negative | N/A | CF0056 |
| | 1 | Positive | Negative | Delta I507 | N/A | CF0056 |
| | 1 | Positive | Delta F508 | Negative | N/A | CF0057 |
| | 1 | Positive | Negative | Delta F508 | N/A | CF0057 |
| | 1 | Positive | A455E | Negative | N/A | CF0058 |
| | 1 | Positive | Negative | A455E | N/A | CF0058 |
| | 1 | Positive | E60X | Negative | N/A | CF0121 |
| | 1 | Positive | Negative | E60X | N/A | CF0121 |
| | 1 | Positive | G85E | Negative | N/A | CF0060 |
| | 1 | Positive | Negative | G85E | N/A | CF0060 |
| | 1 | Positive | G542X | Negative | N/A | CF0061 |
| | 1 | Positive | Negative | G542X | N/A | CF0061 |
| | 1 | Positive | G551D | Negative | N/A | CF0062 |
| | 1 | Positive | Negative | G551D | N/A | CF0062 |
| | 1 | Positive | N1303K | Negative | N/A | CF0064 |
| | 1 | Positive | Negative | N1303K | N/A | CF0064 |
| | 1 | Positive | Q493X | Negative | N/A | CF0122 |
| | 1 | Positive | Negative | Q493X | N/A | CF0122 |
| | 1 | Positive | R334W | Negative | N/A | CF0065 |
| | 2 | Positive | Negative | R334W | N/A | CF0065 |
| | 2 | Positive | R347H | Negative | N/A | CF0066 |
| | 2 | Positive | Negative | R347H | N/A | CF0066 |
| | 2 | Positive | R347P | Negative | N/A | CF0067 |
| | 2 | Positive | Negative | R347P | N/A | CF0067 |
| | 2 | Positive | R553X | Negative | N/A | CF0068 |
| | 2 | Positive | Negative | R553X | N/A | CF0068 |
| | 2 | Positive | R560T | Negative | N/A | CF0069 |
| | 2 | Positive | Negative | R560T | N/A | CF0069 |
| | 2 | Positive | R1162X | Negative | N/A | CF0070 |
| | 2 | Positive | Negative | R1162X | N/A | CF0070 |
| | 2 | Positive | S549N | Negative | N/A | CF0071 |
| | 2 | Positive | Negative | S549N | N/A | CF0071 |
| | 2 | Positive | S549R(A > C) | Negative | N/A | CF0123 |
| | 2 | Positive | Negative | S549R(A > C) | N/A | CF0123 |
| | 2 | Positive | S549R(T > G) | Negative | N/A | CF0072 |
| | 2 | Positive | Negative | S549R(T > G) | N/A | CF0072 |
| | 2 | Positive | S1255X | Negative | N/A | CF0073 |
| | 2 | Positive | Negative | S1255X | N/A | CF0073 |
| | 2 | Positive | V520F | Negative | N/A | CF0074 |
| | 2 | Positive | Negative | V520F | N/A | CF0074 |
| | 2 | Positive | W1282X | Negative | N/A | CF0075 |
| | 3 | Positive | Negative | W1282X | N/A | CF0075 |
| | 3 | Positive | Y122X | Negative | N/A | CF0076 |
| | 3 | Positive | Negative | Y122X | N/A | CF0076 |
| | 3 | Positive | Y1092X(C > A) | Negative | N/A | CF0077 |
| | 3 | Positive | Negative | Y1092X(C > A) | N/A | CF0077 |
| | 3 | Positive | Y1092X(C > G) | Negative | N/A | CF0078 |
| | 3 | Positive | Negative | Y1092X(C > G) | N/A | CF0078 |
| | 3 | Positive | 394delTT | Negative | N/A | CF0079 |
| | 3 | Positive | Negative | 394delTT | N/A | CF0079 |
| | 3 | Positive | 621(+1)G > T | Negative | N/A | CF0080 |
| | 3 | Positive | Negative | 621(+1)G > T | N/A | CF0080 |
| | 3 | Positive | 711(+1)G > T | Negative | N/A | CF0081 |
| | 3 | Positive | Negative | 711(+1)G > T | N/A | CF0081 |
| | 3 | Positive | 1078delT | Negative | N/A | CF0082 |
| | 3 | Positive | Negative | 1078delT | N/A | CF0082 |
| | 3 | Positive | 1717(−1)G > A | Negative | N/A | CF0083 |
| | 3 | Positive | Negative | 1717(−1)G > A | N/A | CF0083 |
| | 3 | Positive | 1898(+1)G > A | Negative | N/A | CF0084 |
| | 3 | Positive | Negative | 1898(+1)G > A | N/A | CF0084 |
| | 3 | Positive | 1898(+5)G > T | Negative | N/A | CF0085 |
| | 3 | Positive | Negative | 1898(+5)G > T | N/A | CF0085 |
| | 3 | Positive | 2183delAA > G | Negative | N/A | CF0086 |
| | 4 | Positive | Negative | 2183delAA > G | N/A | CF0086 |
| | 4 | Positive | 2184delA | Negative | N/A | CF0087 |
| | 4 | Positive | Negative | 2184delA | N/A | CF0087 |
| | 4 | Positive | 2307insA | Negative | N/A | CF0088 |
| | 4 | Positive | Negative | 2307insA | N/A | CF0088 |
| | 4 | Positive | 2789(+5)G > A | Negative | N/A | CF0089 |
| | 4 | Positive | Negative | 2789(+5)G > A | N/A | CF0089 |
| | 4 | Positive | 3120(+1)G > A | Negative | N/A | CF0090 |
| | 4 | Positive | Negative | 3120(+1)G > A | N/A | CF0090 |
| | 4 | Positive | 3659delC | Negative | N/A | CF0091 |
| | 4 | Positive | Negative | 3659delC | N/A | CF0091 |
| | 4 | Positive | 3849(+4)A > G | Negative | N/A | CF0124 |
| | 4 | Positive | Negative | 3849(+4)A > G | N/A | CF0124 |
| | 4 | Positive | 3849(+10 kb)C > T | Negative | N/A | CF0092 |
| | 4 | Positive | Negative | 3849(+10 kb)C > T | N/A | CF0092 |
| | 4 | Positive | 3876delA | Negative | N/A | CF0093 |
| | 4 | Positive | Negative | 3876delA | N/A | CF0093 |
| | 4 | Positive | 3905insC | Negative | N/A | CF0094 |
| | 4 | Positive | Negative | 3905insC | N/A | CF0094 |
| | 4 | Positive | R117H | Negative | 5T/7T | CF0095 |
| | 4 | Positive | Negative | R117H | 5T/7T | CF0095 |
| | 4 | Positive | R117H | Negative | 5T/9T | CF0096 |
| | 5 | Positive | Negative | R117H | 5T/9T | CF0096 |
| | 5 | Positive | R117H | Negative | 5T/5T | CF0097 |
| | 5 | Positive | Negative | R117H | 5T/5T | CF0097 |
| | 5 | Positive | R117H | Negative | 7T/7T | CF0098 |
| | 5 | Positive | Negative | R117H | 7T/7T | CF0098 |
| | 5 | Positive | R117H | Negative | 7T/9T | CF0099 |
| | 5 | Positive | Negative | R117H | 7T/9T | CF0099 |
| | 5 | Positive | R117H | Negative | 9T/9T | CF0100 |
| | 5 | Positive | Negative | R117H | 9T/9T | CF0100 |
| | 5 | Positive | Delta F508 | Delta F508 | N/A | CF0101 |
| | 5 | Positive | Delta F508 | Negative | F508C | CF0102 |
| | 5 | Positive | Negative | Delta F508 | F508C | CF0102 |
| **EOF** | | | | | | |

CFIID TABLE 1
APPENDIX
Cystic Fibrosis Invader Platform, Diagnostic Test (CFIID) User Queries and Answers
Invader Test Code
Values

| Client enters: | Client enters: | First part of result | Second part | Possible third |
|---|---|---|---|---|
| Source | Personal History | Allele 1 | Allele 2 | Variant |
| Blood | Positive | Negative | Negative | Not applicable (data masked) |
| Buccal swab | Assumed Positive | Delta I507 | Delta I507 | intron 8-5T/7T |
| Mouthwashing | | Delta F508 | Delta F508 | intron 8-5T/9T |
| Cord blood | | A455E | A455E | intron 8-5T/5T |
| Unknown | | E60X | E60X | intron 8-7T/7T |
| | | G85E | G85E | intron 8-7T/9T |
| | | G542X | G542X | intron 8-9T/9T |
| | | G551D | G551D | F508C heterozygote |
| | | N1303K | N1303K | |
| | | Q493X | Q493X | |
| | | R334W | R334W | |
| | | R347H | R347H | |
| | | R347P | R347P | |
| | | R553X | R553X | |
| | | R560T | R560T | |
| | | R1162X | R1162X | |
| | | S549N | S549N | |
| | | S549R (A > C) | S549R (A > C) | |
| | | S549R (T > G) | S549R (T > G) | |
| | | V520F | V520F | |
| | | W1282X | W1282X | |
| | | Y122X | Y122X | |
| | | Y1092X (C > A) | Y1092X (C > A) | |
| | | Y1092X (C > G | Y1092X (C > G | |
| | | 394delTT | 394delTT | |
| | | 621(+1)G > T | 621(+1)G > T | |
| | | 711(+1)G > T | 711(+1)G > T | |
| | | 1078delT | 1078delT | |
| | | 1717(−1)G > A | 1717(−1)G > A | |
| | | 1898(+1)G > A | 1898(+1)G > A | |
| | | 2183delAA > G | 2183delAA > G | |
| | | 2184delA | 2184delA | |
| | | 2789(+5)G > A | 2789(+5)G > A | |
| | | 3120(+1)G > A | 3120(+1)G > A | |
| | | 3659delC | 3659delC | |
| | | 3849(+4)A > G | 3849(+4)A > G | |
| | | 3849(+10 kb)C > T | 3849(+10 kb)C > T | |
| | | 3876delA | 3876delA | |
| | | 3905insC | 3905insC | |
| | | R117H | R117H | |

CFITD TABLE 3
APPENDIX
INTERPRETATIVE REPORT, CYSTIC FIBROSIS DIAGNOSTIC TEST, TAGIT PLATFORM (CFITD)
Report Header

| | | WORD # | | | |
|---|---|---|---|---|---|
| | | 55 | 56 | 56a | 57 |
| Client enter | Source | | | | |
| | Personal History | Positive | Positive | Positive | Positive |
| | Allele 1 | Negative | Delta I507 | Negative | Delta F508 |
| | Allele 2 | Negative | Negative | Delta I507 | Negative |
| | Variant | N/A | N/A | N/A | N/A |
| Code | | CF0055 | CF0056 | CF0056 | CF0057 |
| Report Field | Indication | Diagnosis of a | Diagnosis of a | Diagnosis of a | Diagnosis of a |
| | | symptomatic patient | symptomatic patient | symptomatic patient | symptomatic patient |
| | Result | Negative for mutations | Delta I507 heterozygote; | Delta I507 heterozygote; | Delta F508 heterozygote; |
| | | analyzed | one mutation detected | one mutation detected | one mutation detected |
| | Recommendations | text | text | text | text |
| | Interpretation | text | text | text | text |
| | Canned Message | CF003 | CF003 | CF003 | CF003 |

| 57a | 58 | 58a | 59 | 59a |
|---|---|---|---|---|
| Positive | Positive | Positive | Positive | Positive |
| Negative | A455E | Negative | A559T | Negative |
| Delta F508 | Negative | A455E | Negative | A559T |
| N/A | N/A | N/A | N/A | N/A |
| CF0057 | CF0058 | CF0058 | CF0059 | CF0059 |
| Diagnosis of a | Diagnosis of a | Diagnosis of a | Diagnosis of a | Diagnosis of a |
| symptomatic patient | symptomatic patient | symptomatic patient | symptomatic patient | symptomatic patient |
| Delta F508 heterozygote; | A455E heterozygote; | A455E heterozygote; | A559T heterozygote; one | A559T heterozygote; one |
| one mutation detected | one mutation detected | one mutation detected | mutation detected | mutation detected |
| text | text | text | text | text |
| text | text | text | text | text |
| CF003 | CF003 | CF003 | CF003 | CF003 |
| 60 | 60a | 61 | 61a | 62 |
| Positive | Positive | Positive | Positive | Positive |
| G85E | Negative | G542X | Negative | G551D |
| Negative | G85E | Negative | G542X | Negative |
| N/A | N/A | N/A | N/A | N/A |
| CF0060 | CF0060 | CF0061 | CF0061 | CF0062 |
| Diagnosis of a | Diagnosis of a | Diagnosis of a | Diagnosis of a | Diagnosis of a |
| symptomatic patient | symptomatic patient | symptomatic patient | symptomatic patient | symptomatic patient |
| G85E heterozygote; one | G85E heterozygote; one | G542X heterozygote; | G542X heterozygote; | G551D heterozygote; |
| mutation detected | mutation detected | one mutation detected | one mutation detected | one mutation detected |
| text | text | text | text | text |
| text | text | text | text | text |
| CF003 | CF003 | CF003 | CF003 | CF003 |
| 62a | 63 | 63a | 64 | 64a |
| Positive | Positive | Positive | Positive | Positive |
| Negative | M1101K | Negative | N1303K | Negative |
| G551D | Negative | M1101K | Negative | N1303K |
| N/A | N/A | N/A | N/A | N/A |
| CF0062 | CF0063 | CF0063 | CF0064 | CF0064 |
| Diagnosis of a | Diagnosis of a | Diagnosis of a | Diagnosis of a | Diagnosis of a |
| symptomatic patient | symptomatic patient | symptomatic patient | symptomatic patient | symptomatic patient |
| G551D heterozygote; | M1101 heterozygote; | M1101 heterozygote; | N1303K heterozygote; | N1303K heterozygote; |
| one mutation detected | one mutation detected | one mutation detected | one mutation detected | one mutation detected |
| text | text | text | text | text |
| text | text | text | text | text |
| CF003 | CF003 | CF003 | CF003 | CF003 |
| 65 | 65a | 66 | 66a | 67 |
| Positive | Positive | Positive | Positive | Positive |
| R334W | Negative | R347H | Negative | R347P |
| Negative | R334W | Negative | R347H | Negative |
| N/A | N/A | N/A | N/A | N/A |
| CF0065 | CF0065 | CF0066 | CF0066 | CF0067 |
| Diagnosis of a | Diagnosis of a | Diagnosis of a | Diagnosis of a | Diagnosis of a |
| symptomatic patient | symptomatic patient | symptomatic patient | symptomatic patient | symptomatic patient |
| R334W heterozygote; | R334W heterozygote; | R347H heterozygote; | R347H heterozygote; | R347P heterozygote; |
| one mutation detected | one mutation detected | one mutation detected | one mutation detected | one mutation detected |
| text | text | text | text | text |
| text | text | text | text | text |
| CF003 | CF003 | CF003 | CF003 | CF003 |
| 67a | 68 | 68a | 69 | 69a |
| Positive | Positive | Positive | Positive | Positive |
| Negative | R553X | Negative | R560T | Negative |
| R347P | Negative | R553X | Negative | R560T |
| N/A | N/A | N/A | N/A | N/A |
| CF0067 | CF0068 | CF0068 | CF0069 | CF0069 |
| Diagnosis of a | Diagnosis of a | Diagnosis of a | Diagnosis of a | Diagnosis of a |
| symptomatic patient | symptomatic patient | symptomatic patient | symptomatic patient | symptomatic patient |
| R347P heterozygote; | R553X heterozygote; | R553X heterozygote; | R560T heterozygote; | R560T heterozygote; |
| one mutation detected | one mutation detected | one mutation detected | one mutation detected | one mutation detected |
| text | text | text | text | text |
| text | text | text | text | text |
| CF003 | CF003 | CF003 | CF003 | CF003 |
| 70 | 70a | 71 | 71a | 72 |
| Positive | Positive | Positive | Positive | Positive |
| R1162X | Negative | S549N | Negative | S549R(T > G) |
| Negative | R1162X | Negative | S549N | Negative |
| N/A | N/A | N/A | N/A | N/A |
| CF0070 | CF0070 | CF0071 | CF0071 | CF0072 |
| Diagnosis of a | Diagnosis of a | Diagnosis of a | Diagnosis of a | Diagnosis of a |
| symptomatic patient | symptomatic patient | symptomatic patient | symptomatic patient | symptomatic patient |
| R1162X heterozygote; | R1162X heterozygote; | S549N heterozygote; | S549N heterozygote; | S549R(T > G) |
| one mutation detected | one mutation detected | one mutation detected | one mutation detected | heterozygote; one |
| | | | | mutation detected |
| text | text | text | text | text |
| text | text | text | text | text |
| CF003 | CF003 | CF003 | CF003 | CF003 |
| 72a | 73 | 73a | 74 | 74a |
| Positive | Positive | Positive | Positive | Positive |
| Negative | S1255X | Negative | V520F | Negative |
| S549R(T > G) | Negative | S1255X | Negative | V520F |
| N/A | N/A | N/A | N/A | N/A |
| CF0072 | CF0073 | CF0073 | CF0074 | CF0074 |
| Diagnosis of a | Diagnosis of a | Diagnosis of a | Diagnosis of a | Diagnosis of a |
| symptomatic patient | symptomatic patient | symptomatic patient | symptomatic patient | symptomatic patient |
| S549R(T > G) | S1255X heterozygote; | S1255X heterozygote; | V520F heterozygote; one | V520F heterozygote; one |
| heterozygote; one | one mutation detected | one mutation detected | mutation detected | mutation detected |
| mutation detected | | | | |
| text | text | text | text | text |
| text | text | text | text | text |
| CF003 | CF003 | CF003 | CF003 | CF003 |
| 75 | 75a | 76 | 76a | 77 |
| Positive | Positive | Positive | Positive | Positive |
| W1282X | Negative | Y122X | Negative | Y1092X(C > A) |
| Negative | W1282X | Negative | Y122X | Negative |
| N/A | N/A | N/A | N/A | N/A |
| CF0075 | CF0075 | CF0076 | CF0076 | CF0077 |
| Diagnosis of a | Diagnosis of a | Diagnosis of a | Diagnosis of a | Diagnosis of a |
| symptomatic patient | symptomatic patient | symptomatic patient | symptomatic patient | symptomatic patient |
| W1282X heterozygote; | W1282X heterozygote; | Y122X heterozygote; | Y122X heterozygote; | Y1092X(C > A) |
| one mutation detected | one mutation detected | one mutation detected | one mutation detected | heterozygote; one |
| | | | | mutation detected |
| text | text | text | text | text |
| text | text | text | text | text |
| CF003 | CF003 | CF003 | CF003 | CF003 |
| 77a | 78 | 78a | 79 | 79a |
| Positive | Positive | Positive | Positive | Positive |
| Negative | Y1092X(C > G) | Negative | 394delTT | Negative |
| Y1092X(C > A) | Negative | Y1092X(C > G) | Negative | 394delTT |
| N/A | N/A | N/A | N/A | N/A |
| CF0077 | CF0078 | CF0078 | CF0079 | CF0079 |
| Diagnosis of a | Diagnosis of a | Diagnosis of a | Diagnosis of a | Diagnosis of a |
| symptomatic patient | symptomatic patient | symptomatic patient | symptomatic patient | symptomatic patient |
| Y1092X(C > A) | Y1092X(C > G) | Y1092X(C > G) | 394delTT heterozygote; | 394delTT heterozygote; |
| heterozygote; one | heterozygote; one | heterozygote; one | one mutation detected | one mutation detected |
| mutation detected | mutation detected | mutation detected | | |
| text | text | text | text | text |
| text | text | text | text | text |
| CF003 | CF003 | CF003 | CF003 | CF003 |
| 80 | 80a | 81 | 81a | 82 |
| Positive | Positive | Positive | Positive | Positive |
| 621(+1)G > T | Negative | 711(+1)G > T | Negative | 1078delT |
| Negative | 621(+1)G > T | Negative | 711(+1)G > T | Negative |
| N/A | N/A | N/A | N/A | N/A |
| CF0080 | CF0080 | CF0081 | CF0081 | CF0082 |
| Diagnosis of a | Diagnosis of a | Diagnosis of a | Diagnosis of a | Diagnosis of a |
| symptomatic patient | symptomatic patient | symptomatic patient | symptomatic patient | symptomatic patient |
| 621(+1)G > T | 621(+1)G > T | 711(+1)G > T | 711(+1)G > T | 1078delT heterozygote; |
| heterozygote; one | heterozygote; one | heterozygote; one | heterozygote; one | one mutation detected |
| mutation detected | mutation detected | mutation detected | mutation detected | |
| text | text | text | text | text |
| text | text | text | text | text |
| CF003 | CF003 | CF003 | CF003 | CF003 |
| 82a | 83 | 83a | 84 | 84a |
| Positive | Positive | Positive | Positive | Positive |
| Negative | 1717(−1)G > A | Negative | 1898(+1)G > A | Negative |
| 1078delT | Negative | 1717(−1)G > A | Negative | 1898(+1)G > A |
| N/A | N/A | N/A | N/A | N/A |
| CF0082 | CF0083 | CF0083 | CF0084 | CF0084 |
| Diagnosis of a | Diagnosis of a | Diagnosis of a | Diagnosis of a | Diagnosis of a |
| symptomatic patient | symptomatic patient | symptomatic patient | symptomatic patient | symptomatic patient |
| 1078delT heterozygote; | 1078delT heterozygote; | 1078delT heterozygote; | 1898(+1)G > A | 1898(+1)G > A |
| one mutation detected | one mutation detected | one mutation detected | heterozygote; one | heterozygote; one |
| | | | mutation detected | mutation detected |
| text | text | text | text | text |
| text | text | text | text | text |
| CF003 | CF003 | CF003 | CF003 | CF003 |
| 85 | 85a | 86 | 86a | 87 |
| Positive | Positive | Positive | Positive | Positive |
| 1898(+5)G > T | Negative | 2183delAA > G | Negative | 2184delA |
| Negative | 1898(+5)G > T | Negative | 2183delAA > G | Negative |
| N/A | N/A | N/A | N/A | N/A |
| CF0085 | CF0085 | CF0086 | CF0086 | CF0087 |
| Diagnosis of a | Diagnosis of a | Diagnosis of a | Diagnosis of a | Diagnosis of a |
| symptomatic patient | symptomatic patient | symptomatic patient | symptomatic patient | symptomatic patient |
| 1898(+5)G > A | 1898(+5)G > A | 2183delAA > G | 2183delAA > G | 2184delA heterozygote; |
| heterozygote; one | heterozygote; one | heterozygote; one | heterozygote; one | one mutation detected |
| mutation detected | mutation detected | mutation detected | mutation detected | |
| text | text | text | text | text |
| text | text | text | text | text |
| CF003 | CF003 | CF003 | CF003 | CF003 |
| 87a | 88 | 88a | 89 | 89a |
| Positive | Positive | Positive | Positive | Positive |
| Negative | 2307insA | Negative | 2789(+5)G > A | Negative |
| 2184delA | Negative | 2307insA | Negative | 2789(+5)G > A |
| N/A | N/A | N/A | N/A | N/A |
| CF0087 | CF0088 | CF0088 | CF0089 | CF0089 |
| Diagnosis of a | Diagnosis of a | Diagnosis of a | Diagnosis of a | Diagnosis of a |
| symptomatic patient | symptomatic patient | symptomatic patient | symptomatic patient | symptomatic patient |
| 2184delA heterozygote; | 2307insA heterozygote; | 2307insA heterozygote; | 2789(+5)G > A | 2789(+5)G > A |
| one mutation detected | one mutation detected | one mutation detected | heterozygote; one | heterozygote; one |
| | | | mutation detected | mutation detected |
| text | text | text | text | text |
| text | text | text | text | text |
| CF003 | CF003 | CF003 | CF003 | CF003 |
| 90 | 90a | 91 | 91a | 92 |
| Positive | Positive | Positive | Positive | Positive |
| 3120(+1)G > A | Negative | 3659delC | Negative | 3849(+10 kb)C > T |
| Negative | 3120(+1)G > A | Negative | 3659delC | Negative |
| N/A | N/A | N/A | N/A | N/A |
| CF0090 | CF0090 | CF0091 | CF0091 | CF0092 |
| Diagnosis of a | Diagnosis of a | Diagnosis of a | Diagnosis of a | Diagnosis of a |
| symptomatic patient | symptomatic patient | symptomatic patient | symptomatic patient | symptomatic patient |
| 3120(+1)G > A | 3120(+1)G > A | 3659delC heterozygote; | 3659delC heterozygote; | 3849(+10 kb)C > T |
| heterozygote; one | heterozygote; one | one mutation detected | one mutation detected | heterozygote; one |
| mutation detected | mutation detected | | | mutation detected |
| text | text | text | text | text |
| text | text | text | text | text |
| CF003 | CF003 | CF003 | CF003 | CF003 |
| 92a | 93 | 93a | 94 | 94a |
| Positive | Positive | Positive | Positive | Positive |
| Negative | 3876delA | Negative | 3905insC | Negative |
| 3849(+10 kb)C > T | Negative | 3876delA | Negative | 3905insC |
| N/A | N/A | N/A | N/A | N/A |
| CF0092 | CF0093 | CF0093 | CF0094 | CF0094 |
| Diagnosis of a | Diagnosis of a | Diagnosis of a | Diagnosis of a | Diagnosis of a |
| symptomatic patient | symptomatic patient | symptomatic patient | symptomatic patient | symptomatic patient |
| 3849(+10 kb)C > T | 3876delA heterozygote; | 3876delA heterozygote; | 3905insC heterozygote; | 3905insC heterozygote; |
| heterozygote; one | one mutation detected | one mutation detected | one mutation detected | one mutation detected |
| mutation detected | | | | |
| text | text | text | text | text |
| text | text | text | text | text |
| CF003 | CF003 | CF003 | CF003 | CF003 |
| 95 | 95a | 96 | 96a | 97 |
| Positive | Positive | Positive | Positive | Positive |
| R117H | Negative | R117H | Negative | R117H |
| Negative | R117H | Negative | R117H | Negative |
| 5T/7T | 5T/7T | 5T/9T | 5T/9T | 5T/5T |
| CF0095 | CF0095 | CF0096 | CF0096 | CF0097 |
| Diagnosis of a | Diagnosis of a | Diagnosis of a | Diagnosis of a | Diagnosis of a |
| symptomatic patient | symptomatic patient | symptomatic patient | symptomatic patient | symptomatic patient |
| R117H heterozygote; | R117H heterozygote; | R117H heterozygote; | R117H heterozygote; | R117H heterozygote; |
| one mutation detected; | one mutation detected; | one mutation detected; | one mutation detected; | one mutation detected; |
| positive with respect to | positive with respect to | positive with respect to | positive with respect to | positive with respect to |
| intron 8 variant, 5T/7T | intron 8 variant, 5T/7T | intron 8 variant, 5T/9T | intron 8 variant, 5T/9T | intron 8 variant, 5T/5T |
| text | text | text | text | text |
| text | text | text | text | text |
| CF003 | CF003 | CF003 | CF003 | CF003 |
| 97a | 98 | 98a | 99 | 99a |
| Positive | Positive | Positive | Positive | Positive |
| Negative | R117H | Negative | R117H | Negative |
| R117H | Negative | R117H | Negative | R117H |
| 5T/5T | 7T/7T | 7T/7T | 7T/9T | 7T/9T |
| CF0097 | CF0098 | CF0098 | CF0099 | CF0099 |
| Diagnosis of a | Diagnosis of a | Diagnosis of a | Diagnosis of a | Diagnosis of a |
| symptomatic patient | symptomatic patient | symptomatic patient | symptomatic patient | symptomatic patient |
| R117H heterozygote; | R117H heterozygote, | R117H heterozygote, | R117H heterozygote; | R117H heterozygote; |
| one mutation detected; | one mutation detected; | one mutation detected; | one mutation detected; | one mutation detected; |
| positive with respect to | negative with respect to | negative with respect to | negative with respect to | negative with respect to |
| intron 8 variant, 5T/5T | intron 8-5T, 7T/7T | intron 8-5T, 7T/7T | intron 8 variant, 7T/9T | intron 8 variant, 7T/9T |
| text | text | text | text | text |
| text | text | text | text | text |
| CF003 | CF003 | CF003 | CF003 | CF003 |
| 100 | 100a | 101 | 102 | 102a |
| Positive | Positive | Positive | Positive | Positive |
| R117H | Negative | Delta F508 | Delta F508 | Negative |
| Negative | R117H | Delta F508 | Negative | Delta F508 |
| 9T/9T | 9T/9T | Negative for benign exon | F508C heterozygote | F508C heterozygote |
| | | 10 variants tested | | |
| CF0100 | CF0100 | CF0101 | CF0102 | CF0102 |
| Diagnosis of a | Diagnosis of a | Diagnosis of a | Delta F508/F508C | Delta F508/F508C |
| symptomatic patient | symptomatic patient | symptomatic patient | compound heterozygote; | compound heterozygote; |
| | | | one pathogenic mutation | one pathogenic mutation |
| | | | detected | detected |
| R117H heterozygote, | R117H heterozygote, | Delta F508 homozygote | | |
| one mutation detected; | one mutation detected; | (and negative for benign | | |
| negative with respect to | negative with respect to | exon 10 variants tested); | | |
| intron 8-5T, 9T/9T | intron 8-5T, 9T/9T | affected with cystic | | |
| | | fibrosis | | |
| text | text | text | text | text |
| text | text | text | text | text |
| CF003 | CF003 | CF003 | CF003 | CF003 |

| 103 | 103a | 125 | 125a |
|---|---|---|---|
| Positive | Positive | Positive | Positive |
| Delta F508 | Negative | Delta F508 | Negative |
| Negative | Delta F508 | Negative | Delta F508 |
| I506V heterozygote | I506V heterozygote | I507V heterozygote | I507V heterozygote |
| CF0103 | CF0103 | CF0125 | CF0125 |
| Delta F508/I506V | Delta F508/I506V | Delta F508/ | Delta F508/ |
| compound heterozygote; | compound heterozygote; | I507Vcompound | I507Vcompound |
| one pathogenic mutation | one pathogenic mutation | heterozygote; one | heterozygote; one |
| detected | detected | pathogenic mutation | pathogenic mutation |
| | | detected | detected |
| text | text | text | text |
| text | text | text | text |
| CF003 | CF003 | CF003 | CF003 |

CFITD TABLE 2
APPENDIX
Cystic Fibrosis Taglt(TM) Plaform, Diagnostic Test (CFITD), Data and Report Codes

| 0 | 8445 | 88245 | 9045 | 9046 | 8345 | 8745 |
|---|---|---|---|---|---|---|
| INT | Source | Personal History | Allele 1 | Allele 2 | Variant | MC |
| | 1 | Positive | Negative | Negative | N/A | CF0055 |
| | 1 | Positive | Delta I507 | Negative | N/A | CF0056 |
| | 1 | Positive | Negative | Delta I507 | N/A | CF0056 |
| | 1 | Positive | Delta F508 | Negative | N/A | CF0057 |
| | 1 | Positive | Negative | Delta F508 | N/A | CF0057 |
| | 1 | Positive | A455E | Negative | N/A | CF0058 |
| | 1 | Positive | Negative | A455E | N/A | CF0058 |
| | 1 | Positive | A559T | Negative | N/A | CF0059 |
| | 1 | Positive | Negative | A559T | N/A | CF0059 |
| | 1 | Positive | G85E | Negative | N/A | CF0060 |
| | 1 | Positive | Negative | G85E | N/A | CF0060 |
| | 1 | Positive | G542X | Negative | N/A | CF0061 |
| | 1 | Positive | Negative | G542X | N/A | CF0061 |
| | 1 | Positive | G551D | Negative | N/A | CF0062 |
| | 1 | Positive | Negative | G551D | N/A | CF0062 |
| | 1 | Positive | M1101K | Negative | N/A | CF0063 |
| | 1 | Positive | Negative | M1101K | N/A | CF0063 |
| | 1 | Positive | N1303K | Negative | N/A | CF0064 |
| | 1 | Positive | Negative | N1303K | N/A | CF0064 |
| | 1 | Positive | R334W | Negative | N/A | CF0065 |
| | 1 | Positive | Negative | R334W | N/A | CF0065 |
| | 1 | Positive | R347H | Negative | N/A | CF0066 |
| | 2 | Positive | Negative | R347H | N/A | CF0066 |
| | 2 | Positive | R347P | Negative | N/A | CF0067 |
| | 2 | Positive | Negative | R347P | N/A | CF0067 |
| | 2 | Positive | R553X | Negative | N/A | CF0068 |
| | 2 | Positive | Negative | R553X | N/A | CF0068 |
| | 2 | Positive | R560T | Negative | N/A | CF0069 |
| | 2 | Positive | Negative | R560T | N/A | CF0069 |
| | 2 | Positive | R1162X | Negative | N/A | CF0070 |
| | 2 | Positive | Negative | R1162X | N/A | CF0070 |
| | 2 | Positive | S549N | Negative | N/A | CF0071 |
| | 2 | Positive | Negative | S549N | NIA | CF0071 |
| | 2 | Positive | S549R(T > G) | Negative | N/A | CF0072 |
| | 2 | Positive | Negative | S549R(T > G) | N/A | CF0072 |
| | 2 | Positive | S1255X | Negative | N/A | CF0073 |
| | 2 | Positive | Negative | S1255X | N/A | CF0073 |
| | 2 | Positive | V520F | Negative | N/A | CF0074 |
| | 2 | Positive | Negative | V520F | N/A | CF0074 |
| | 2 | Positive | W1282X | Negative | N/A | CF0075 |
| | 2 | Positive | Negative | W1282X | N/A | CF0075 |
| | 2 | Positive | Y122X | Negative | N/A | CF0076 |
| | 2 | Positive | Negative | Y122X | N/A | CF0076 |
| | 2 | Positive | Y1092X(C > A) | Negative | N/A | CF0077 |
| | 3 | Positive | Negative | Y1092X(C > A) | N/A | CF0077 |
| | 3 | Positive | Y1092X(C > G) | Negative | N/A | CF0078 |
| | 3 | Positive | Negative | Y1092X(C > G) | N/A | CF0078 |
| | 3 | Positive | 394delTT | Negative | N/A | CF0079 |
| | 3 | Positive | Negative | 394dalTT | N/A | CF0079 |
| | 3 | Positive | 621(+1)G > T | Negative | N/A | CF0080 |
| | 3 | Positive | Negative | 621(+1)G > T | N/A | CF0080 |
| | 3 | Positive | 711(+1)G > T | Negative | N/A | CF0081 |
| | 3 | Positive | Negative | 711(+1)G > T | N/A | CF0081 |
| | 3 | Positive | 1078delT | Negative | N/A | CF0082 |
| | 3 | Positive | Negative | 1078delT | N/A | CF0082 |
| | 3 | Positive | 1717(−1)G > A | Negative | N/A | CF0083 |
| | 3 | Positive | Negative | 1717(−1)G > A | N/A | CF0083 |
| | 3 | Positive | 1898(+1)G > A | Negative | N/A | CF0084 |
| | 3 | Positive | Negative | 1898(+1)G > A | N/A | CF0084 |
| | 3 | Positive | 1898(+5)G > T | Negative | N/A | CF0085 |
| | 3 | Positive | Negative | 1898(+5)G > T | N/A | CF0085 |
| | 3 | Positive | 2183delAA > G | Negative | N/A | CF0086 |
| | 3 | Positive | Negative | 2183delAA > G | N/A | CF0086 |
| | 3 | Positive | 2184delA | Negative | N/A | CF0087 |
| | 3 | Positive | Negative | 2184delA | N/A | CF0087 |
| | 3 | Positive | 2307insA | Negative | N/A | CF0088 |
| | 4 | Positive | Negative | 2307insA | N/A | CF0088 |
| | 4 | Positive | 2789(+5)G > A | Negative | N/A | CF0089 |
| | 4 | Positive | Negative | 2789(+5)G > A | N/A | CF0089 |
| | 4 | Positive | 3120(+1)G > A | Negative | N/A | CF0090 |
| | 4 | Positive | Negative | 3120(+1)G > A | N/A | CF0090 |
| | 4 | Positive | 3659delC | Negative | N/A | CF0091 |
| | 4 | Positive | Negative | 3659delC | N/A | CF0091 |
| | 4 | Positive | 3849(+10 kb)C > T | Negative | N/A | CF0092 |
| | 4 | Positive | Negative | 3849(+10 kb)C > T | N/A | CF0092 |
| | 4 | Positive | 3876delA | Negative | N/A | CF0093 |
| | 4 | Positive | Negative | 3876delA | N/A | CF0093 |
| | 4 | Positive | 3905insC | Negative | N/A | CF0094 |
| | 4 | Positive | Negative | 3905insC | N/A | CF0094 |
| | 4 | Positive | R117H | Negative | 5T/7T | CF0095 |
| | 4 | Positive | Negative | R117H | 5T/7T | CF0095 |
| | 4 | Positive | R117H | Negative | 5T/9T | CF0096 |
| | 4 | Positive | Negative | R117H | 5T/9T | CF0096 |
| | 4 | Positive | R117H | Negative | 5T/5T | CF0097 |
| | 4 | Positive | Negative | R117H | 5T/5T | CF0097 |
| | 4 | Positive | R117H | Negative | 7T/7T | CF0098 |
| | 4 | Positive | Negative | R117H | 7T/7T | CF0098 |
| | 4 | Positive | R117H | Negative | 7T/9T | CF0099 |
| | 5 | Positive | Negative | R117H | 7T/9T | CF0099 |
| | 5 | Positive | R117H | Negative | 9T/9T | CF0100 |
| | 5 | Positive | Negative | R117H | 9T/9T | CF0100 |
| | 5 | Positive | Delta F508 | Delta F508 | Negative for benign exon 10 variants tested | CF0101 |
| | 5 | Positive | Delta F508 | Negative | F508C heterozygote | CF0102 |
| | 5 | Positive | Negative | Delta F508 | F508C heterozygote | CF0102 |
| | 5 | Positive | Delta F508 | Negative | I506V heterozygote | CF0103 |
| | 5 | Positive | Negative | Delta F508 | I506V heterozygote | CF0103 |
| | 5 | Positive | Delta F508 | Negative | I507V heterozygote | CF0125 |
| | 5 | Positive | Negative | Delta F508 | I507V heterozygote | CF0125 |

**EOF**

CFITD TABLE 1
APPENDIX
Cystic Fibrosis Taglt Platform, Diagnostic Test (CFIID) User Queries and Answers
Taglt Test Code
Values

| Client enters: | Client enters: | First part of result | Second part | Possible third |
|---|---|---|---|---|
| Source | Personal History | Allele 1 | Allele 2 | Variant |
| Blood | Positive | Negative | Negative | N/A |
| Buccal swab | Assumed positive | Delta I507 | Delta I507 | intron 8-5T/7T |
| Mouthwashing | | Delta F508 | Delta F508 | intron 8-5T/9T |
| Cord blood | | A455E | A455E | intron 8-5T/5T |
| Unknown | | A559T | A559T | intron 8-7T/7T |
| | | G85E | G85E | intron 8-7T/9T |
| | | G542X | G542X | intron 8-9T/9T |
| | | G551D | G551D | F508C heterozygote |
| | | M1101K | M1101K | I506V heterozygote |
| | | N1303K | N1303K | I507V heterozygote |
| | | R334W | R334W | Negative for benign exon 10 variants tested |
| | | R34H | R34H | |
| | | R347P | R347P | |
| | | R553X | R553X | |
| | | R560T | R560T | |
| | | R1162X | R1162X | |
| | | S549N | S549N | |
| | | S549R(T > G) | S549R(T > G) | |
| | | S1255X | S1255X | |
| | | V520F | V520F | |
| | | W1282X | W1282X | |
| | | Y122X | Y122X | |
| | | Y1092X (C > A) | Y1092X (C > A) | |
| | | Y1092X (T > G) | Y1092X (T > G) | |
| | | 394delTT | 394delTT | |
| | | 621(+1)G > T | 621(+1)G > T | |
| | | 711(+1)G > T | 711(+1)G > T | |
| | | 1078delT | 1078delT | |
| | | 1717(−1)G > A | 1717(−1)G > A | |
| | | 1898(+1)G > A | 1898(+1)G > A | |
| | | 1898(+5)G > T | 1898(+5)G > T | |
| | | 2183delAA > G | 2183delAA > G | |
| | | 2184delA | 2184delA | |
| | | 2307insA | 2307insA | |
| | | 2789(+5)G > A | 2789(+5)G > A | |
| | | 3120(+1)G > A | 3120(+1)G > A | |
| | | 3659delC | 3659delC | |
| | | 3849(+10 kb)C > T | 3849(+10 kb)C > T | |
| | | 3876delA | 3876delA | |
| | | 3905insC | 3905insC | |
| | | R117H | R117H | |

CFIIC TABLE 3
APPENDIX
INTERPRETATIVE REPORT, CYSTIC FIBROSIS CARRIER SCREEN, INVADER PLATFORM (CFIIC)
Report Header

| | | WORD # | | |
|---|---|---|---|---|
| | | 1 | 2 | 3 |
| Client enter | Source | Any value | Any value | Any value |
| | Ethnicity | Not Solicited | Non-Hispanic Caucasian | Ashkenazi Jewish |
| | Family history | Not Solicited | Negative | Negative |
| | Personal History | Assumed negative/negative | Assumed | Assumed |
| | | | negative/negative | negative/negative |
| | Allele 1 | Negative | Negative | Negative |
| | Allele 2 | Negative | Negative | Negative |
| | Variant | N/A | N/A | N/A |
| | Comment | | | |
| CODE | | CF0001 | CF0002 | CF0003 |
| Report Field | Indication | Carrier screening | Carrier screening | Carrier screening |
| | Prior Carrier Risk (detection) | omit | 1 in 25 | 1 in 25 |
| | Result | Negative for mutations | Negative for mutations | Negative for mutations |
| | | analyzed | analyzed | analyzed |
| | Revised Carrier Risk | omit | 1 in 241 | 1 in 801 |
| | Recommendations | omit | omit | omit |
| | Interpretation | text | text | text |
| Report Field | CF004 | CF004 | CF004 | CF004 |
| 4 | 5 | 6 | 7 | 8 |
| Any value | Any value | Any value | Any value | Any value |
| Hispanic American | African American | Asian American | Complex | Not provided |
| Negative | Negative | Negative | Negative | Negative |
| Assumed | Assumed | Assumed | Assumed | Assumed |
| negative/negative | negative/negative | negative/negative | negative/negative | negative/negative |
| Negative | Negative | Negative | Negative | Negative |
| Negative | Negative | Negative | Negative | Negative |
| N/A | N/A | N/A | N/A | N/A |
| | | | Client may enter free text | |
| CF0004 | CF0005 | CF0006 | CF0007 | CF0008 |
| Carrier screening | Carrier screening | Carrier screening | Carrier screening | Carrier screening |
| 1 in 46 | 1 in 65 | 1 in 90 | Not calculated | Not calculated |
| Negative for mutations | Negative for mutations | Negative for mutations | Negative for mutations | Negative for mutations |
| analyzed | analyzed | analyzed | analyzed | analyzed |
| 1 in 105 | 1 in 207 | Not calculated | Not calculated | Not calculated |
| omit | omit | omit | omit | omit |
| text | text | text | text | text |
| CF004 | CF004 | CF004 | CF004 | CF004 |
| 9 | 9b | 10 | 10b | 11 |
| Any value | Any value | Any value | Any value | Any value |
| Any value | Any value | Any value | Any value | Any value |
| Any value | Any value | Any value | Any value | Any value |
| Assumed | Assumed | Assumed | Assumed | Assumed |
| negative/negative | negative/negative | negative/negative | negative/negative | negative/negative |
| Delta I507 | Negative | Delta F508 | Negative | A455E |
| Negative | Delta I507 | Negative | Delta F508 | Negative |
| N/A | N/A | N/A | N/A | N/A |
| CF0009 | CF0009 | CF0010 | CF0010 | CF0011 |
| Carrier screening | Carrier screening | Carrier screening | Carrier screening | Carrier screening |
| omit | omit | omit | omit | omit |
| Delta I507 heterozygote; | Delta I507 heterozygote; | Delta F508 heterozygote; | Delta F508 heterozygote; | A455E heterozygote; |
| cystic fibrosis carrier | cystic fibrosis carrier | cystic fibrosis carrier | cystic fibrosis carrier | cystic fibrosis carrier |
| omit | omit | omit | omit | omit |
| recs | recs | recs | recs | recs |
| text | text | text | text | text |
| CF004 | CF004 | CF004 | CF004 | CF004 |
| 11b | 105 | 105b | 13 | 13b |
| Any value | Any value | Any value | Any value | Any value |
| Any value | Any value | Any value | Any value | Any value |
| Any value | Any value | Any value | Any value | Any value |
| Assumed | Assumed | Assumed | Assumed | Assumed |
| negative/negative | negative/negative | negative/negative | negative/negative | negative/negative |
| Negative | E60X | Negative | G85E | Negative |
| A455E | Negative | E60X | Negative | G85E |
| N/A | N/A | N/A | N/A | N/A |
| CF0011 | CF0105 | CF0105 | CF0013 | CF0013 |
| Carrier screening | Carrier screening | Carrier screening | Carrier screening | Carrier screening |
| omit | omit | omit | omit | omit |
| A455E heterozygote; | E60X heterozygote; | E60X heterozygote; | G85E heterozygote; | G85E heterozygote; |
| cystic fibrosis carrier | cystic fibrosis carrier | cystic fibrosis carrier | cystic fibrosis carrier | cystic fibrosis carrier |
| omit | omit | omit | omit | omit |
| recs | recs | recs | recs | recs |
| text | text | text | text | text |
| CF004 | CF004 | CF004 | CF004 | CF004 |
| 14 | 14b | 15 | 15b | 17 |
| Any value | Any value | Any value | Any value | Any value |
| Any value | Any value | Any value | Any value | Any value |
| Any value | Any value | Any value | Any value | Any value |
| Assumed | Assumed | Assumed | Assumed | Assumed |
| negative/negative | negative/negative | negative/negative | negative/negative | negative/negative |
| G542X | Negative | G551D | Negative | N1303K |
| Negative | G542X | Negative | G551D | Negative |
| N/A | N/A | N/A | N/A | N/A |
| CF0014 | CF0014 | CF0015 | CF0015 | CF0017 |
| Carrier screening | Carrier screening | Carrier screening | Carrier screening | Carrier screening |
| omit | omit | omit | omit | omit |
| G542X heterozygote; | G542X heterozygote; | G551D heterozygote; | G551D heterozygote; | N1303K heterozygote; |
| cystic fibrosis carrier | cystic fibrosis carrier | cystic fibrosis carrier | cystic fibrosis carrier | cystic fibrosis carrier |
| omit | omit | omit | omit | omit |
| recs | recs | recs | recs | recs |
| text | text | text | text | text |
| CF004 | CF004 | CF004 | CF004 | CF004 |
| 17b | 106 | 106b | 18 | 18b |
| Any value | Any value | Any value | Any value | Any value |
| Any value | Any value | Any value | Any value | Any value |
| Any value | Any value | Any value | Any value | Any value |
| Assumed | Assumed | Assumed | Assumed | Assumed |
| negative/negative | negative/negative | negative/negative | negative/negative | negative/negative |
| Negative | Q493X | Negative | R334W | Negative |
| N1303K | Negative | Q493X | Negative | R334W |
| N/A | N/A | N/A | N/A | N/A |
| CF0017 | CF0106 | CF0106 | CF0019 | CF0019 |
| Carrier screening | Carrier screening | Carrier screening | Carrier screening | Carrier screening |
| omit | omit | omit | omit | omit |
| N1303K heterozygote; | Q493X heterozygote; | Q493X heterozygote; | R347H heterozygote; | R347H heterozygote; |
| cystic fibrosis carrier | cystic fibrosis carrier | cystic fibrosis carrier | cystic fibrosis carrier | cystic fibrosis carrier |
| omit | omit | omit | omit | omit |
| recs | recs | recs | recs | recs |
| text | text | text | text | text |
| CF004 | CF004 | CF004 | CF004 | CF004 |
| 19 | 19b | 20 | 20b | 21 |
| Any value | Any value | Any value | Any value | Any value |
| Any value | Any value | Any value | Any value | Any value |
| Any value | Any value | Any value | Any value | Any value |
| Assumed | Assumed | Assumed | Assumed | Assumed |
| negative/negative | negative/negative | negative/negative | negative/negative | negative/negative |
| R347H | Negative | R347P | Negative | R553X |
| Negative | R347H | Negative | R347P | Negative |
| N/A | N/A | N/A | N/A | N/A |
| CF0019 | CF0019 | CF0020 | CF0020 | CF0021 |
| Carrier screening | Carrier screening | Carrier screening | Carrier screening | Carrier screening |
| omit | omit | omit | omit | omit |
| R347H heterozygote; | R347H heterozygote; | R347P heterozygote; | R347P heterozygote; | R553X heterozygote; |
| cystic fibrosis carrier | cystic fibrosis carrier | cystic fibrosis carrier | cystic fibrosis carrier | cystic fibrosis carrier |
| omit | omit | omit | omit | omit |
| recs | recs | recs | recs | recs |
| text | text | text | text | text |
| CF004 | CF004 | CF004 | CF004 | CF004 |
| 21b | 22 | 22b | 23 | 23b |
| Any value | Any value | Any value | Any value | Any value |
| Any value | Any value | Any value | Any value | Any value |
| Any value | Any value | Any value | Any value | Any value |
| Assumed | Assumed | Assumed | Assumed | Assumed |
| negative/negative | negative/negative | negative/negative | negative/negative | negative/negative |
| Negative | R560T | Negative | R1162X | Negative |
| R553X | Negative | R560T | Negative | R1162X |
| N/A | N/A | N/A | N/A | N/A |
| CF0021 | CF0022 | CF0022 | CF0023 | CF0023 |
| Carrier screening | Carrier screening | Carrier screening | Carrier screening | Carrier screening |
| omit | omit | omit | omit | omit |
| R553X heterozygote; | R560T heterozygote; | R560T heterozygote; | R1162X heterozygote; | R1162X heterozygote; |
| cystic fibrosis carrier | cystic fibrosis carrier | cystic fibrosis carrier | cystic fibrosis carrier | cystic fibrosis carrier |
| omit | omit | omit | omit | omit |
| recs | recs | recs | recs | recs |
| text | text | text | text | text |
| CF004 | CF004 | CF004 | CF004 | CF004 |
| 24 | 24b | 107 | 107b | 25 |
| Any value | Any value | Any value | Any value | Any value |
| Any value | Any value | Any value | Any value | Any value |
| Any value | Any value | Any value | Any value | Any value |
| Assumed | Assumed | Assumed | Assumed | Assumed |
| negative/negative | negative/negative | negative/negative | negative/negative | negative/negative |
| S549N | Negative | S549R(A > C) | Negative | S549R(T > G) |
| Negative | S549N | Negative | S549R(A > C) | Negative |
| N/A | N/A | N/A | N/A | N/A |
| CF0024 | CF0024 | CF0107 | CF0107 | CF0025 |
| Carrier screening | Carrier screening | Carrier screening | Carrier screening | Carrier screening |
| omit | omit | omit | omit | omit |
| S549N heterozygote; | S549N heterozygote; | S549R(A > C) | S549R(A > C) | S549R(T > G) |
| cystic fibrosis carrier | cystic fibrosis carrier | heterozygote; cystic | heterozygote; cystic | heterozygote; cystic |
| | | fibrosis carrier | fibrosis carrier | fibrosis carrier |
| omit | omit | omit | omit | omit |
| recs | recs | recs | recs | recs |
| text | text | text | text | text |
| CF004 | CF004 | CF004 | CF004 | CF004 |
| 25b | 27 | 27b | 28 | 28b |
| Any value | Any value | Any value | Any value | Any value |
| Any value | Any value | Any value | Any value | Any value |
| Any value | Any value | Any value | Any value | Any value |
| Assumed | Assumed | Assumed | Assumed | Assumed |
| negative/negative | negative/negative | negative/negative | negative/negative | negative/negative |
| Negative | V520F | Negative | W1282X | Negative |
| S549R(T > G) | Negative | V520F | Negative | W1282X |
| N/A | N/A | N/A | N/A | N/A |
| CF0025 | CF0027 | CF0027 | CF0028 | CF0028 |
| Carrier screening | Carrier screening | Carrier screening | Carrier screening | Carrier screening |
| omit | omit | omit | omit | omit |
| S549R(T > G) | V520F heterozygote; | V520F heterozygote; | W1282X heterozygote; | W1282X heterozygote; |
| heterozygote; cystic | cystic fibrosis carrier | cystic fibrosis carrier | cystic fibrosis carrier | cystic fibrosis carrier |
| fibrosis carrier | | | | |
| omit | omit | omit | omit | omit |
| recs | recs | recs | recs | recs |
| text | text | text | text | text |
| CF004 | CF004 | CF004 | CF004 | CF004 |
| 29 | 29b | 30 | 30b | 31 |
| Any value | Any value | Any value | Any value | Any value |
| Any value | Any value | Any value | Any value | Any value |
| Any value | Any value | Any value | Any value | Any value |
| Assumed | Assumed | Assumed | Assumed | Assumed |
| negative/negative | negative/negative | negative/negative | negative/negative | negative/negative |
| Y122X | Negative | Y1092X(C > A) | Negative | Y1092X(C > G) |
| Negative | Y122X | Negative | Y1092X(C > A) | Negative |
| N/A | N/A | N/A | N/A | N/A |
| CF0029 | CF0029 | CF0030 | CF0030 | CF0031 |
| Carrier screening | Carrier screening | Carrier screening | Carrier screening | Carrier screening |
| omit | omit | omit | omit | omit |
| Y122X heterozygote; | Y122X heterozygote; | Y1092X(C > A) | Y1092X(C > A) | Y1092X(C > G) |
| cystic fibrosis carrier | cystic fibrosis carrier | heterozygote; cystic | heterozygote; cystic | heterozygote; cystic |
| | | fibrosis carrier | fibrosis carrier | fibrosis carrier |
| omit | omit | omit | omit | omit |
| recs | recs | recs | recs | recs |
| text | text | text | text | text |
| CF004 | CF004 | CF004 | CF004 | CF004 |
| 31b | 32 | 32b | 33 | 33b |
| Any value | Any value | Any value | Any value | Any value |
| Any value | Any value | Any value | Any value | Any value |
| Any value | Any value | Any value | Any value | Any value |
| Assumed | Assumed | Assumed | Assumed | Assumed |
| negative/negative | negative/negative | negative/negative | negative/negative | negative/negative |
| Negative | 394delTT | Negative | 621(+1)G > T | Negative |
| Y1092X(C > G) | Negative | 394delTT | Negative | 621(+1)G > T |
| N/A | N/A | N/A | N/A | N/A |
| CF0031 | CF0032 | CF0032 | CF0033 | CF0033 |
| Carrier screening | Carrier screening | Carrier screening | Carrier screening | Carrier screening |
| omit | omit | omit | omit | omit |
| Y1092X(C > G) | 394delTT heterozygote; | 394delTT heterozygote; | 621(+1)G > T | 621(+1)G > T |
| heterozygote; cystic | cystic fibrosis carrier | cystic fibrosis carrier | heterozygote; cystic | heterozygote; cystic |
| fibrosis carrier | | | fibrosis carrier | fibrosis carrier |
| omit | omit | omit | omit | omit |
| recs | recs | recs | recs | recs |
| text | text | text | text | text |
| CF004 | CF004 | CF004 | CF004 | CF004 |
| 34 | 34b | 35 | 35b | 36 |
| Any value | Any value | Any value | Any value | Any value |
| Any value | Any value | Any value | Any value | Any value |
| Any value | Any value | Any value | Any value | Any value |
| Assumed | Assumed | Assumed | Assumed | Assumed |
| negative/negative | negative/negative | negative/negative | negative/negative | negative/negative |
| 711(+1)G > T | Negative | 1078delT | Negative | 1717(−1)G > A |
| Negative | 711(+1)G > T | Negative | 1078delT | Negative |
| N/A | N/A | N/A | N/A | N/A |
| CF0034 | CF0034 | CF0035 | CF0035 | CF0036 |
| Carrier screening | Carrier screening | Carrier screening | Carrier screening | Carrier screening |
| omit | omit | omit | omit | omit |
| 711(+1)G > T | 711(+1)G > T | 1078delT heterozygote; | 1078delT heterozygote; | 1717(−1)G > A |
| heterozygote; cystic | heterozygote; cystic | cystic fibrosis carrier | cystic fibrosis carrier | heterozygote; cystic |
| fibrosis carrier | fibrosis carrier | | | fibrosis carrier |
| omit | omit | omit | omit | omit |
| recs | recs | recs | recs | recs |
| text | text | text | text | text |
| CF004 | CF004 | CF004 | CF004 | CF004 |
| 36b | 37 | 37b | 39 | 39b |
| Any value | Any value | Any value | Any value | Any value |
| Any value | Any value | Any value | Any value | Any value |
| Any value | Any value | Any value | Any value | Any value |
| Assumed | Assumed | Assumed | Assumed | Assumed |
| negative/negative | negative/negative | negative/negative | negative/negative | negative/negative |
| Negative | 1898(+1)G > A | Negative | 2183delAA > G | Negative |
| 1717(−1)G > A | Negative | 1898(+1)G > A | Negative | 2183delAA > G |
| N/A | N/A | N/A | N/A | N/A |
| CF0036 | CF0037 | CF0037 | CF0039 | CF0039 |
| Carrier screening | Carrier screening | Carrier screening | Carrier screening | Carrier screening |
| omit | omit | omit | omit | omit |
| 1717(−1)G > A | 1898(+1)G > A | 1898(+1)G > A | 2183delAA > G | 2183delAA > G |
| heterozygote; cystic | heterozygote; cystic | heterozygote; cystic | heterozygote; cystic | heterozygote; cystic |
| fibrosis carrier | fibrosis carrier | fibrosis carrier | fibrosis carrier | fibrosis carrier |
| omit | omit | omit | omit | omit |
| recs | recs | recs | recs | recs |
| text | text | text | text | text |
| CF004 | CF004 | CF004 | CF004 | CF004 |
| 40 | 40b | 42 | 42b | 43 |
| Any value | Any value | Any value | Any value | Any value |
| Any value | Any value | Any value | Any value | Any value |
| Any value | Any value | Any value | Any value | Any value |
| Assumed | Assumed | Assumed | Assumed | Assumed |
| negative/negative | negative/negative | negative/negative | negative/negative | negative/negative |
| 2184delA | Negative | 2789(+5)G > A | Negative | 3120(+1)G > A |
| Negative | 2184delA | Negative | 2789(+5)G > A | Negative |
| N/A | N/A | N/A | N/A | N/A |
| CF0040 | CF0040 | CF0042 | CF0042 | CF0043 |
| Carrier screening | Carrier screening | Carrier screening | Carrier screening | Carrier screening |
| omit | omit | omit | omit | omit |
| 2184delA heterozygote; | 2184delA heterozygote; | 2789(+5)G > A | 2789(+5)G > A | 3120(+1)G > A |
| cystic fibrosis carrier | cystic fibrosis carrier | heterozygote; cystic | heterozygote; cystic | heterozygote; cystic |
| | | fibrosis carrier | fibrosis carrier | fibrosis carrier |
| omit | omit | omit | omit | omit |
| recs | recs | recs | recs | recs |
| text | text | text | text | text |
| CF004 | CF004 | CF004 | CF004 | CF004 |
| 43b | 44 | 44b | 108 | 108b |
| Any value | Any value | Any value | Any value | Any value |
| Any value | Any value | Any value | Any value | Any value |
| Any value | Any value | Any value | Any value | Any value |
| Assumed | Assumed | Assumed | Assumed | Assumed |
| negative/negative | negative/negative | negative/negative | negative/negative | negative/negative |
| Negative | 3659delC | Negative | 3849(+4)A > G | Negative |
| 3120(+1)G > A | Negative | 3659delC | Negative | 3849(+4)A > G |
| N/A | N/A | N/A | N/A | N/A |
| CF0043 | CF0044 | CF0044 | CF0108 | CF0108 |
| Carrier screening | Carrier screening | Carrier screening | Carrier screening | Carrier screening |
| omit | omit | omit | omit | omit |
| 3120(+1)G > A | 3659delC heterozygote; | 3659delC heterozygote; | 3849(+4)A > G | 3849(+4)A > G |
| heterozygote; cystic | cystic fibrosis carrier | cystic fibrosis carrier | heterozygote; cystic | heterozygote; cystic |
| fibrosis carrier | | | fibrosis carrier | fibrosis carrier |
| omit | omit | omit | omit | omit |
| recs | recs | recs | recs | recs |
| text | text | text | text | text |
| CF004 | CF004 | CF004 | CF004 | CF004 |
| 45 | 45b | 46 | 46b | 47 |
| Any value | Any value | Any value | Any value | Any value |
| Any value | Any value | Any value | Any value | Any value |
| Any value | Any value | Any value | Any value | Any value |
| Assumed | Assumed | Assumed | Assumed | Assumed |
| negative/negative | negative/negative | negative/negative | negative/negative | negative/negative |
| 3849(+10 kb)C > T | Negative | 3876delA | Negative | 3905insC |
| Negative | 3849(+10 kb)C > T | Negative | 3876delA | Negative |
| N/A | N/A | N/A | N/A | N/A |
| CF0045 | CF0045 | CF0046 | CF0046 | CF0047 |
| Carrier screening | Carrier screening | Carrier screening | Carrier screening | Carrier screening |
| omit | omit | omit | omit | omit |
| 3849(+10 kb)C > T | 3849(+10 kb)C > T | 3876delA heterozygote; | 3876delA heterozygote; | 3905insC heterozygote; |
| heterozygote; cystic | heterozygote; cystic | cystic fibrosis carrier | cystic fibrosis carrier | cystic fibrosis carrier |
| fibrosis carrier | fibrosis carrier | | | |
| omit | omit | omit | omit | omit |
| recs | recs | recs | recs | recs |
| text | text | text | text | text |
| CF004 | CF004 | CF004 | CF004 | CF004 |
| 47b | 48 | 48b | 49 | 49b |
| Any value | Any value | Any value | Any value | Any value |
| Any value | Any value | Any value | Any value | Any value |
| Any value | Any value | Any value | Any value | Any value |
| Assumed | Assumed | Assumed | Assumed | Assumed |
| negative/negative | negative/negative | negative/negative | negative/negative | negative/negative |
| Negative | R117H | Negative | R117H | Negative |
| 3905insC | Negative | R117H | Negative | R117H |
| N/A | intron 8-5T/7T | intron 8-5T/7T | intron 8-5T/9T | intron 8-5T/9T |
| CF0047 | CF0048 | CF0048 | CF0049 | CF0049 |
| Carrier screening | Carrier screening | Carrier screening | Carrier screening | Carrier screening |
| omit | omit | omit | omit | omit |
| 3905insC heterozygote; | Cystic fibrosis carrier; | Cystic fibrosis carrier; | Cystic fibrosis carrier; | Cystic fibrosis carrier; |
| cystic fibrosis carrier | R117H heterozygote; | R117H heterozygote; | R117H heterozygote; | R117H heterozygote; |
| | intron 8-5T positive | intron 8-5T positive | intron 8-5T positive | intron 8-5T positive |
| | 5T/7T, phase unknown | 5T/7T, phase unknown | 5T/9T, phase unknown | 5T/9T, phase unknown |
| omit | omit | omit | omit | omit |
| recs | recs | recs | recs | recs |
| text | text | text | text | text |
| CF004 | CF004 | CF004 | CF004 | CF004 |

| 50 | 50b | 51 | 51b | 52 | 52b |
|---|---|---|---|---|---|
| Any value | Any value | Any value | Any value | Any value | Any value |
| Any value | Any value | Any value | Any value | Any value | Any value |
| Any value | Any value | Any value | Any value | Any value | Any value |
| Assumed | Assumed | Assumed | Assumed | Assumed | Assumed |
| negative/negative | negative/negative | negative/negative | negative/negative | negative/negative | negative/negative |
| R117H | Negative | R117H | Negative | R117H | Negative |
| Negative | R117H | Negative | R117H | Negative | R117H |
| intron 8-5T/5T | intron 8-5T/5T | intron 8-7T/7T | intron 8-7T/7T | intron 8-7T/9T | intron 8-7T/9T |
| CF0050 | CF0050 | CF0051 | CF0051 | CF0052 | CF0052 |
| Carrier screening | Carrier screening | Carrier screening | Carrier screening | Carrier screening | Carrier screening |
| omit | omit | omit | omit | omit | omit |
| Cystic fibrosis carrier; | Cystic fibrosis carrier; | Cystic fibrosis carrier; | Cystic fibrosis carrier; | Cystic fibrosis carrier; | Cystic fibrosis carrier; |
| R117H heterozygote and | R117H heterozygote and | R117H heterozygote; | R117H heterozygote; | R117H heterozygote; | R117H heterozygote; |
| intron 8-5T/5T | intron 8-5T/5T | intron 8-5T negative, | intron 8-5T negative, | intron 8-5T negative, | intron 8-5T negative, |
| homozygote | homozygote | 7T/7T | 7T/7T | 7T/9T | 7T/9T |
| omit | omit | omit | omit | omit | omit |
| recs | recs | recs | recs | recs | recs |
| text | text | text | text | text | text |
| CF004 | CF004 | CF004 | CF004 | CF004 | CF004 |
| 53 | 53b | 54 | 54b | 55 | 56 |
| Any value | Any value | Any value | Any value | Any value | Any value |
| Any value | Any value | Any value | Any value | Any value | Any value |
| Any value | Any value | Any value | Any value | Positive | Any value |
| Assumed | Assumed | Assumed | Assumed | Negative | Negative |
| negative/negative | negative/negative | negative/negative | negative/negative | | |
| R117H | Negative | Delta F508 | Negative | Any value | Any value except |
| | | | | | negative and |
| Negative | R117H | Negative | Delta F508 | Any value | Any value except |
| | | | | | negative |
| intron 8-9T/9T | intron 8-9T/9T | F508C | F508C | Any value | Any value |
| CF0053 | CF0053 | CF0054 | CF0054 | Manual based on | Manual based on |
| | | | | several templates | template |
| Carrier screening | Carrier screening | Carrier screening | Carrier screening | | |
| omit | omit | omit | omit | | |
| Cystic fibrosis carrier; | Cystic fibrosis carrier; | Delta F508/F508C | Delta F508/F508C | | |
| R117H heterozygote; | R117H heterozygote; | compound | compound heterozygote; | | |
| intron 8-5T negative, | intron 8-5T negative, | heterozygote; cystic | cystic fibrosis carrier | | |
| 9T/9T | 9T/9T | fibrosis carrier | | | |
| omit | omit | omit | omit | | |
| recs | recs | recs | recs | | |
| text | text | text | text | | |
| CF004 | CF004 | CF004 | CF004 | CF004 | CF004 |

CFIIC TABLE 2
APPENDIX
Cystic Fibrosis Invader(TM) Platform, Carrier Test (CFIIC)
Data and Report Codes

| | | | | 8245 | | | | |
|---|---|---|---|---|---|---|---|---|
| 0 | 8445 | 8045 | 8145 | Personal | 9045 | 9046 | 8345 | 8745 |
| INT | Source | Ethnicity | Family history | History | Allele 1 | Allele 2 | Variant | MC |
| | 1 | Not Solicited | Not Solicited | Negative | Negative | Negative | N/A | CF0001 |
| | 1 | Non-Hispanic | Negative | Negative | Negative | Negative | N/A | CF0002 |
| | | Caucasian | | | | | | |
| | 1 | Ashkenazi Jewish | Negative | Negative | Negative | Negative | N/A | CF0003 |
| | 1 | Hispanic American | Negative | Negative | Negative | Negative | N/A | CF0004 |
| | 1 | African American | Negative | Negative | Negative | Negative | N/A | CF0005 |
| | 1 | Asian American | Negative | Negative | Negative | Negative | N/A | CF0006 |
| | 1 | Complex | Negative | Negative | Negative | Negative | N/A | CF0007 |
| | 1 | Not provided | Negative | Negative | Negative | Negative | N/A | CF0008 |
| | 2 | | | Negative | Delta I507 | Negative | N/A | CF0009 |
| | 2 | | | Negative | Negative | Delta I507 | N/A | CF0009 |
| | 2 | | | Negative | Delta F508 | Negative | N/A | CF0010 |
| | 2 | | | Negative | Negative | Delta F508 | N/A | CF0010 |
| | 2 | | | Negative | A455E | Negative | N/A | CF0011 |
| | 2 | | | Negative | Negative | A455E | N/A | CF0011 |
| | 2 | | | Negative | E60X | Negative | N/A | CF0105 |
| | 2 | | | Negative | Negative | E60X | N/A | CF0105 |
| | 2 | | | Negative | G85E | Negative | N/A | CF0013 |
| | 2 | | | Negative | Negative | G85E | N/A | CF0013 |
| | 2 | | | Negative | G542X | Negative | N/A | CF0014 |
| | 2 | | | Negative | Negative | G542X | N/A | CF0014 |
| | 2 | | | Negative | G551D | Negative | N/A | CF0015 |
| | 2 | | | Negative | Negative | G551D | N/A | CF0015 |
| | 2 | | | Negative | N1303K | Negative | N/A | CF0017 |
| | 2 | | | Negative | Negative | N1303K | N/A | CF0017 |
| | 2 | | | Negative | Q493X | Negative | N/A | CF0106 |
| | 2 | | | Negative | Negative | Q493X | N/A | CF0106 |
| | 2 | | | Negative | R334W | Negative | N/A | CF0019 |
| | 2 | | | Negative | Negative | R334W | N/A | CF0019 |
| | 2 | | | Negative | R347H | Negative | N/A | CF0019 |
| | 2 | | | Negative | Negative | R347H | N/A | CF0019 |
| | 3 | | | Negative | R347P | Negative | N/A | CF0020 |
| | 3 | | | Negative | Negative | R347P | N/A | CF0020 |
| | 3 | | | Negative | R553X | Negative | N/A | CF0021 |
| | 3 | | | Negative | Negative | R553X | N/A | CF0021 |
| | 3 | | | Negative | R560T | Negative | N/A | CF0022 |
| | 3 | | | Negative | Negative | R560T | N/A | CF0022 |
| | 3 | | | Negative | R1162X | Negative | N/A | CF0023 |
| | 3 | | | Negative | Negative | R1162X | N/A | CF0023 |
| | 3 | | | Negative | S549N | Negative | N/A | CF0024 |
| | 3 | | | Negative | Negative | S549N | N/A | CF0024 |
| | 3 | | | Negative | S549R(A > C) | Negative | N/A | CF0107 |
| | 3 | | | Negative | Negative | S549R(A > C) | N/A | CF0107 |
| | 3 | | | Negative | S549R(T > G) | Negative | N/A | CF0025 |
| | 3 | | | Negative | Negative | S549R(T > G) | N/A | CF0025 |
| | 3 | | | Negative | V520F | Negative | N/A | CF0027 |
| | 3 | | | Negative | Negative | V520F | N/A | CF0027 |
| | 3 | | | Negative | W1282X | Negative | N/A | CF0028 |
| | 3 | | | Negative | Negative | W1282X | N/A | CF0028 |
| | 3 | | | Negative | Y122X | Negative | N/A | CF0029 |
| | 3 | | | Negative | Negative | Y122X | N/A | CF0029 |
| | 3 | | | Negative | Y1092X(C > A) | Negative | N/A | CF0030 |
| | 3 | | | Negative | Negative | Y1092X(C > A) | N/A | CF0030 |
| | 4 | | | Negative | Y1092X(C > G) | Negative | N/A | CF0031 |
| | 4 | | | Negative | Negative | Y1092X(C > G) | N/A | CF0031 |
| | 4 | | | Negative | 394delTT | Negative | N/A | CF0032 |
| | 4 | | | Negative | Negative | 394delTT | N/A | CF0032 |
| | 4 | | | Negative | 621(+1)G > T | Negative | N/A | CF0033 |
| | 4 | | | Negative | Negative | 621(+1)G > T | N/A | CF0033 |
| | 4 | | | Negative | 711(+1)G > T | Negative | N/A | CF0034 |
| | 4 | | | Negative | Negative | 711(+1)G > T | N/A | CF0034 |
| | 4 | | | Negative | 1078delT | Negative | N/A | CF0035 |
| | 4 | | | Negative | Negative | 1078delT | N/A | CF0035 |
| | 4 | | | Negative | 1717(−1)G > A | Negative | N/A | CF0036 |
| | 4 | | | Negative | Negative | 1717(−1)G > A | N/A | CF0036 |
| | 4 | | | Negative | 1898(+1)G > A | Negative | N/A | CF0037 |
| | 4 | | | Negative | Negative | 1898(+1)G > A | N/A | CF0037 |
| | 4 | | | Negative | 2183delAA > G | Negative | N/A | CF0039 |
| | 4 | | | Negative | Negative | 2183delAA > G | N/A | CF0039 |
| | 4 | | | Negative | 2184delA | Negative | N/A | CF0040 |
| | 4 | | | Negative | Negative | 2184delA | N/A | CF0040 |
| | 4 | | | Negative | 2789(+5)G > A | Negative | N/A | CF0042 |
| | 4 | | | Negative | Negative | 2789(+5)G > A | N/A | CF0042 |
| | 4 | | | Negative | 3120(+1)G > A | Negative | N/A | CF0043 |
| | 4 | | | Negative | Negative | 3120(+1)G > A | N/A | CF0043 |
| | 5 | | | Negative | 3659delC | Negative | N/A | CF0044 |
| | 5 | | | Negative | Negative | 3659delC | N/A | CF0044 |
| | 5 | | | Negative | 3849(+4)A > G | Negative | N/A | CF0108 |
| | 5 | | | Negative | Negative | 3849(+4)A > G | N/A | CF0108 |
| | 5 | | | Negative | 3849(+10 kb)C > T | Negative | N/A | CF0045 |
| | 5 | | | Negative | Negative | 3849(+10 kb)C > T | N/A | CF0045 |
| | 5 | | | Negative | 3876delA | Negative | N/A | CF0046 |
| | 5 | | | Negative | Negative | 3876delA | N/A | CF0046 |
| | 5 | | | Negative | 3905insC | Negative | N/A | CF0047 |
| | 5 | | | Negative | Negative | 3905insC | N/A | CF0047 |
| | 5 | | | Negative | R117H | Negative | intron 8-5T/7T | CF0048 |
| | 5 | | | Negative | Negative | R117H | intron 8-5T/7T | CF0048 |
| | 5 | | | Negative | R117H | Negative | intron 8-5T/9T | CF0049 |
| | 5 | | | Negative | Negative | R117H | intron 8-5T/9T | CF0049 |
| | 5 | | | Negative | R117H | Negative | intron 8-5T/5T | CF0050 |
| | 5 | | | Negative | Negative | R117H | intron 8-5T/5T | CF0050 |
| | 5 | | | Negative | R117H | Negative | intron 8-7T/7T | CF0051 |
| | 5 | | | Negative | Negative | R117H | intron 8-7T/7T | CF0051 |
| | 5 | | | Negative | R117H | Negative | intron 8-7T/9T | CF0052 |
| | 5 | | | Negative | Negative | R117H | intron 8-7T/9T | CF0052 |
| | 5 | | | Negative | R117H | Negative | intron 8-9T/9T | CF0053 |
| | 5 | | | Negative | Negative | R117H | intron 8-9T/9T | CF0053 |
| | 6 | | | Negative | Delta F508 | Negative | F508C | CF0054 |
| | 6 | | | Negative | Negative | Delta F508 | F508C | CF0054 |

**EOF**

CFITC TABLE 3
APPENDIX
CFITC - Interpretative Report
INTERPRETATIVE REPORT, CYSTIC FIBROSIS CARRIER SCREEN, TAGIT PLATFORM
Report Header

WORD #

| | | 1 | 2 | 3 |
|---|---|---|---|---|
| Client enter | Source | Any value | Any value | Any value |
| | Ethnicity | Not Solicited | Non-Hispanic Caucasian | Ashkenazi Jewish |
| | Family history | Not Solicited | Negative | Negative |
| | Personal History | Assumed | Assumed | Assumed |
| | | negative/negative | negative/negative | negative/negative |
| | Allele 1 | Negative | Negative | Negative |
| | Allele 2 | Negative | Negative | Negative |
| | Variant | N/A | N/A | N/A |
| | Comment | | | |
| CODE | | CF0001 | CF0002 | CF0003 |
| Report Field | Indication | Carrier screening | Carrier screening | Carrier screening |
| | Prior Carrier Risk | omit | 1 in 25 | 1 in 25 |
| | (detection) | | | |
| | Result | Negative for | Negative for | Negative for |
| | | mutations | mutations | mutations |
| | | analyzed | analyzed | analyzed |
| | Revised Carrier Risk | omit | 1 in 241 | 1 in 801 |
| | Recommendations | omit | omit | omit |
| | Interpretation | text | text | text |
| Report Field | CF002 | CF002 | CF002 | CF002 |

| 4 | 5 | 6 | 7 | 8 |
|---|---|---|---|---|
| Any value | Any value | Any value | Any value | Any value |
| Hispanic American | African American | Asian American | Complex | Not provided |
| Negative | Negative | Negative | Negative | Negative |
| Assumed | Assumed | Assumed | Assumed | Assumed |
| negative/negative | negative/negative | negative/negative | negative/negative | negative/negative |
| Negative | Negative | Negative | Negative | Negative |
| Negative | Negative | Negative | Negative | Negative |
| N/A | N/A | N/A | N/A | N/A |
| | | | Client may enter free text | |
| CF0004 | CF0005 | CF0006 | CF0007 | CF0008 |
| Carrier screening | Carrier screening | Carrier screening | Carrier screening | Carrier screening |
| 1 in 46 | 1 in 65 | 1 in 90 | Not calculated | Not calculated |
| Negative for | Negative for | Negative for | Negative for | Negative for |
| mutations | mutations | mutations | mutations | mutations |
| analyzed | analyzed | analyzed | analyzed | analyzed |
| 1 in 105 | 1 in 207 | Not calculated | Not calculated | Not calculated |
| omit | omit | omit | omit | omit |
| text | text | text | text | text |
| CF002 | CF002 | CF002 | CF002 | CF002 |

| 9 | 9a | 10 | 10a |
|---|---|---|---|
| Any value | Any value | Any value | Any value |
| Any value | Any value | Any value | Any value |
| Any value | Any value | Any value | Any value |
| Assumed | Assumed | Assumed | Assumed |
| negative/negative | negative/negative | negative/negative | negative/negative |
| Delta I507 | Negative | Delta F508 | Negative |
| Negative | Delta I507 | Negative | Delta F508 |
| N/A | N/A | N/A | N/A |
| CF0009 | CF0009 | CF0010 | CF0010 |
| Carrier screening | Carrier screening | Carrier screening | Carrier screening |
| omit | omit | omit | omit |
| Delta I507 heterozygote; | Delta I507 heterozygote; | Delta F508 heterozygote; | Delta F508 heterozygote; |
| cystic fibrosis carrier | cystic fibrosis carrier | cystic fibrosis carrier | cystic fibrosis carrier |
| omit | omit | omit | omit |
| recs | recs | recs | recs |
| text | text | text | text |
| CF002 | CF002 | CF002 | CF002 |
| 11 | 11a | 12 | 12a |
| Any value | Any value | Any value | Any value |
| Any value | Any value | Any value | Any value |
| Any value | Any value | Any value | Any value |
| Assumed | Assumed | Assumed | Assumed |
| negative/negative | negative/negative | negative/negative | negative/negative |
| A455E | Negative | A559T | Negative |
| Negative | A455E | Negative | A559T |
| N/A | N/A | N/A | N/A |
| CF0011 | CF0011 | CF0012 | CF0012 |
| Carrier screening | Carrier screening | Carrier screening | Carrier screening |
| omit | omit | omit | omit |
| A455E heterozygote; | A455E heterozygote; | A559T heterozygote; | A559T heterozygote; |
| cystic fibrosis carrier | cystic fibrosis carrier | cystic fibrosis carrier | cystic fibrosis carrier |
| omit | omit | omit | omit |
| recs | recs | recs | recs |
| text | text | text | text |
| CF002 | CF002 | CF002 | CF002 |
| 13 | 13a | 14 | 14a |
| Any value | Any value | Any value | Any value |
| Any value | Any value | Any value | Any value |
| Any value | Any value | Any value | Any value |
| Assumed | Assumed | Assumed | Assumed |
| negative/negative | negative/negative | negative/negative | negative/negative |
| G85E | Negative | G542X | Negative |
| Negative | G85E | Negative | G542X |
| N/A | N/A | N/A | N/A |
| CF0013 | CF0013 | CF0014 | CF0014 |
| Carrier screening | Carrier screening | Carrier screening | Carrier screening |
| omit | omit | omit | omit |
| G85E heterozygote; | G85E heterozygote; | G542X heterozygote; | G542X heterozygote; |
| cystic fibrosis carrier | cystic fibrosis carrier | cystic fibrosis carrier | cystic fibrosis carrier |
| omit | omit | omit | omit |
| recs | recs | recs | recs |
| text | text | text | text |
| CF002 | CF002 | CF002 | CF002 |
| 15 | 15a | 16 | 16a |
| Any value | Any value | Any value | Any value |
| Any value | Any value | Any value | Any value |
| Any value | Any value | Any value | Any value |
| Assumed | Assumed | Assumed | Assumed |
| negative/negative | negative/negative | negative/negative | negative/negative |
| G551D | Negative | M1101K | Negative |
| Negative | G551D | Negative | M1101K |
| N/A | N/A | N/A | N/A |
| CF0015 | CF0015 | CF0016 | CF0016 |
| Carrier screening | Carrier screening | Carrier screening | Carrier screening |
| omit | omit | omit | omit |
| G551D heterozygote; | G551D heterozygote; | M1101K heterozygote; | M1101K heterozygote; |
| cystic fibrosis carrier | cystic fibrosis carrier | cystic fibrosis carrier | cystic fibrosis carrier |
| omit | omit | omit | omit |
| recs | recs | recs | recs |
| text | text | text | text |
| CF002 | CF002 | CF002 | CF002 |
| 17 | 17a | 18 | 18a |
| Any value | Any value | Any value | Any value |
| Any value | Any value | Any value | Any value |
| Any value | Any value | Any value | Any value |
| Assumed | Assumed | Assumed | Assumed |
| negative/negative | negative/negative | negative/negative | negative/negative |
| N1303K | Negative | R334W | Negative |
| Negative | N1303K | Negative | R334W |
| N/A | N/A | N/A | N/A |
| CF0017 | CF0017 | CF0018 | CF0018 |
| Carrier screening | Carrier screening | Carrier screening | Carrier screening |
| omit | omit | omit | omit |
| N1303K heterozygote; | N1303K heterozygote; | R334W heterozygote; | R334W heterozygote; |
| cystic fibrosis carrier | cystic fibrosis carrier | cystic fibrosis carrier | cystic fibrosis carrier |
| omit | omit | omit | omit |
| recs | recs | recs | recs |
| text | text | text | text |
| CF002 | CF002 | CF002 | CF002 |
| 19 | 19a | 20 | 20a |
| Any value | Any value | Any value | Any value |
| Any value | Any value | Any value | Any value |
| Any value | Any value | Any value | Any value |
| Assumed | Assumed | Assumed | Assumed |
| negative/negative | negative/negative | negative/negative | negative/negative |
| R347H | Negative | R347P | Negative |
| Negative | R347H | Negative | R347P |
| N/A | N/A | N/A | N/A |
| CF0019 | CF0019 | CF0020 | CF0020 |
| Carrier screening | Carrier screening | Carrier screening | Carrier screening |
| omit | omit | omit | omit |
| R347H heterozygote; | R347H heterozygote; | R347P heterozygote; | R347P heterozygote; |
| cystic fibrosis carrier | cystic fibrosis carrier | cystic fibrosis carrier | cystic fibrosis carrier |
| omit | omit | omit | omit |
| recs | recs | recs | recs |
| text | text | text | text |
| CF002 | CF002 | CF002 | CF002 |
| 21 | 21a | 22 | 22a |
| Any value | Any value | Any value | Any value |
| Any value | Any value | Any value | Any value |
| Any value | Any value | Any value | Any value |
| Assumed | Assumed | Assumed | Assumed |
| negative/negative | negative/negative | negative/negative | negative/negative |
| R553X | Negative | R560T | Negative |
| Negative | R553X | Negative | R560T |
| N/A | N/A | N/A | N/A |
| CF0021 | CF0021 | CF0022 | CF0022 |
| Carrier screening | Carrier screening | Carrier screening | Carrier screening |
| omit | omit | omit | omit |
| R553X heterozygote; | R553X heterozygote; | R560T heterozygote; | R560T heterozygote; |
| cystic fibrosis carrier | cystic fibrosis carrier | cystic fibrosis carrier | cystic fibrosis carrier |
| omit | omit | omit | omit |
| recs | recs | recs | recs |
| text | text | text | text |
| CF002 | CF002 | CF002 | CF002 |
| 23 | 23a | 24 | 24a |
| Any value | Any value | Any value | Any value |
| Any value | Any value | Any value | Any value |
| Any value | Any value | Any value | Any value |
| Assumed | Assumed | Assumed | Assumed |
| negative/negative | negative/negative | negative/negative | negative/negative |
| R1162X | Negative | S549N | Negative |
| Negative | R1162X | Negative | S549N |
| N/A | N/A | N/A | N/A |
| CF0023 | CF0023 | CF0024 | CF0024 |
| Carrier screening | Carrier screening | Carrier screening | Carrier screening |
| omit | omit | omit | omit |
| R1162X heterozygote; | R1162X heterozygote; | S549N heterozygote; | S549N heterozygote; |
| cystic fibrosis carrier | cystic fibrosis carrier | cystic fibrosis carrier | cystic fibrosis carrier |
| omit | omit | omit | omit |
| recs | recs | recs | recs |
| text | text | text | text |
| CF002 | CF002 | CF002 | CF002 |
| 25 | 25a | 26 | 26a |
| Any value | Any value | Any value | Any value |
| Any value | Any value | Any value | Any value |
| Any value | Any value | Any value | Any value |
| Assumed | Assumed | Assumed | Assumed |
| negative/negative | negative/negative | negative/negative | negative/negative |
| S549R(T > G) | Negative | S1255X | Negative |
| Negative | S549R(T > G) | Negative | S1255X |
| N/A | N/A | N/A | N/A |
| CF0025 | CF0025 | CF0026 | CF0026 |
| Carrier screening | Carrier screening | Carrier screening | Carrier screening |
| omit | omit | omit | omit |
| S549R(T > G) | S549R(T > G) | S1255X heterozygote; | S1255X heterozygote; |
| heterozygote; cystic | heterozygote; cystic | cystic fibrosis carrier | cystic fibrosis carrier |
| fibrosis carrier | fibrosis carrier | | |
| omit | omit | omit | omit |
| recs | recs | recs | recs |
| text | text | text | text |
| CF002 | CF002 | CF002 | CF002 |
| 27 | 27a | 28 | 28a |
| Any value | Any value | Any value | Any value |
| Any value | Any value | Any value | Any value |
| Any value | Any value | Any value | Any value |
| Assumed | Assumed | Assumed | Assumed |
| negative/negative | negative/negative | negative/negative | negative/negative |
| V520F | Negative | W1282X | Negative |
| Negative | V520F | Negative | W1282X |
| N/A | N/A | N/A | N/A |
| CF0027 | CF0027 | CF0028 | CF0028 |
| Carrier screening | Carrier screening | Carrier screening | Carrier screening |
| omit | omit | omit | omit |
| V520F heterozygote; | V520F heterozygote; | W1282X heterozygote; | W1282X heterozygote; |
| cystic fibrosis carrier | cystic fibrosis carrier | cystic fibrosis carrier | cystic fibrosis carrier |
| omit | omit | omit | omit |
| recs | recs | recs | recs |
| text | text | text | text |
| CF002 | CF002 | CF002 | CF002 |
| 29 | 29a | 30 | 30a |
| Any value | Any value | Any value | Any value |
| Any value | Any value | Any value | Any value |
| Any value | Any value | Any value | Any value |
| Assumed | Assumed | Assumed | Assumed |
| negative/negative | negative/negative | negative/negative | negative/negative |
| Y122X | Negative | Y1092X(C > A) | Negative |
| Negative | Y122X | Negative | Y1092X(C > A) |
| N/A | N/A | N/A | N/A |
| CF0029 | CF0029 | CF0030 | CF0030 |
| Carrier screening | Carrier screening | Carrier screening | Carrier screening |
| omit | omit | omit | omit |
| Y122X heterozygote; | Y122X heterozygote; | Y1092X(C > A) | Y1092X(C > A) |
| cystic fibrosis carrier | cystic fibrosis carrier | heterozygote; cystic | heterozygote; cystic |
| | | fibrosis carrier | fibrosis carrier |
| omit | omit | omit | omit |
| recs | recs | recs | recs |
| text | text | text | text |
| CF002 | CF002 | CF002 | CF002 |
| 31 | 31a | 32 | 32a |
| Any value | Any value | Any value | Any value |
| Any value | Any value | Any value | Any value |
| Any value | Any value | Any value | Any value |
| Assumed | Assumed | Assumed | Assumed |
| negative/negative | negative/negative | negative/negative | negative/negative |
| Y1092X(C > G) | Negative | 394delTT | Negative |
| Negative | Y1092X(C > G) | Negative | 394delTT |
| N/A | N/A | N/A | N/A |
| CF0031 | CF0031 | CF0032 | CF0032 |
| Carrier screening | Carrier screening | Carrier screening | Carrier screening |
| omit | omit | omit | omit |
| Y1092X(C > G) | Y1092X(C > G) | 394delTT heterozygote; | 394delTT heterozygote; |
| heterozygote; cystic | heterozygote; cystic | cystic fibrosis carrier | cystic fibrosis carrier |
| fibrosis carrier | fibrosis carrier | | |
| omit | omit | omit | omit |
| recs | recs | recs | recs |
| text | text | text | text |
| CF002 | CF002 | CF002 | CF002 |
| 33 | 33a | 34 | 34a |
| Any value | Any value | Any value | Any value |
| Any value | Any value | Any value | Any value |
| Any value | Any value | Any value | Any value |
| Assumed | Assumed | Assumed | Assumed |
| negative/negative | negative/negative | negative/negative | negative/negative |
| 621(+1)G > T | Negative | 711(+1)G > T | Negative |
| Negative | 621(+1)G > T | Negative | 711(+1)G > T |
| N/A | N/A | N/A | N/A |
| CF0033 | CF0033 | CF0034 | CF0034 |
| Carrier screening | Carrier screening | Carrier screening | Carrier screening |
| omit | omit | omit | omit |
| 621(+1)G > T | 621(+1)G > T | 711(+1)G > T | 711(+1)G > T |
| heterozygote; cystic | heterozygote; cystic | heterozygote; cystic | heterozygote; cystic |
| fibrosis carrier | fibrosis carrier | fibrosis carrier | fibrosis carrier |
| omit | omit | omit | omit |
| recs | recs | recs | recs |
| text | text | text | text |
| CF002 | CF002 | CF002 | CF002 |
| 35 | 35a | 36 | 36a |
| Any value | Any value | Any value | Any value |
| Any value | Any value | Any value | Any value |
| Any value | Any value | Any value | Any value |
| Assumed | Assumed | Assumed | Assumed |
| negative/negative | negative/negative | negative/negative | negative/negative |
| 1078delT | Negative | 1717(−1)G > A | Negative |
| Negative | 1078delT | Negative | 1717(−1)G > A |
| N/A | N/A | N/A | N/A |
| CF0035 | CF0035 | CF0036 | CF0036 |
| Carrier screening | Carrier screening | Carrier screening | Carrier screening |
| omit | omit | omit | omit |
| 1078delT heterozygote; | 1078delT heterozygote; | 1717(−1)G > A | 1717(−1)G > A |
| cystic fibrosis carrier | cystic fibrosis carrier | heterozygote; cystic | heterozygote; cystic |
| | | fibrosis carrier | fibrosis carrier |
| omit | omit | omit | omit |
| recs | recs | recs | recs |
| text | text | text | text |
| CF002 | CF002 | CF002 | CF002 |
| 37 | 37a | 38 | 38a |
| Any value | Any value | Any value | Any value |
| Any value | Any value | Any value | Any value |
| Any value | Any value | Any value | Any value |
| Assumed | Assumed | Assumed | Assumed |
| negative/negative | negative/negative | negative/negative | negative/negative |
| 1898(+1)G > A | Negative | 1898(+5)G > T | Negative |
| Negative | 1898(+1)G > A | Negative | 1898(+5)G > T |
| N/A | N/A | N/A | N/A |
| CF0037 | CF0037 | CF0038 | CF0038 |
| Carrier screening | Carrier screening | Carrier screening | Carrier screening |
| omit | omit | omit | omit |
| 1898(+1)G > A | 1898(+1)G > A | 1898(+5)G > T | 1898(+5)G > T |
| heterozygote; cystic | heterozygote; cystic | heterozygote; cystic | heterozygote; cystic |
| fibrosis carrier | fibrosis carrier | fibrosis carrier | fibrosis carrier |
| omit | omit | omit | omit |
| recs | recs | recs | recs |
| text | text | text | text |
| CF002 | CF002 | CF002 | CF002 |
| 39 | 39a | 40 | 40a |
| Any value | Any value | Any value | Any value |
| Any value | Any value | Any value | Any value |
| Any value | Any value | Any value | Any value |
| Assumed | Assumed | Assumed | Assumed |
| negative/negative | negative/negative | negative/negative | negative/negative |
| 2183delAA > G | Negative | 2184delA | Negative |
| Negative | 2183delAA > G | Negative | 2184delA |
| N/A | N/A | N/A | N/A |
| CF0039 | CF0039 | CF0040 | CF0040 |
| Carrier screening | Carrier screening | Carrier screening | Carrier screening |
| omit | omit | omit | omit |
| 2183delAA > G | 2183delAA > G | 2184delA heterozygote; | 2184delA heterozygote; |
| heterozygote; cystic | heterozygote; cystic | cystic fibrosis carrier | cystic fibrosis carrier |
| fibrosis carrier | fibrosis carrier | | |
| omit | omit | omit | omit |
| recs | recs | recs | recs |
| text | text | text | text |
| CF002 | CF002 | CF002 | CF002 |
| 41 | 41a | 42 | 42a |
| Any value | Any value | Any value | Any value |
| Any value | Any value | Any value | Any value |
| Any value | Any value | Any value | Any value |
| Assumed | Assumed | Assumed | Assumed |
| negative/negative | negative/negative | negative/negative | negative/negative |
| 2307insA | Negative | 2789(+5)G > A | Negative |
| Negative | 2307insA | Negative | 2789(+5)G > A |
| N/A | N/A | N/A | N/A |
| CF0041 | CF0041 | CF0042 | CF0042 |
| Carrier screening | Carrier screening | Carrier screening | Carrier screening |
| omit | omit | omit | omit |
| 2307insA heterozygote; | 2307insA heterozygote; | 2789(+5)G > A | 2789(+5)G > A |
| cystic fibrosis carrier | cystic fibrosis carrier | heterozygote; cystic | heterozygote; cystic |
| | | fibrosis carrier | fibrosis carrier |
| omit | omit | omit | omit |
| recs | recs | recs | recs |
| text | text | text | text |
| CF002 | CF002 | CF002 | CF002 |
| 43 | 43a | 44 | 44a |
| Any value | Any value | Any value | Any value |
| Any value | Any value | Any value | Any value |
| Any value | Any value | Any value | Any value |
| Assumed | Assumed | Assumed | Assumed |
| negative/negative | negative/negative | negative/negative | negative/negative |
| 3120(+1)G > A | Negative | 3659delC | Negative |
| Negative | 3120(+1)G > A | Negative | 3659delC |
| N/A | N/A | N/A | N/A |
| CF0043 | CF0043 | CF0044 | CF0044 |
| Carrier screening | Carrier screening | Carrier screening | Carrier screening |
| omit | omit | omit | omit |
| 3120(+1)G > A | 3120(+1)G > A | 3659delC heterozygote; | 3659delC heterozygote; |
| heterozygote; cystic | heterozygote; cystic | cystic fibrosis carrier | cystic fibrosis carrier |
| fibrosis carrier | fibrosis carrier | | |
| omit | omit | omit | omit |
| recs | recs | recs | recs |
| text | text | text | text |
| CF002 | CF002 | CF002 | CF002 |
| 45 | 45a | 46 | 46a |
| Any value | Any value | Any value | Any value |
| Any value | Any value | Any value | Any value |
| Any value | Any value | Any value | Any value |
| Assumed | Assumed | Assumed | Assumed |
| negative/negative | negative/negative | negative/negative | negative/negative |
| 3849(+10 kb)C > T | Negative | 3876delA | Negative |
| Negative | 3849(+10 kb)C > T | Negative | 3876delA |
| N/A | N/A | N/A | N/A |
| CF0045 | CF0045 | CF0046 | CF0046 |
| Carrier screening | Carrier screening | Carrier screening | Carrier screening |
| omit | omit | omit | omit |
| 3849(+10 kb)C > T | 3849(+10 kb)C > T | 3876delA heterozygote; | 3876delA heterozygote; |
| heterozygote; cystic | heterozygote; cystic | cystic fibrosis carrier | cystic fibrosis carrier |
| fibrosis carrier | fibrosis carrier | | |
| omit | omit | omit | omit |
| recs | recs | recs | recs |
| text | text | text | text |
| CF002 | CF002 | CF002 | CF002 |
| 47 | 47a | 48 | 48a |
| Any value | Any value | Any value | Any value |
| Any value | Any value | Any value | Any value |
| Any value | Any value | Any value | Any value |
| Assumed | Assumed | Assumed | Assumed |
| negative/negative | negative/negative | negative/negative | negative/negative |
| 3905insC | Negative | R117H | Negative |
| Negative | 3905insC | Negative | R117H |
| N/A | N/A | intron 8-5T/7T | intron 8-5T/7T |
| CF0047 | CF0047 | CF0048 | CF0048 |
| Carrier screening | Carrier screening | Carrier screening | Carrier screening |
| omit | omit | omit | omit |
| 3905insC heterozygote; | 3905insC heterozygote; | Cystic fibrosis carrier; | Cystic fibrosis carrier; |
| cystic fibrosis carrier | cystic fibrosis carrier | R117H heterozygote; | R117H heterozygote; |
| | | intron 8-5T positive | intron 8-5T positive |
| | | 5T/7T, phase unknown | 5T/7T, phase unknown |
| omit | omit | omit | omit |
| recs | recs | recs | recs |
| text | text | text | text |
| CF002 | CF002 | CF002 | CF002 |
| 49 | 49a | 50 | 50a |
| Any value | Any value | Any value | Any value |
| Any value | Any value | Any value | Any value |
| Any value | Any value | Any value | Any value |
| Assumed | Assumed | Assumed | Assumed |
| negative/negative | negative/negative | negative/negative | negative/negative |
| R117H | Negative | R117H | Negative |
| Negative | R117H | Negative | R117H |
| intron 8-5T/9T | intron 8-5T/9T | intron 8-5T/5T | intron 8-5T/5T |
| CF0049 | CF0049 | CF0050 | CF0050 |
| Carrier screening | Carrier screening | Carrier screening | Carrier screening |
| omit | omit | omit | omit |
| Cystic fibrosis carrier; | Cystic fibrosis carrier; | Cystic fibrosis carrier; | Cystic fibrosis carrier; |
| R117H heterozygote; | R117H heterozygote; | R117H heterozygote and | R117H heterozygote and |
| intron 8-5T positive | intron 8-5T positive | intron 8-5T/5T | intron 8-5T/5T |
| 5T/9T, phase unknown | 5T/9T, phase unknown | homozygote | homozygote |
| omit | omit | omit | omit |
| recs | recs | recs | recs |
| text | text | text | text |
| CF002 | CF002 | CF002 | CF002 |
| 51 | 51a | 52 | 52a |
| Any value | Any value | Any value | Any value |
| Any value | Any value | Any value | Any value |
| Any value | Any value | Any value | Any value |
| Assumed | Assumed | Assumed | Assumed |
| negative/negative | negative/negative | negative/negative | negative/negative |
| R117H | Negative | R117H | Negative |
| Negative | R117H | Negative | R117H |
| intron 8-7T/7T | intron 8-7T/7T | intron 8-7T/9T | intron 8-7T/9T |
| CF0051 | CF0051 | CF0052 | CF0052 |
| Carrier screening | Carrier screening | Carrier screening | Carrier screening |
| omit | omit | omit | omit |
| Cystic fibrosis carrier; | Cystic fibrosis carrier; | Cystic fibrosis carrier; | Cystic fibrosis carrier; |
| R117H heterozygote; | R117H heterozygote; | R117H heterozygote; | R117H heterozygote; |
| intron 8-5T negative, | intron 8-5T negative, | intron 8-5T negative, | intron 8-5T negative, |
| 7T/7T | 7T/7T | 7T/9T | 7T/9T |
| omit | omit | omit | omit |
| recs | recs | recs | recs |
| text | text | text | text |
| CF002 | CF002 | CF002 | CF002 |
| 53 | 53a | 54 | 54a |
| Any value | Any value | Any value | Any value |
| Any value | Any value | Any value | Any value |
| Any value | Any value | Any value | Any value |
| Assumed | Assumed | Assumed | Assumed |
| negative/negative | negative/negative | negative/negative | negative/negative |
| R117H | Negative | Delta F508 | Negative |
| Negative | R117H | Negative | Delta F508 |
| intron 8-9T/9T | intron 8-9T/9T | F508C heterozygote | F508C heterozygote |
| CF0053 | CF0053 | CF0054 | CF0054 |
| Carrier screening | Carrier screening | Carrier screening | Carrier screening |
| omit | omit | omit | omit |
| Cystic fibrosis carrier; | Cystic fibrosis carrier; | Delta F508/F508C | Delta F508/F508C |
| R117H heterozygote; | R117H heterozygote; | compound heterozygote; | compound heterozygote; |
| intron 8-5T negative, | intron 8-5T negative, | cystic fibrosis carrier | cystic fibrosis carrier |
| 9T/9T | 9T/9T | | |
| omit | omit | omit | omit |
| recs | recs | recs | recs |
| text | text | text | text |
| CF002 | CF002 | CF002 | CF002 |
| 126 | 126a | 127 | 127a |
| Any value | Any value | Any value | Any value |
| Any value | Any value | Any value | Any value |
| Any value | Any value | Any value | Any value |
| Assumed | Assumed | Assumed | Assumed |
| negative/negative | negative/negative | negative/negative | negative/negative |
| Delta F508 | Negative | Delta F508 | Negative |
| Negative | Delta F508 | Negative | Delta F508 |
| I506V heterozygote | I506V heterozygote | I507V heterozygote | I507V heterozygote |
| CF0126 | CF0126 | CF0127 | CF0127 |
| Carrier screening | Carrier screening | Carrier screening | Carrier screening |
| omit | omit | omit | omit |
| Delta F508/I506V | Delta F508/I506V | Delta F508/I507V | Delta F508/I507V |
| compound heterozygote; | compound heterozygote; | compound heterozygote; | compound |
| cystic fibrosis carrier | cystic fibrosis carrier | cystic fibrosis carrier | heterozygote; cystic |
| | | | fibrosis carrier |
| omit | omit | omit | omit |
| recs | recs | recs | recs |
| text | text | text | text |
| CF002 | CF002 | CF002 | CF002 |

CFITC TABLE 4
APPENDIX
CFITC - Report Codes for Source Data

| Client enter | Source | Blood | Buccal Swab | Mouthwashing | Cord Blood | Unknown |
|---|---|---|---|---|---|---|
| | Ethnicity | Not Solicited | Not Solicited | Not Solicited | Not Solicited | Not Solicited |
| | Personal History | Negative | Negative | Negative | Negative | Negative |
| | Family history | Not Solicited | Not Solicited | Not Solicited | Not Solicited | Not Solicited |
| | Allele 1 | Negative | Negative | Negative | Negative | Negative |
| | Allele 2 | Negative | Negative | Negative | Negative | Negative |
| | Variant | N/A | N/A | N/A | N/A | N/A |
| | Comment | | | | | |
| CODE | | CF0001 | CF0001 | CF0001 | CF0001 | CF0001 |

| Blood | Blood | Blood | Blood | Blood |
|---|---|---|---|---|
| Non-Hispanic | Non-Hispanic | Ashkenazi | Hispanic | African |
| Caucasian | Caucasian | Jewish | American | American |
| Negative | Negative | Negative | Negative | Negative |
| Negative | Assumed | Negative | Negative | Negative |
| | Negative | | | |
| Negative | Negative | Negative | Negative | Negative |
| Negative | Negative | Negative | Negative | Negative |
| N/A | N/A | NIA | N/A | N/A |
| CF0002 | CF0002 | CF0003 | CF0004 | CF0005 |

| Blood | Blood | Blood | Blood | Blood | Blood |
|---|---|---|---|---|---|
| Asian | Complex | Not | Non-Hispanic | Non-Hispanic | Non-Hispanic |
| American | | provided | Caucasian | Caucasian | Caucasian |
| Negative | Negative | Negative | Negative | Negative | Negative |
| Negative | Negative | Negative | Negative | Delta I507 | Positive |
| Negative | Negative | Negative | Delta I507 | Neative | Delta I507 |
| Negative | Negative | Negative | Negative | Negative | Negative |
| N/A | N/A | N/A | N/A | N/A | N/A |
| | Client may | | | | |
| | enter free | | | | |
| | text | | | | |
| CF0006 | CF0007 | CF0008 | CF0009 | CF0009 | CF0009 |

CFIIC TABLE 1
APPENDIX
Cystic Fibrosis Invader Platform, Carrier Test (CFIIC) User Queries and Answers
Values Invader Test Code

| Client enters: | Client enters: | Client enters: | Client enters: | First part of result | Second part | Possible third |
|---|---|---|---|---|---|---|
| Source | Ethnicity | Family History | Personal History | Allele 1 | Allele 2 | Variant |
| Blood | Not solicited | Negative | Negative | Negative | Negative | Not applicable (data masked) |
| Buccal swab | Non-Hispanic | Assumed negative | Assumed negative | Delta I507 | Delta I507 | intron 8-5T/7T |
| | Caucasian | | | | | |
| Mouthwashing | Ashkenazi Jewish | Positive | | Delta F508 | Delta F508 | intron 8-5T/9T |
| Cord blood | Hispanic American | | | A455E | A455E | intron 8-5T/5T |
| Unknown | African American | | | E60X | E60X | intron 8-7T/7T |
| | Asian American | | | G85E | G85E | intron 8-7T/9T |
| | Complex | | | G542X | G542X | intron 8-9T/9T |
| | Not provided | | | G551D | G551D | F508C heterozygote |
| | Unknown? | | | N1303K | N1303K | |
| | | | | Q493X | Q493X | |
| | | | | R334W | R334W | |
| | | | | R347H | R347H | |
| | | | | R347P | R347P | |
| | | | | R553X | R553X | |
| | | | | R560T | R560T | |
| | | | | R1162X | R1162X | |
| | | | | S549N | S549N | |
| | | | | S549R (A > C) | S549R (A > C) | |
| | | | | S549R (T > G) | S549R (T > G) | |
| | | | | V520F | V520F | |
| | | | | W1282X | W1282X | |
| | | | | Y122X | Y122X | |
| | | | | Y1092X (C > A) | Y1092X (C > A) | |
| | | | | Y1092X (C > G | Y1092X (C > G | |
| | | | | 394delTT | 394delTT | |
| | | | | 621(+1)G > T | 621(+1)G > T | |
| | | | | 711(+1)G > T | 711(+1)G > T | |
| | | | | 1078delT | 1078delT | |
| | | | | 1717(−1)G > A | 1717(−1)G > A | |
| | | | | 1898(+1)G > A | 1898(+1)G > A | |
| | | | | 2183delAA > G | 2183delAA > G | |
| | | | | 2184delA | 2184delA | |
| | | | | 2789(+5)G > A | 2789(+5)G > A | |
| | | | | 3120(+1)G > A | 3120(+1)G > A | |
| | | | | 3659delC | 3659delC | |
| | | | | 3849(+4)A > G | 3849(+4)A > G | |
| | | | | 3849(+10 kb)C > T | 3849(+10 kb)C > T | |
| | | | | 3876delA | 3876delA | |
| | | | | 3905insC | 3905insC | |
| | | | | R117H | R117H | |

CFITC TABLE 2
APPENDIX
Cystic Fibrosis Taglt(TM) Platform, Carrier Test (CFITC)
Data and Report Codes

| | | | | 8245 | | | | |
|---|---|---|---|---|---|---|---|---|
| 0 | 8445 | 8045 | 8145 | Personal | 9045 | 9046 | 8345 | 8745 |
| INT | Source | Ethnicity | Family history | History | Allele 1 | Allele 2 | Variant | MC |
| | 1 | Not Solicited | Not Solicited | Negative | Negative | Negative | N/A | CF0001 |
| | 1 | Non-Hispanic Caucasian | Negative | Negative | Negative | Negative | N/A | CF0002 |
| | 1 | Ashkenazi Jewish | Negative | Negative | Negative | Negative | N/A | CF0003 |
| | 1 | Hispanic American | Negative | Negative | Negative | Negative | N/A | CF0004 |
| | 1 | African American | Negative | Negative | Negative | Negative | N/A | CF0005 |
| | 1 | Asian American | Negative | Negative | Negative | Negative | N/A | CF0006 |
| | 1 | Complex | Negative | Negative | Negative | Negative | N/A | CF0007 |
| | 1 | Not provided | Negative | Negative | Negative | Negative | N/A | CF0008 |
| | 2 | | | Negative | Delta I507 | Negative | N/A | CF0009 |
| | 2 | | | Negative | Negative | Delta I507 | N/A | CF0009 |
| | 2 | | | Negative | Delta F508 | Negative | N/A | CF0010 |
| | 2 | | | Negative | Negative | Delta F508 | N/A | CF0010 |
| | 2 | | | Negative | A455E | Negative | N/A | CF0011 |
| | 2 | | | Negative | Negative | A455E | N/A | CF0011 |
| | 2 | | | Negative | A559T | Negative | N/A | CF0012 |
| | 2 | | | Negative | Negative | A559T | N/A | CF0012 |
| | 2 | | | Negative | G85E | Negative | N/A | CF0013 |
| | 2 | | | Negative | Negative | G85E | N/A | CF0013 |
| | 2 | | | Negative | G542X | Negative | N/A | CF0014 |
| | 2 | | | Negative | Negative | G542X | N/A | CF0014 |
| | 2 | | | Negative | G551D | Negative | N/A | CF0015 |
| | 2 | | | Negative | Negative | G551D | N/A | CF0015 |
| | 2 | | | Negative | M1101K | Negative | N/A | CF0016 |
| | 2 | | | Negative | Negative | M1101K | N/A | CF0016 |
| | 2 | | | Negative | N1303K | Negative | N/A | CF0017 |
| | 2 | | | Negative | Negative | N1303K | N/A | CF0017 |
| | 2 | | | Negative | R334W | Negative | N/A | CF0018 |
| | 2 | | | Negative | Negative | R334W | N/A | CF0018 |
| | 2 | | | Negative | R347H | Negative | N/A | CF0019 |
| | 2 | | | Negative | Negative | R347H | N/A | CF0019 |
| | 3 | | | Negative | R347P | Negative | N/A | CF0020 |
| | 3 | | | Negative | Negative | R347P | N/A | CF0020 |
| | 3 | | | Negative | R553X | Negative | N/A | CF0021 |
| | 3 | | | Negative | Negative | R553X | N/A | CF0021 |
| | 3 | | | Negative | R560T | Negative | N/A | CF0022 |
| | 3 | | | Negative | Negative | R560T | N/A | CF0022 |
| | 3 | | | Negative | R1162X | Negative | N/A | CF0023 |
| | 3 | | | Negative | Negative | R1162X | N/A | CF0023 |
| | 3 | | | Negative | S549N | Negative | N/A | CF0024 |
| | 3 | | | Negative | Negative | S549N | N/A | CF0024 |
| | 3 | | | Negative | S549R(T > G) | Negative | N/A | CF0025 |
| | 3 | | | Negative | Negative | S549R(T > G) | N/A | CF0025 |
| | 3 | | | Negative | S1255X | Negative | N/A | CF0026 |
| | 3 | | | Negative | Negative | S1255X | N/A | CF0026 |
| | 3 | | | Negative | V520F | Negative | N/A | CF0027 |
| | 3 | | | Negative | Negative | V520F | N/A | CF0027 |
| | 3 | | | Negative | W1282X | Negative | N/A | CF0028 |
| | 3 | | | Negative | Negative | W1282X | N/A | CF0028 |
| | 3 | | | Negative | Y122X | Negative | N/A | CF0029 |
| | 3 | | | Negative | Negative | Y122X | N/A | CF0029 |
| | 3 | | | Negative | Y1092X(C > A) | Negative | N/A | CF0030 |
| | 3 | | | Negative | Negative | Y1092X(C > A) | N/A | CF0030 |
| | 4 | | | Negative | Y1092X(C > G) | Negative | N/A | CF0031 |
| | 4 | | | Negative | Negative | Y1092X(C > G) | N/A | CF0031 |
| | 4 | | | Negative | 394delTT | Negative | N/A | CF0032 |
| | 4 | | | Negative | Negative | 394delTT | N/A | CF0032 |
| | 4 | | | Negative | 621(+1)G > T | Negative | N/A | CF0033 |
| | 4 | | | Negative | Negative | 621(+1)G > T | N/A | CF0033 |
| | 4 | | | Negative | 711(+1)G > T | Negative | N/A | CF0034 |
| | 4 | | | Negative | Negative | 711(+1)G > T | N/A | CF0034 |
| | 4 | | | Negative | 1078delT | Negative | N/A | CF0035 |
| | 4 | | | Negative | Negative | 1078delT | N/A | CF0035 |
| | 4 | | | Negative | 1717(−1)G > A | Negative | N/A | CF0036 |
| | 4 | | | Negative | Negative | 1717(−1)G > A | N/A | CF0036 |
| | 4 | | | Negative | 1898(+1)G > A | Negative | N/A | CF0037 |
| | 4 | | | Negative | Negative | 1898(+1)G > A | N/A | CF0037 |
| | 4 | | | Negative | 1898(+5)G > T | Negative | N/A | CF0038 |
| | 4 | | | Negative | Negative | 1898(+5)G > T | N/A | CF0038 |
| | 4 | | | Negative | 2183delAA > G | Negative | N/A | CF0039 |
| | 4 | | | Negative | Negative | 2183delAA > G | N/A | CF0039 |
| | 4 | | | Negative | 2184delA | Negative | N/A | CF0040 |
| | 4 | | | Negative | Negative | 2184delA | N/A | CF0040 |
| | 4 | | | Negative | 2307insA | Negative | N/A | CF0041 |
| | 4 | | | Negative | Negative | 2307insA | N/A | CF0041 |
| | 5 | | | Negative | 2789(+5)G > A | Negative | N/A | CF0042 |
| | 5 | | | Negative | Negative | 2789(+5)G > A | N/A | CF0042 |
| | 5 | | | Negative | 3120(+1)G > A | Negative | N/A | CF0043 |
| | 5 | | | Negative | Negative | 3120(+1)G > A | N/A | CF0043 |
| | 5 | | | Negative | 3659delC | Negative | N/A | CF0044 |
| | 5 | | | Negative | Negative | 3659delC | N/A | CF0044 |
| | 5 | | | Negative | 3849(+10 kb)C > T | Negative | N/A | CF0045 |
| | 5 | | | Negative | Negative | 3849(+10 kb)C > T | N/A | CF0045 |
| | 5 | | | Negative | 3876delA | Negative | N/A | CF0046 |
| | 5 | | | Negative | Negative | 3876delA | N/A | CF0046 |
| | 5 | | | Negative | 3905insC | Negative | N/A | CF0047 |
| | 5 | | | Negative | Negative | 3905insC | N/A | CF0047 |
| | 5 | | | Negative | R117H | Negative | intron 8-5T/7T | CF0048 |
| | 5 | | | Negative | Negative | R117H | intron 8-5T/7T | CF0048 |
| | 5 | | | Negative | R117H | Negative | intron 8-5T/9T | CF0049 |
| | 5 | | | Negative | Negative | R117H | intron 8-5T/9T | CF0049 |
| | 5 | | | Negative | R117H | Negative | intron 8-5T/5T | CF0050 |
| | 5 | | | Negative | Negative | R117H | intron 8-5T/5T | CF0050 |
| | 5 | | | Negative | R117H | Negative | intron 8-7T/7T | CF0051 |
| | 5 | | | Negative | Negative | R117H | intron 8-7T/7T | CF0051 |
| | 5 | | | Negative | R117H | Negative | intron 8-7T/9T | CF0052 |
| | 5 | | | Negative | Negative | R117H | intron 8-7T/9T | CF0052 |
| | 6 | | | Negative | R117H | Negative | intron 8-9T/9T | CF0053 |
| | 6 | | | Negative | Negative | R117H | intron 8-9T/9T | CF0053 |
| | 6 | | | Negative | Delta F508 | Negative | F508C | CF0054 |
| | | | | | | | heterozygote | |
| | 6 | | | Negative | Negative | Delta F508 | F508C | CF0054 |
| | | | | | | | heterozygote | |
| | 6 | | | Negative | Delta F508 | Negative | I506V | CF0126 |
| | | | | | | | heterozygote | |
| | 6 | | | Negative | Negative | Delta F508 | I506V | CF0126 |
| | | | | | | | heterozygote | |
| | 6 | | | Negative | Delta F508 | Negative | I507V | CF0127 |
| | | | | | | | heterozygote | |
| | 6 | | | Negative | Negative | Delta F508 | I507V | CF0127 |
| | | | | | | | heterozygote | |

**EOF**

CFITC TABLE 1
APPENDIX
Cystic Fibrosis TagltPlatform, Carrier Test (CFITC) User Queries and Answers
Values: Taglt Carrier Test Code
Report Codes

| Routine: CF0001-0054 | Client enters: | Client enters: | Client enters: | Client enters: |
|---|---|---|---|---|
| Manual: See separate | Source | Ethnicity | Family History | Personal History |
| document | Blood | Non-Hispanic Caucasian | Negative | Negative |
| | Buccal swab | Ashkenazi Jewish | Assumed negative | Assumed negative |
| | Mouthwashing | Hispanic American | Positive | |
| | Cord blood | African American | | |
| | Unknown | Asian American | | |
| | | Complex | | |
| | | Not provided | | |
| | | Unknown | | |
| | | Not solicited | | |

| Client enters: | Client enters: | Client enters: | |
|---|---|---|---|
| First part of result | Second part of result | Third part of result | |
| Allele 1 | Allele 2 | Variant | Comment |
| Negative | Negative | N/A | Client enters, as necessary, |
| Delta I507 | Delta I507 | intron 8-5T/7T | usually to note details of |
| Delta F508 | Delta F508 | intron 8-5T/9T | positive family history |
| A455E | A455E | intron 8-5T/5T | |
| A559T | A559T | intron 8-7T/7T | |
| G85E | G85E | intron 8-7T/9T | |
| G542X | G542X | intron 8-9T/9T | |
| G551D | G551D | F508C heterozygote | |
| M1101K | M1101K | I506V heterozygote | |
| N1303K | N1303K | I507V heterozygote | |
| R334W | R334W | Negative for benign exon | |
| R347H | R347H | 10 variants tested | |
| R347P | R347P | | |
| R553X | R553X | | |
| R560T | R560T | | |
| R1162X | R1162X | | |
| S549N | S549N | | |
| S549R(T > G) | S549R(T > G) | | |
| S1255X | S1255X | | |
| V520F | V520F | | |
| W1282X | W1282X | | |
| Y122X | Y122X | | |
| Y1092X (C > A) | Y1092X (C > A) | | |
| Y1092X (T > G) | Y1092X (T > G) | | |
| 394delTT | 394delTT | | |
| 621(+1)G > T | 621(+1)G > T | | |
| 711(+1)G > T | 711(+1)G > T | | |
| 1078delT | 1078delT | | |
| 1717(−1)G > A | 1717(−1)G > A | | |
| 1898(+1)G > A | 1898(+1)G > A | | |
| 1898(+5)G > T | 1898(+5)G > T | | |
| 2183delAA > G | 2183delAA > G | | |
| 2184delA | 2184delA | | |
| 2307insA | 2307insA | | |
| 2789(+5)G > A | 2789(+5)G > A | | |
| 3120(+1)G > A | 3120(+1)G > A | | |
| 3659delC | 3659delC | | |
| 3849(+10 kb)C > T | 3849(+10 kb)C > T | | |
| 3876delA | 3876delA | | |
| 3905insC | 3905insC | | |
| R117H | R117H | | |

TABLE
Appendix
Interpretive Reporting Master List
INTERPRETIVE REPORTING MASTER LIST
KEY - CFIIC-1
INTERPRETATION

| WORKLIST | TEST CODE | FLAG | EVALUATION |
|---|---|---|---|
| CFIIC | 8045-ETHNICITY | A | R EQ African American |
| | | B | R EQ Ashkenazi Jewish |
| | | C | R EQ Asian American |
| | | D | R EQ Complex |
| | | E | R EQ Hispanic American |
| | | F | R EQ Non-Hispanic |
| | | | Caucasian |
| | | G | R EQ Not Solicited |
| | | H | R EQ Not provided |
| CFIIC | 8145-FAMHIS | A | R EQ Negative |
| | | B | R EQ Not Solicited |
| CFIIC | 8245-PERHIST | A | R CON Negative |
| CFIIC | 9045-ALLELE1 | A | R EQ Negative |
| CFIIC | 9046-ALLELE2 | A | R EQ Negative |
| CFIIC | 8345-VARIANT | A | R EQ N/A |

ADD TO WORKLIST: CFIIC TEST CODE: 8745-INTERP
IF ORDERED:

| FLAG CONFIGURATION | ADD |
|---|---|
| AAAAAA | #CF0005 |
| BAAAAA | #CF0003 |
| CAAAAA | #CF0006 |
| DAAAAA | #CF0007 |
| EAAAAA | #CF0004 |
| FAAAAA | #CF0002 |
| GBAAAA | #CF0001 |
| HAAAAA | #CF0008 |

KEY - CFIIC-3
INTERPRETATION

| WORKLIST | TEST CODE | FLAG | EVALUATION |
|---|---|---|---|
| CFIIC | 8245-PERHIST | A | R CON Negative |
| CFIIC | 9045-ALLELE1 | A | R EQ A455E |
| | | B | R EQ Delta F508 |
| | | C | R EQ Delta I507 |
| | | D | R EQ E60X |
| | | E | R EQ G542X |
| | | F | R EQ G551D |
| | | G | R EQ G85E |
| | | H | R EQ N1303K |
| | | I | R EQ Negative |
| | | J | R EQ Q493X |
| | | K | R EQ R334W |
| | | L | R EQ R347H |
| CFIIC | 9046-ALLELE2 | A | R EQ A455E |
| | | B | R EQ Delta F508 |
| | | C | R EQ Delta I507 |
| | | D | R EQ E60X |
| | | E | R EQ G542X |
| | | F | R EQ G551D |
| | | G | R EQ G85E |
| | | H | R EQ N1303K |
| | | I | R EQ Negative |
| | | J | R EQ Q493X |
| | | K | R EQ R334W |
| | | L | R EQ R347H |
| CFIIC | 8345-VARIANT | A | R EQ N/A |

ADD TO WORKLIST: CFIIC TEST CODE: 8745-INTERP
IF ORDERED:

| FLAG CONFIGURATION | ADD |
|---|---|
| AAIA | #CF0011 |
| ABIA | #CF0010 |
| ACIA | #CF0009 |
| ADIA | #CF0105 |
| AEIA | #CF0014 |
| AFIA | #CF0015 |
| AGIA | #CF0013 |
| AHIA | #CF0017 |
| AIAA | #CF0011 |
| AIBA | #CF0010 |
| AICA | #CF0009 |
| AIDA | #CF0105 |
| AIEA | #CF0014 |
| AIFA | #CF0015 |
| AIGA | #CF0013 |
| AIHA | #CF0017 |
| AIJA | #CF0106 |
| AIKA | #CF0019 |
| AILA | #CF0019 |

KEY - CFIIC-2
INTERPRETATION

| FLAG CONFIGURATION | ADD |
|---|---|
| AJIA | #CF0106 |
| AKIA | #CF0019 |
| ALIA | #CF0019 |

KEY - CFIIC-3
INTERPRETATION

| WORKLIST | TEST CODE | FLAG | EVALUATION |
|---|---|---|---|
| CFIIC | 8245-PERHIST | A | R CON Negative |
| CFIIC | 9045-ALLELE1 | A | R EQ Negative |
| | | B | R EQ R1162X |
| | | C | R EQ R347P |
| | | D | R EQ R553X |
| | | E | R EQ R560T |
| | | F | R EQ S549N |
| | | G | R EQ S549R(A > C) |
| | | H | R EQ S549R(T > G) |
| | | I | R EQ V520F |
| | | J | R EQ W1282X |
| | | K | R EQ Y1092X(C > A) |
| | | L | R EQ Y122X |
| CFIIC | 9046-ALLELE2 | A | R EQ Negative |
| | | B | R EQ R1162X |
| | | C | R EQ R347P |
| | | D | R EQ R553X |
| | | E | R EQ R560T |
| | | F | R EQ S549N |
| | | G | R EQ S549R(A > C) |
| | | H | R EQ S549R(T > G) |
| | | I | R EQ V520F |
| | | J | R EQ W1282X |
| | | K | R EQ Y1092X(C > A) |
| | | L | R EQ Y122X |
| CFIIC | 8345-VARIANT | A | R EQ N/A |

ADD TO WORKLIST: CFIIC TEST CODE: 8745-INTERP
IF ORDERED:

| FLAG CONFIGURATION | ADD |
|---|---|
| AABA | #CF0023 |
| AACA | #CF0020 |
| AADA | #CF0021 |
| AAEA | #CF0022 |
| AAFA | #CF0024 |
| AAGA | #CF0107 |
| AAHA | #CF0025 |
| AAIA | #CF0027 |
| AAJA | #CF0028 |
| AAKA | #CF0030 |
| AALA | #CF0029 |
| ABAA | #CF0023 |
| ACAA | #CF0020 |
| ADAA | #CF0021 |
| AEAA | #CF0022 |
| AFAA | #CF0024 |
| AGAA | #CF0107 |
| AHAA | #CF0025 |
| AIAA | #CF0027 |
| AJAA | #CF0028 |
| AKAA | #CF0030 |
| ALAA | #CF0029 |

KEY - CFIIC-4
INTERPRETATION

| WORKLIST | TEST CODE | FLAG | EVALUATION |
|---|---|---|---|
| CFIIC | 8245-PERHIST | A | R CON Negative |
| CFIIC | 9045-ALLELE1 | A | R EQ 1078delT |
| | | B | R EQ 1717(−1)G > A |
| | | C | R EQ 1898(+1)G > A |
| | | D | R EQ 2183delAA > G |
| | | E | R EQ 2184delA |
| | | F | R EQ 2789(+5)G > A |
| | | G | R EQ 3120(+1)G > A |
| | | H | R EQ 394delTT |
| | | I | R EQ 621(+1)G > T |
| | | J | R EQ 711(+1)G > T |
| | | K | R EQ Negative |
| | | L | R EQ Y1092X(C > G) |
| CFIIC | 9046-ALLELE2 | A | R EQ 1078delT |
| | | B | R EQ 1717(−1)G > A |
| | | C | R EQ 1898(+1)G > A |
| | | D | R EQ 2183delAA > G |
| | | E | R EQ 2184delA |
| | | F | R EQ 2789(+5)G > A |
| | | G | R EQ 3120(+1)G > A |
| | | H | R EQ 394delTT |
| | | I | R EQ 621(+1)G > T |
| | | J | R EQ 711(+1)G > T |
| | | K | R EQ Negative |
| | | L | R EQ Y1092X(C > G) |
| CFIIC | 8345-VARIANT | A | R EQ N/A |

ADD TO WORKLIST: CFIIC TEST CODE: 8745-INTERP
IF ORDERED:

| FLAG CONFIGURATION | ADD |
|---|---|
| AAKA | #CF0035 |
| ABKA | #CF0036 |
| ACKA | #CF0037 |
| ADKA | #CF0039 |
| AEKA | #CF0040 |
| AFKA | #CF0042 |
| AGKA | #CF0043 |
| AHKA | #CF0032 |
| AIKA | #CF0033 |
| AJKA | #CF0034 |
| AKAA | #CF0035 |
| AKBA | #CF0036 |
| AKCA | #CF0037 |
| AKDA | #CF0039 |
| AKEA | #CF0040 |
| AKFA | #CF0042 |
| AKGA | #CF0043 |
| AKHA | #CF0032 |
| AKIA | #CF0033 |

KEY - CFIIC-4
EFFECTIVE DATE - Sep. 19, 2005
INTERPRETATION

| FLAG CONFIGURATION | ADD |
|---|---|
| AKJA | #CF0034 |
| AKLA | #CF0031 |
| ALKA | #CF0031 |

KEY - CFIIC-5
INTERPRETATION

| WORKLIST | TEST CODE | FLAG | EVALUATION |
|---|---|---|---|
| CFIIC | 8245-PERHIST | A | R CON Negative |
| CFIIC | 9045-ALLELE1 | A | R EQ 3659delC |
| | | B | R EQ 3849(+10 kb)C > T |
| | | C | R EQ 3849(+4)A > G |
| | | D | R EQ 3876delA |
| | | E | R EQ 3905insC |
| | | F | R EQ Negative |
| | | G | R EQ R117H |
| CFIIC | 9046-ALLELE2 | A | R EQ 3659delC |
| | | B | R EQ 3849(+10 kb)C > T |
| | | C | R EQ 3849(+4)A > G |
| | | D | R EQ 3876delA |
| | | E | R EQ 3905insC |
| | | F | R EQ Negative |
| | | G | R EQ R117H |
| CFIIC | 8345-VARIANT | A | R EQ N/A |
| | | B | R EQ intron 8-5T/5T |
| | | C | R EQ intron 8-5T/7T |
| | | D | R EQ intron 8-5T/9T |
| | | E | R EQ intron 8-7T/7T |
| | | F | R EQ intron 8-7T/9T |
| | | G | R EQ intron 8-9T/9T |

ADD TO WORKLIST: CFIIC TEST CODE: 8745-INTERP
IF ORDERED:

| FLAG CONFIGURATION | ADD |
|---|---|
| AAFA | #CF0044 |
| ABFA | #CF0045 |
| ACFA | #CF0108 |
| ADFA | #CF0046 |
| AEFA | #CF0047 |
| AFAA | #CF0044 |
| AFBA | #CF0045 |
| AFCA | #CF0108 |
| AFDA | #CF0046 |
| AFEA | #CF0047 |
| AFGB | #CF0050 |
| AFGC | #CF0048 |
| AFGD | #CF0049 |
| AFGE | #CF0051 |
| AFGF | #CF0052 |
| AFGG | #CF0053 |
| AGFB | #CF0050 |
| AGFC | #CF0048 |
| AGFD | #CF0049 |
| AGFE | #CF0051 |
| AGFF | #CF0052 |
| AGFG | #CF0053 |

KEY - CFIIC-6
INTERPRETATION

| WORKLIST | TEST CODE | FLAG | EVALUATION |
|---|---|---|---|
| CFIIC | 8245-PERHIST | A | R CON Negative |
| CFIIC | 9045-ALLELE1 | A | R EQ Delta F508 |
| | | B | R EQ Negative |
| CFIIC | 9046-ALLELE2 | A | R EQ Delta F508 |
| | | B | R EQ Negative |
| CFIIC | 8345-VARIANT | A | R EQ F508C |

ADD TO WORKLIST: CFIIC TEST CODE: 8745-INTERP
IF ORDERED:

| FLAG CONFIGURATION | ADD |
|---|---|
| AABA | #CF0054 |
| ABAA | #CF0054 |

KEY - CFIID-1
INTERPRETATION

| WORKLIST | TEST CODE | FLAG | EVALUATION |
|---|---|---|---|
| CFIID | 88245-PERHIST | A | R CON Positive |
| CFIID | 9045-ALLELE1 | A | R EQ A455E |
| | | B | R EQ Delta F508 |
| | | C | R EQ Delta I507 |
| | | D | R EQ E60X |
| | | E | R EQ G542X |
| | | F | R EQ G551D |
| | | G | R EQ G85E |
| | | H | R EQ N1303K |
| | | I | R EQ Negative |
| | | J | R EQ Q493X |
| | | K | R EQ R334W |
| CFIID | 9046-ALLELE2 | A | R EQ A455E |
| | | B | R EQ Delta F508 |
| | | C | R EQ Delta I507 |
| | | D | R EQ E60X |
| | | E | R EQ G542X |
| | | F | R EQ G551D |
| | | G | R EQ G85E |
| | | H | R EQ N1303K |
| | | I | R EQ Negative |
| | | J | R EQ Q493X |
| CFIID | 8345-VARIANT | A | R EQ N/A |

ADD TO WORKLIST: CFIID TEST CODE: 8745-INTERP
IF ORDERED:

| FLAG CONFIGURATION | ADD |
|---|---|
| AAIA | #CF0058 |
| ABIA | #CF0057 |
| ACIA | #CF0056 |
| ADIA | #CF0121 |
| AEIA | #CF0061 |
| AFIA | #CF0062 |
| AGIA | #CF0060 |
| AHIA | #CF0064 |
| AIAA | #CF0058 |
| AIBA | #CF0057 |
| AICA | #CF0056 |
| AIDA | #CF0121 |
| AIEA | #CF0061 |
| AIFA | #CF0062 |
| AIGA | #CF0060 |
| AIHA | #CF0064 |
| AIIA | #CF0055 |
| AIJA | #CF0122 |
| AJIA | #CF0122 |
| AKIA | #CF0065 |

KEY - CFIID-2
INTERPRETATION

| WORKLIST | TEST CODE | FLAG | EVALUATION |
|---|---|---|---|
| CFIID | 88245-PERHIST | A | R CON Positive |
| CFIID | 9045-ALLELE1 | A | R EQ Negative |
| | | B | R EQ R1162X |
| | | C | R EQ R347H |
| | | D | R EQ R347P |
| | | E | R EQ R553X |
| | | F | R EQ R560T |
| | | G | R EQ S1255X |
| | | H | R EQ S549N |
| | | I | R EQ S549R(A > C) |
| | | J | R EQ S549R(T > G) |
| | | K | R EQ V520F |
| | | L | R EQ W1282X |
| CFIID | 9046-ALLELE2 | A | R EQ Negative |
| | | B | R EQ R1162X |
| | | C | R EQ R334W |
| | | D | R EQ R347H |
| | | E | R EQ R347P |
| | | F | R EQ R553X |
| | | G | R EQ R560T |
| | | H | R EQ S1255X |
| | | I | R EQ S549N |
| | | J | R EQ S549R(A > C) |
| | | K | R EQ S549R(T > G) |
| | | L | R EQ V520F |
| CFIID | 8345-VARIANT | A | R EQ N/A |

ADD TO WORKLIST: CFIID TEST CODE: 8745-INTERP
IF ORDERED:

| FLAG CONFIGURATION | ADD |
|---|---|
| AABA | #CF0070 |
| AACA | #CF0065 |
| AADA | #CF0066 |
| AAEA | #CF0067 |
| AAFA | #CF0068 |
| AAGA | #CF0069 |
| AAHA | #CF0073 |
| AAIA | #CF0071 |
| AAJA | #CF0123 |
| AAKA | #CF0072 |
| AALA | #CF0074 |
| ABAA | #CF0070 |
| ACAA | #CF0066 |
| ADAA | #CF0067 |
| AEAA | #CF0068 |
| AFAA | #CF0069 |
| AGAA | #CF0073 |
| AHAA | #CF0071 |
| AIAA | #CF0123 |
| IAJAA | #CF0072 |
| AKAA | #CF0074 |
| ALAA | #CF0075 |

IKEY - CFIID-3
INTERPRETATION

| WORKLIST | TEST CODE | FLAG | EVALUATION |
|---|---|---|---|
| CFIID | 88245-PERHIST | A | R CON Positive |
| CFIID | 9045-ALLELE1 | A | R EQ 1078delT |
| | | B | R EQ 1717(−1)G > A |
| | | C | R EQ 1898(+1)G > A |
| | | D | R EQ 1898(+5)G > T |
| | | E | R EQ 2183delAA > G |
| | | F | R EQ 394delTT |
| | | G | R EQ 621(+1)G > T |
| | | H | R EQ 711(+1)G > T |
| | | I | R EQ Negative |
| | | J | R EQ Y1092X(C > A) |
| | | K | R EQ Y1092X(C > G) |
| | | L | R EQ Y122X |
| CFIID | 9046-ALLELE2 | A | R EQ 1078delT |
| | | B | R EQ 1717(−1)G > A |
| | | C | R EQ 1898(+1)G > A |
| | | D | R EQ 1898(+5)G > T |
| | | E | R EQ 394delTT |
| | | F | R EQ 621(+1)G > T |
| | | G | R EQ 711(+1)G > T |
| | | H | R EQ Negative |
| | | I | R EQ W1282X |
| | | J | R EQ Y1092X(C > A) |
| | | K | R EQ Y1092X(C > G) |
| | | L | R EQ Y122X |
| CFIID | 8345-VARIANT | A | R EQ N/A |

ADD TO WORKLIST: CFIID TEST CODE: 8745-INTERP
IF ORDERED:

| FLAG CONFIGURATION | ADD |
|---|---|
| AAHA | #CF0082 |
| ABHA | #CF0083 |
| ACHA | #CF0084 |
| ADHA | #CF0085 |
| AEHA | #CF0086 |
| AFHA | #CF0079 |
| AGHA | #CF0080 |
| AHHA | #CF0081 |
| AIAA | #CF0082 |
| AIBA | #CF0083 |
| AICA | #CF0084 |
| AIDA | #CF0085 |
| AIEA | #CF0079 |
| AIFA | #CF0080 |
| AIGA | #CF0081 |
| AIIA | #CF0075 |
| AIJA | #CF0077 |
| AIKA | #CF0078 |
| AILA | #CF0076 |
| AJHA | #CF0077 |
| AKHA | #CF0078 |
| ALHA | #CF0076 |

KEY - CFIID-4
INTERPRETATION

| WORKLIST | TEST CODE | FLAG | EVALUATION |
|---|---|---|---|
| CFIID | 88245-PERHIST | A | R CON Positive |
| CFIID | 9045-ALLELE1 | A | R EQ 2184delA |
| | | B | R EQ 2307insA |
| | | C | R EQ 2789(+5)G > A |
| | | D | R EQ 3120(+1)G > A |
| | | E | R EQ 3659delC |
| | | F | R EQ 3849(+10 kb)C > T |
| | | G | R EQ 3849(+4)A > G |
| | | H | R EQ 3876delA |
| | | I | R EQ 3905insC |
| | | J | R EQ Negative |
| | | K | R EQ R117H |
| CFIID | 9046-ALLELE2 | A | R EQ 2183delAA > G |
| | | B | R EQ 2184delA |
| | | C | R EQ 2307insA |
| | | D | R EQ 2789(+5)G > A |
| | | E | R EQ 3120(+1)G > A |
| | | F | R EQ 3659delC |
| | | G | R EQ 3849(+10 kb)C > T |
| | | H | R EQ 3849(+4)A > G |
| | | I | R EQ 3876delA |
| | | J | R EQ 3905insC |
| | | K | R EQ Negative |
| | | L | R EQ R117H |
| CFIID | 8345-VARIANT | A | R EQ 5T/7T |
| | | B | R EQ 5T/9T |
| | | C | R EQ N/A |

ADD TO WORKLIST: CFIID TEST CODE: 8745-INTERP
IF ORDERED:

| FLAG CONFIGURATION | ADD |
|---|---|
| AAKC | #CF0087 |
| ABKC | #CF0088 |
| ACKC | #CF0089 |
| ADKC | #CF0090 |
| AEKC | #CF0091 |
| AFKC | #CF0092 |
| AGKC | #CF0124 |
| AHKC | #CF0093 |
| AIKC | #CF0094 |
| AJAC | #CF0086 |
| AJBC | #CF0087 |
| AJCC | #CF0088 |
| AJDC | #CF0089 |
| AJEC | #CF0090 |
| AJFC | #CF0091 |
| AJGC | #CF0092 |
| AJHC | #CF0124 |
| AJIC | #CF0093 |
| AJJC | #CF0094 |
| AJLA | #CF0095 |
| AKKA | #CF0095 |
| AKKB | #CF0096 |

KEY - CFIID-5
INTERPRETATION

| WORKLIST | TEST CODE | FLAG | EVALUATION |
|---|---|---|---|
| CFIID | 88245-PERHIST | A | R CON Positive |
| CFIID | 9045-ALLELE1 | A | R EQ Delta F508 |
| | | B | R EQ Negative |
| | | C | R EQ R117H |
| CFIID | 9046-ALLELE2 | A | R EQ Delta F508 |
| | | B | R EQ Negative |
| | | C | R EQ R117H |
| CFIID | 8345-VARIANT | A | R EQ 5T/5T |
| | | B | R EQ 5T/9T |
| | | C | R EQ 7T/7T |
| | | D | R EQ 7T/9T |
| | | E | R EQ 9T/9T |
| | | F | R EQ F508C |
| | | G | R EQ N/A |

ADD TO WORKLIST: CFIID TEST CODE: 8745-INTERP
IF ORDERED:

| FLAG CONFIGURATION | ADD |
|---|---|
| AAAG | #CF0101 |
| AABF | #CF0102 |
| ABAF | #CF0102 |
| ABCA | #CF0097 |
| ABCB | #CF0096 |
| ABCC | #CF0098 |
| ABCD | #CF0099 |
| ABCE | #CF0100 |
| ACBA | #CF0097 |
| ACBC | #CF0098 |
| ACBD | #CF0099 |
| ACBE | #CF0100 |

KEY - CFITC-1
INTERPRETATION

| WORKLIST | TEST CODE | FLAG | EVALUATION |
|---|---|---|---|
| CFITC | 8045-ETHNICITY | A | R EQ African American |
| | | B | R EQ Ashkenazi Jewish |
| | | C | R EQ Asian American |
| | | D | R EQ Complex |
| | | E | R EQ Hispanic American |
| | | F | R EQ Non-Hispanic |
| | | | Caucasian |
| | | G | R EQ Not Solicited |
| | | H | R EQ Not provided |
| CFITC | 8145-FAMHIS | A | R EQ Negative |
| | | B | R EQ Not Solicited |
| CFITC | 8245-PERHIST | A | R CON Negative |
| CFITC | 9045-ALLELE1 | A | R EQ Negative |
| CFITC | 9046-ALLELE2 | A | R EQ Negative |
| CFITC | 8345-VARIANT | A | R EQ N/A |

ADD TO WORKLIST: CFITC TEST CODE: 8745-INTERP
IF ORDERED:

| FLAG CONFIGURATION | ADD |
|---|---|
| AAAAAA | #CF0005 |
| BAAAAA | #CF0003 |
| CAAAAA | #CF0006 |
| DAAAAA | #CF0007 |
| EAAAAA | #CF0004 |
| FAAAAA | #CF0002 |
| GBAAAA | #CF0001 |
| HAAAAA | #CF0008 |

KEY - CFITC-2
INTERPRETATION

| WORKLIST | TEST CODE | FLAG | EVALUATION |
|---|---|---|---|
| CFITC | 8245-PERHIST | A | R CON Negative |
| CFITC | 9045-ALLELE1 | A | R EQ A455E |
| | | B | R EQ A559T |
| | | C | R EQ Delta F508 |
| | | D | R EQ Delta I507 |
| | | E | R EQ G542X |
| | | F | R EQ G551D |
| | | G | R EQ G85E |
| | | H | R EQ M1101K |
| | | I | R EQ N1303K |
| | | J | R EQ Negative |
| | | K | R EQ R334W |
| | | L | R EQ R347H |
| CFITC | 9046-ALLELE2 | A | R EQ A455E |
| | | B | R EQ A559T |
| | | C | R EQ Delta F508 |
| | | D | R EQ Delta I507 |
| | | E | R EQ G542X |
| | | F | R EQ G551D |
| | | G | R EQ G85E |
| | | H | R EQ M1101K |
| | | I | R EQ N1303K |
| | | J | R EQ Negative |
| | | K | R EQ R334W |
| | | L | R EQ R347H |
| CFITC | 8345-VARIANT | A | R EQ N/A |

ADD TO WORKLIST: CFITC TEST CODE: 8745-INTERP
IF ORDERED:

| FLAG CONFIGURATION | ADD |
|---|---|
| AAJA | #CF0011 |
| ABJA | #CF0012 |
| ACJA | #CF0010 |
| ADJA | #CF0009 |
| AEJA | #CF0014 |
| AFJA | #CF0015 |
| AGJA | #CF0013 |
| AHJA | #CF0016 |
| AIJA | #CF0017 |
| AJAA | #CF0011 |
| AJBA | #CF0012 |
| AJCA | #CF0010 |
| AJDA | #CF0009 |
| AJEA | #CF0014 |
| AJFA | #CF0015 |
| AJGA | #CF0013 |
| AJHA | #CF0016 |
| AJIA | #CF0017 |
| AJKA | #CF0018 |
| AJLA | #CF0019 |
| AKJA | #CF0018 |
| ALJA | #CF0019 |

KEY - CFITC-3
INTERPRETATION

| WORKLIST | TEST CODE | FLAG | EVALUATION |
|---|---|---|---|
| CFITC | 8245-PERHIST | A | R CON Negative |
| CFITC | 9045-ALLELE1 | A | R EQ Negative |
| | | B | R EQ R1162X |
| | | C | R EQ R347P |
| | | D | R EQ R553X |
| | | E | R EQ R560T |
| | | F | R EQ S1255X |
| | | G | R EQ S549N |
| | | H | R EQ S549R(T > G) |
| | | I | R EQ V520F |
| | | J | R EQ W1282X |
| | | K | R EQ Y1092X(C > A) |
| | | L | R EQ Y122X |
| CFITC | 9046-ALLELE2 | A | R EQ Negative |
| | | B | R EQ R1162X |
| | | C | R EQ R347P |
| | | D | R EQ R553X |
| | | E | R EQ R560T |
| | | F | R EQ S1255X |
| | | G | R EQ S549N |
| | | H | R EQ S549R(T > G) |
| | | I | R EQ V520F |
| | | J | R EQ W1282X |
| | | K | R EQ Y1092X(C > A) |
| | | L | R EQ Y122X |
| CFITC | 8345-VARIANT | A | R EQ N/A |

ADD TO WORKLIST: CFITC TEST CODE: 8745-INTERP
IF ORDERED:

| FLAG CONFIGURATION | ADD |
|---|---|
| AABA | #CF0023 |
| AACA | #CF0020 |
| AADA | #CF0021 |
| AAEA | #CF0022 |
| AAFA | #CF0026 |
| AAGA | #CF0024 |
| AAHA | #CF0025 |
| AAIA | #CF0027 |
| AAJA | #CF0028 |
| AAKA | #CF0030 |
| AALA | #CF0029 |
| ABAA | #CF0023 |
| ACAA | #CF0020 |
| ADAA | #CF0021 |
| AEAA | #CF0022 |
| AFAA | #CF0026 |
| AGAA | #CF0024 |
| AHAA | #CF0025 |
| AIAA | #CF0027 |
| AJAA | #CF0028 |
| AKAA | #CF0030 |
| ALAA | #CF0029 |

KEY - CFITC-4
INTERPRETATION

| WORKLIST | TEST CODE | FLAG | EVALUATION |
|---|---|---|---|
| CFITC | 8245-PERHIST | A | R CON Negative |
| CFITC | 9045-ALLELE1 | A | R EQ 1078delT |
| | | B | R EQ 1717(−1)G > A |
| | | C | R EQ 1898(+1)G > A |
| | | D | R EQ 1898(+5)G > T |
| | | E | R EQ 2183delAA > G |
| | | F | R EQ 2184delA |
| | | G | R EQ 2307insA |
| | | H | R EQ 394delTT |
| | | I | R EQ 621(+1)G > T |
| | | J | R EQ 711(+1)G > T |
| | | K | R EQ Negative |
| | | L | R EQ Y1092X(C > G) |
| CFITC | 9046-ALLELE2 | A | R EQ 1078delT |
| | | B | R EQ 1717(−1)G > A |
| | | C | R EQ 1898(+1)G > A |
| | | D | R EQ 1898(+5)G > T |
| | | E | R EQ 2183delAA > G |
| | | F | R EQ 2184delA |
| | | G | R EQ 2307insA |
| | | H | R EQ 394delTT |
| | | I | R EQ 621(+1)G > T |
| | | J | R EQ 711(+1)G > T |
| | | K | R EQ Negative |
| | | L | R EQ Y1092X(C > G) |
| CFITC | 8345-VARIANT | A | R EQ N/A |

ADD TO WORKLIST: CFITC TEST CODE: 8745-INTERP
IF ORDERED:

| FLAG CONFIGURATION | ADD |
|---|---|
| AAKA | #CF0035 |
| ABKA | #CF0036 |
| ACKA | #CF0037 |
| ADKA | #CF0038 |
| AEKA | #CF0039 |
| AFKA | #CF0040 |
| AGKA | #CF0041 |
| AHKA | #CF0032 |
| AIKA | #CF0033 |
| AJKA | #CF0034 |
| AKAA | #CF0035 |
| AKBA | #CF0036 |
| AKCA | #CF0037 |
| AKDA | #CF0038 |
| AKEA | #CF0039 |
| AKFA | #CF0040 |
| AKGA | #CF0041 |
| AKHA | #CF0032 |
| AKIA | #CF0033 |
| AKJA | #CF0034 |
| AKLA | #CF0031 |
| ALKA | #CF0031 |

KEY - CFITC-5
INTERPRETATION

| WORKLIST | TEST CODE | FLAG | EVALUATION |
|---|---|---|---|
| CFITC | 8245-PERHIST | A | R CON Negative |
| CFITC | 9045-ALLELE1 | A | R EQ 2789(+5)G > A |
| | | B | R EQ 3120(+1)G > A |
| | | C | R EQ 3659delC |
| | | D | R EQ 3849(+10 kb)C > T |
| | | E | R EQ 3876delA |
| | | F | R EQ 3905insC |
| | | G | R EQ Negative |
| | | H | R EQ R117H |
| CFITC | 9046-ALLELE2 | A | R EQ 2789(+5)G > A |
| | | B | R EQ 3120(+1)G > A |
| | | C | R EQ 3659delC |
| | | D | R EQ 3849(+10 kb)C > T |
| | | E | R EQ 3876delA |
| | | F | R EQ 3905insC |
| | | G | R EQ Negative |
| | | H | R EQ R117H |
| CFITC | 8345-VARIANT | A | R EQ N/A |
| | | B | R EQ intron 8-5T/5T |
| | | C | R EQ intron 8-5T/7T |
| | | D | R EQ intron 8-5T/9T |
| | | E | R EQ intron 8-7T/7T |
| | | F | R EQ intron 8-7T/9T |

ADD TO WORKLIST: CFITC TEST CODE: 8745-INTERP
IF ORDERED:

| FLAG CONFIGURATION | ADD |
|---|---|
| AAGA | #CF0042 |
| ABGA | #CF0043 |
| ACGA | #CF0044 |
| ADGA | #CF0045 |
| AEGA | #CF0046 |
| AFGA | #CF0047 |
| AGAA | #CF0042 |
| AGBA | #CF0043 |
| AGCA | #CF0044 |
| AGDA | #CF0045 |
| AGEA | #CF0046 |
| AGFA | #CF0047 |
| AGHB | #CF0050 |
| AGHC | #CF0048 |
| AGHD | #CF0049 |
| AGHE | #CF0051 |
| AGHF | #CF0052 |
| AHGB | #CF0050 |
| AHGC | #CF0048 |
| AHGD | #CF0049 |
| AHGE | #CF0051 |
| AHGF | #CF0052 |

KEY - CFITC-6
INTERPRETATION

| WORKLIST | TEST CODE | FLAG | EVALUATION |
|---|---|---|---|
| CFITC | 8245-PERHIST | A | R CON Negative |
| CFITC | 9045-ALLELE1 | A | R EQ Delta F508 |
| | | B | R EQ Negative |
| | | C | R EQ R117H |
| CFITC | 9046-ALLELE2 | A | R EQ Delta F508 |
| | | B | R EQ Negative |
| | | C | R EQ R117H |
| CFITC | 8345-VARIANT | A | R EQ F508C heterozygote |
| | | B | R EQ I506V heterozygote |
| | | C | R EQ I507V heterozygote |
| | | D | R EQ intron 8-9T/9T |

ADD TO WORKLIST: CFITC TEST CODE: 8745-INTERP
IF ORDERED:

| FLAG CONFIGURATION | ADD |
|---|---|
| AABA | #CF0054 |
| AABB | #CF0126 |
| AABC | #CF0127 |
| ABAA | #CF0054 |
| ABAB | #CF0126 |
| ABAC | #CF0127 |
| ABCD | #CF0053 |
| ACBD | #CF0053 |

KEY - CFITD-1
INTERPRETATION

| WORKLIST | TEST CODE | FLAG | EVALUATION |
|---|---|---|---|
| CFITD | 88245-PERHIST | A | R CON Positive |
| CFITD | 9045-ALLELE1 | A | R EQ A455E |
| | | B | R EQ A559T |
| | | C | R EQ Delta F508 |
| | | D | R EQ Delta I507 |
| | | E | R EQ G542X |
| | | F | R EQ G551D |
| | | G | R EQ G85E |
| | | H | R EQ M1101K |
| | | I | R EQ N1303K |
| | | J | R EQ Negative |
| | | K | R EQ R334W |
| | | L | R EQ R347H |
| CFITD | 9046-ALLELE2 | A | R EQ A455E |
| | | B | R EQ A559T |
| | | C | R EQ Delta F508 |
| | | D | R EQ Delta I507 |
| | | E | R EQ G542X |
| | | F | R EQ G551D |
| | | G | R EQ G85E |
| | | H | R EQ M1101K |
| | | I | R EQ N1303K |
| | | J | R EQ Negative |
| | | K | R EQ R334W |
| CFITD | 8345-VARIANT | A | R EQ N/A |

ADD TO WORKLIST: CFITD TEST CODE: 8745-INTERP
IF ORDERED:

| FLAG CONFIGURATION | ADD |
|---|---|
| AAJA | #CF0058 |
| ABJA | #CF0059 |
| ACJA | #CF0057 |
| ADJA | #CF0056 |
| AEJA | #CF0061 |
| AFJA | #CF0062 |
| AGJA | #CF0060 |
| AHJA | #CF0063 |
| AIJA | #CF0064 |
| AJAA | #CF0058 |
| AJBA | #CF0059 |
| AJCA | #CF0057 |
| AJDA | #CF0056 |
| AJEA | #CF0061 |
| AJFA | #CF0062 |
| AJGA | #CF0060 |
| AJHA | #CF0063 |
| AJIA | #CF0064 |
| AJJA | #CF0055 |
| AJKA | #CF0065 |
| AKJA | #CF0065 |
| ALJA | #CF0066 |

KEY - CFITD-2
INTERPRETATION

| WORKLIST | TEST CODE | FLAG | EVALUATION |
|---|---|---|---|
| CFITD | 88245-PERHIST | A | R CON Positive |
| CFITD | 9045-ALLELE1 | A | R EQ Negative |
| | | B | R EQ R1162X |
| | | C | R EQ R347P |
| | | D | R EQ R553X |
| | | E | R EQ R560T |
| | | F | R EQ S1255X |
| | | G | R EQ S549N |
| | | H | R EQ S549R(T > G) |
| | | I | R EQ V520F |
| | | J | R EQ W1282X |
| | | K | R EQ Y1092X(C > A) |
| | | L | R EQ Y122X |
| CFITD | 9046-ALLELE2 | A | R EQ Negative |
| | | B | R EQ R1162X |
| | | C | R EQ R347H |
| | | D | R EQ R347P |
| | | E | R EQ R553X |
| | | F | R EQ R560T |
| | | G | R EQ S1255X |
| | | H | R EQ S549N |
| | | I | R EQ S549R(T > G) |
| | | J | R EQ V520F |
| | | K | R EQ W1282X |
| | | L | R EQ Y122X |
| CFITD | 8345-VARIANT | A | R EQ N/A |

ADD TO WORKLIST: CFITD TEST CODE: 8745-INTERP
IF ORDERED:

| FLAG CONFIGURATION | ADD |
|---|---|
| AABA | #CF0070 |
| AACA | #CF0066 |
| AADA | #CF0067 |
| AAEA | #CF0068 |
| AAFA | #CF0069 |
| AAGA | #CF0073 |
| AAHA | #CF0071 |
| AAIA | #CF0072 |
| AAJA | #CF0074 |
| AAKA | #CF0075 |
| AALA | #CF0076 |
| ABAA | #CF0070 |
| ACAA | #CF0067 |
| ADAA | #CF0068 |
| AEAA | #CF0069 |
| AFAA | #CF0073 |
| AGAA | #CF0071 |
| AHAA | #CF0072 |
| AIAA | #CF0074 |
| AJAA | #CF0075 |
| AKAA | #CF0077 |
| ALAA | #CF0076 |

KEY - CFITD-3
INTERPRETATION

| WORKLIST | TEST CODE | FLAG | EVALUATION |
|---|---|---|---|
| CFITD | 88245-PERHIST | A | R CON Positive |
| CFITD | 9045-ALLELE1 | A | R EQ 1078delT |
| | | B | R EQ 1717(−1)G > A |
| | | C | R EQ 1898(+1)G > A |
| | | D | R EQ 1898(+5)G > T |
| | | E | R EQ 2183delAA > G |
| | | F | R EQ 2184delA |
| | | G | R EQ 2307insA |
| | | H | R EQ 394delTT |
| | | I | R EQ 621(+1)G > T |
| | | J | R EQ 711(+1)G > T |
| | | K | R EQ Negative |
| | | L | R EQ Y1092X(C > G) |
| CFITD | 9046-ALLELE2 | A | R EQ 1078delT |
| | | B | R EQ 1717(−1)G > A |
| | | C | R EQ 1898(+1)G > A |
| | | D | R EQ 1898(+5)G > T |
| | | E | R EQ 2183delAA > G |
| | | F | R EQ 2184delA |
| | | G | R EQ 394delTT |
| | | H | R EQ 621(+1)G > T |
| | | I | R EQ 711(+1)G > T |
| | | J | R EQ Negative |
| | | K | R EQ Y1092X(C > A) |
| | | L | R EQ Y1092X(C > G) |
| CFITD | 8345-VARIANT | A | R EQ N/A |

ADD TO WORKLIST: CFITD TEST CODE: 8745-INTERP
IF ORDERED:

| FLAG CONFIGURATION | ADD |
|---|---|
| AAJA | #CF0082 |
| ABJA | #CF0083 |
| ACJA | #CF0084 |
| ADJA | #CF0085 |
| AEJA | #CF0086 |
| AFJA | #CF0087 |
| AGJA | #CF0088 |
| AHJA | #CF0079 |
| AIJA | #CF0080 |
| AJJA | #CF0081 |
| AKAA | #CF0082 |
| AKBA | #CF0083 |
| AKCA | #CF0084 |
| AKDA | #CF0085 |
| AKEA | #CF0086 |
| AKFA | #CF0087 |
| AKGA | #CF0079 |
| AKHA | #CF0080 |
| AKIA | #CF0081 |
| AKKA | #CF0077 |
| AKLA | #CF0078 |
| ALJA | #CF0078 |

KEY - CFITD-4
INTERPRETATION

| WORKLIST | TEST CODE | FLAG | EVALUATION |
|---|---|---|---|
| CFITD | 88245-PERHIST | A | R CON Positive |
| CFITD | 9045-ALLELE1 | A | R EQ 2789(+5)G > A |
| | | B | R EQ 3120(+1)G > A |
| | | C | R EQ 3659delC |
| | | D | R EQ 3849(+10 kb)C > T |
| | | E | R EQ 3876delA |
| | | F | R EQ 3905insC |
| | | G | R EQ Negative |
| | | H | R EQ R117H |
| CFITD | 9046-ALLELE2 | A | R EQ 2307insA |
| | | B | R EQ 2789(+5)G > A |
| | | C | R EQ 3120(+1)G > A |
| | | D | R EQ 3659delC |
| | | E | R EQ 3849(+10 kb)C > T |
| | | F | R EQ 3876delA |
| | | G | R EQ 3905insC |
| | | H | R EQ Negative |
| | | I | R EQ R117H |
| CFITD | 8345-VARIANT | A | R EQ 5T/5T |
| | | B | R EQ 5T/7T |
| | | C | R EQ 5T/9T |
| | | D | R EQ 7T/7T |
| | | E | R EQ 7T/9T |
| | | F | R EQ N/A |

ADD TO WORKLIST: CFITD TEST CODE: 8745-INTERP
IF ORDERED:

| FLAG CONFIGURATION | ADD |
|---|---|
| AAHF | #CF0089 |
| ABHF | #CF0090 |
| ACHF | #CF0091 |
| ADHF | #CF0092 |
| AEHF | #CF0093 |
| AFHF | #CF0094 |
| AGAF | #CF0088 |
| AGBF | #CF0089 |
| AGCF | #CF0090 |
| AGDF | #CF0091 |
| AGEF | #CF0092 |
| AGFF | #CF0093 |
| AGGF | #CF0094 |
| AGIA | #CF0097 |
| AGIB | #CF0095 |
| AGIC | #CF0096 |
| AGID | #CF0098 |
| AHHA | #CF0097 |
| AHHB | #CF0095 |
| AHHC | #CF0096 |
| AHHD | #CF0098 |
| AHHE | #CF0099 |

KEY - CFITD-5
INTERPRETATION

| | | | |
|---|---|---|---|
| CFITD | 88245-PERHIST | A | R CON Positive |
| CFITD | 9045-ALLELE1 | A | R EQ Delta F508 |
| | | B | R EQ Negative |
| | | C | R EQ R117H |
| CFITD | 9046-ALLELE2 | A | R EQ Delta F508 |
| | | B | R EQ Negative |
| | | C | R EQ R117H |
| CFITD | 8345-VARIANT | A | R EQ 7T/9T |
| | | B | R EQ 9T/9T |
| | | C | R EQ F508C heterozygote |
| | | D | R EQ I506V heterozygote |
| | | E | R EQ I507V heterozygote |
| | | F | R EQ Negative for benign |
| | | | exon 10 |

variants tested
ADD TO WORKLIST: CFITD TEST CODE: 8745-INTERP
IF ORDERED:

| | |
|---|---|
| FLAG CONFIGURATION | ADD |
| AAAF | #CF0101 |
| AABC | #CF0102 |
| AABD | #CF0103 |
| AABE | #CF0125 |
| ABAC | #CF0102 |
| ABAD | #CF0103 |
| ABAE | #CF0125 |
| ABCA | #CF0099 |
| ABCB | #CF0100 |
| ACBB | #CF0100 |

** END **

That which is claimed is:

1. A computerized method of interpretation of genetic test data of a patient comprising:
receiving patient data;
receiving genetic test result data for at least a first allele;
generating a flag configuration from the patient data and from at least first allele data; and
generating a report based on the flag configuration;
wherein the report provides an interpretation of genetic test data for a patient.

2. The method of claim 1, wherein said receiving genetic test result data further comprises receiving genetic result data for a second allele, and the flag configuration is generated from the patient data, the first allele data, and the second allele data.

3. The method of claim 1, wherein receiving patient data comprises one or more of:
receiving patient ethnicity data;
receiving personal history data;
receiving family history data; and
wherein the flag configuration generated includes the patient ethnicity data, personal history data and family history data.

4. The method of claim 1, wherein said generating a report comprises:
comparing the flag configuration to a table of defined flag configurations having an associated message code to identify a matching flag configuration; and
entering the message code of the matching flag configuration for inclusion of associated text in the report.

5. The method of claim 4, wherein when said comparing does not identify a matching flag configuration, no report is generated.

6. The method of claim 5, wherein a report is generated after manual intervention is completed.

7. A system for analysis of genetic test data, comprising:
a computing environment;
an input device, connected to the computing environment, to receive data from a user, wherein the data received includes patient data and genetic test result data for at least a first allele;
an output device, connected to the computing environment, to provide information to the user; and
a computer readable storage medium having stored thereon at least one algorithm to provide for generation of a flag configuration from the patient data and the genetic test result data, and comparison of the flag configuration to a table containing defined flag configurations having associated message codes, wherein when the flag configuration generated from the patient data and the genetic test result data matches a defined flag configuration in the table, the associated message code is identified for use in generation of a report;
wherein the system provides results that can be used for generation of a report providing an analysis of genetic test data of a patient.

8. The method of claim 7, wherein the computing environment comprises a local computer local to the user and a remote computer at a site remote to the user, wherein the local computer and the remote computer are connected through a network, and wherein the computer readable storage medium is provided on the remote computer.

9. An automated genetic test result interpretation system, comprising:
a communications network;
a server connected to the communications network;
a client computer connected to the communications network; and
at least one algorithm executed based on patient data and genetic test result data, to provide for generation of a flag configuration from the patient data and the genetic test result data, and comparison of the flag configuration to a table containing defined flag configurations having associated message codes, wherein when the flag configuration generated from the patient data and the genetic test result data matches a defined flag configuration in the table, the associated message code is identified for use in populating a field of a report.

10. The automated genetic test result system of claim 9, wherein the communications network comprises the Internet.

11. A computer readable medium comprising a program stored thereon, wherein the program provides for execution of one or more algorithms to execute the method of claim 1.
